(19) United States
(12) Patent Application Publication
(10) Pub. No.: US 2020/0077216 A1
(43) Pub. Date: Mar. 5, 2020

(54) SPEAKER VIBRATION PLATE, SPEAKER VIBRATION PLATE MANUFACTURING DEVICE, AND MANUFACTURING METHOD OF SPEAKER VIBRATION PLATE

(71) Applicant: SEIKO EPSON CORPORATION, Tokyo (JP)

(72) Inventors: Satomi YOSHIOKA, Shiojiri (JP); Masahiro UCHIDA, Chino (JP); Kazuma MIYAZAWA, Shiojiri (JP)

(21) Appl. No.: 16/551,899

(22) Filed: Aug. 27, 2019

(30) Foreign Application Priority Data
Aug. 29, 2018 (JP) 2018-160221
Aug. 29, 2018 (JP) 2018-160222

(51) Int. Cl. H04R 31/00; B32B 7/12; B32B 5/26; B32B 7/022; B29B 7/90; B29C 70/04; B32B 37/12; H04R 7/12

(52) U.S. Cl. CPC H04R 31/003; B32B 7/12; B32B 5/26; B32B 7/022; B29L 2031/3418; B29C 70/04; B32B 37/12; H04R 7/127; B29B 7/90

(57) ABSTRACT

A vibration plate manufacturing device including: a defibration unit which defibrates a raw material including fibers; a mixing unit which mixes a binding material for binding the fibers to each other, to a defibrated material defibrated by the defibration unit; a second web formation unit which accumulates a mixture mixed by the mixing unit; and a molding unit which forms the second web accumulated in second web formation unit into a vibration plate by a molding process including pressing and heating.

The present application is based on, and claims priority from JP Application Serial Number 2018-160221, filed Aug. 29, 2018 and JP Application Serial Number 2018-160222, filed Aug. 29, 2018, the disclosures of which are hereby incorporated by reference herein in their entirety.

### BACKGROUND

### 1. Technical Field

The present disclosure relates to a speaker vibration plate, a speaker vibration plate manufacturing device, and a manufacturing method of a speaker vibration plate.

### 2. Related Art

In the related art, a method of papermaking by mixing a material such as a resin to pulp by wet papermaking, as a manufacturing method of a vibrating plate used for a speaker or the like (for example, see JP-A-55-136792). In the method of JP-A-55-136792, the papermaking is performed by adding synthetic fibers of polyethylene to pulp, and molding is performed by heating and pressing with drying.

The wet papermaking is a molding method using a hydrogen bond between fibers. The hydrogen bond between fibers strongly works due to the use of water, and it is difficult to ensure a long distance between fibers. The homogeneity is necessary for a speaker vibration plate, in order to obtain excellent sound quality. As properties of the speaker vibration plate, a low density, a high rigidity, and a high internal loss are required, in order to obtain excellent sound quality.

However, a speaker vibration plate manufactured by the wet papermaking has a high density of fibers after molding, and accordingly, it is difficult to manufacture a molded product having a low density or a molded product having a high internal loss. In addition, since the wet papermaking uses a large amount of water, it is necessary to provide equipment for water supply and drainage.

In the wet papermaking, a plurality of materials are dispersed in water. Thus, deviation or aggregation of fibers may occur or alignment may be applied to the fibers, due to a difference in shape, specific gravity, hydrophilicity and hydrophobicity, solubility, and dispersibility of the materials. Accordingly, unevenness of components or unevenness of a thickness may occur during the wet papermaking, and homogeneity may be deteriorated.

### SUMMARY

An object of the present disclosure is to manufactured a speaker vibration plate by dry papermaking to obtain a low density, a high rigidity, and a high internal loss which are optimal for a speaker vibration plate.

In addition, another object of the present disclosure is to prevent deviation or aggregation of fibers and other materials, in a case of missing the other materials with the fibers, when manufacturing the speaker vibration plate.

According to an aspect of the present disclosure, there is provided a speaker vibration plate including: a defibrated material obtained by defibrating a material including fibers; and a binding material for binding the fibers to each other, in which the speaker vibration plate is formed by a molding process including pressing and heating.

In the speaker vibration plate, the binding material may include at least any one of a thermoplastic resin and a thermosetting resin.

The speaker vibration plate may further include a thermally expandable material.

The speaker vibration plate may further include a vibration surface, and an auxiliary material may be attached to at least one surface of the vibration surface.

According to another aspect of the present disclosure, there is provided a speaker vibration plate manufacturing device including: a defibration unit which defibrates a material including fibers; a mixing unit which mixes a binding material for binding the fibers to each other, to a defibrated material defibrated by the defibration unit; an accumulation unit which accumulates a mixture mixed by the mixing unit; and a molding unit which forms an accumulated material accumulated by the accumulation unit into a speaker vibration plate by a molding process including pressing and heating.

In the speaker vibration plate manufacturing device, the mixing unit may disperse the mixture, and the accumulation unit may accumulate the mixture.

In the speaker vibration plate manufacturing device, the mixing unit may mix the defibrated material and the binding material with a thermally expandable material which expands by heating.

In the speaker vibration plate manufacturing device, the mixing unit may mix the defibrated material with the binding material including at least any of a thermoplastic resin and a thermosetting resin.

In the speaker vibration plate manufacturing device, the accumulation unit may accumulates the mixture to form a web, and the molding unit may press and heat the web set in a molding die in the molding process.

In the speaker vibration plate manufacturing device, the accumulation unit may accumulate the mixture to form a web, the speaker vibration plate manufacturing device may further include a sheet forming unit which forms a sheet by pressing and heating the web, and the molding unit may press and heat the sheet set in the molding die in the molding process.

In the speaker vibration plate manufacturing device, the accumulation unit may accumulate the mixture in the molding die, and the molding unit may press and heat the molding die, on which the mixture is accumulated, in the molding process.

The speaker vibration plate manufacturing device may further include an attachment processing unit which attaches an auxiliary material to a surface of the speaker vibration plate formed by the molding unit.

According to still another aspect of the present disclosure, there is provided a manufacturing method of a speaker vibration plate, the method including: defibrating a material including fibers; mixing a binding material for binding the fibers to each other, with a defibrated material obtained by the defibrating; accumulating the mixture; and forming an accumulated material into a speaker vibration plate by a molding process including pressing and heating.

According to still another aspect of the present disclosure, there is provided a speaker vibration plate including: a first layer which includes a defibrated material obtained by defibrating a material including fibers, and a binding material for binding the fibers of the defibrated material; and a second layer which includes the defibrated material and the binding material and has a higher density than a density of the first layer, in which the binding material is dissolved to form the speaker vibration plate.

In the speaker vibration plate, the second layer may be a layer having a higher rigidity than a rigidity of the first layer.

In the speaker vibration plate, a density of at least any one of the fibers and the binding material included in the second layer may be higher than that of the first layer.

In the speaker vibration plate, the binding material may include at least any of a thermoplastic resin and a thermosetting resin.

The speaker vibration plate may further include an adhesive material which bonds the first layer and the second layer to each other.

According to still another aspect of the present disclosure, there is provided a speaker vibration plate manufacturing device including: a defibration unit which defibrates a material including fibers; a mixing unit which mixes a binding material for crosslinking the fibers, with a defibrated material defibrated by the defibration unit; an accumulation unit which accumulates a mixture mixed by the mixing unit to form a first layer and a second layer; and a molding unit which dissolves the binding material to form a speaker vibration plate in which the first layer and the second layer are laminated, in which the second layer has a higher density than a density of the first layer.

In the speaker vibration plate manufacturing device, the second layer may have a higher rigidity than a rigidity of the first layer.

In the speaker vibration plate manufacturing device, a density of at least any of the fibers and the binding material included in the second layer may be higher than the density of the first layer.

In the speaker vibration plate manufacturing device, the binding material may include at least any of a thermoplastic resin and a thermosetting resin.

In the speaker vibration plate manufacturing device, the accumulation unit may accumulate the mixture to form a web, the speaker vibration plate manufacturing device may further include a sheet forming unit which forms a sheet by pressing and heating the web, and the molding unit may form the speaker vibration plate including the first layer formed from the sheet by a first layer molding unit and the second layer formed from the sheet by a second layer molding unit.

In the speaker vibration plate manufacturing device, the accumulation unit may accumulate the mixture to form a web, the speaker vibration plate manufacturing device may further include a sheet forming unit which forms a sheet by pressing and heating the web, and the molding unit may laminate the sheet configuring the first layer and the sheet configuring the second layer, and perform pressing and heating by a molding die, to form the speaker vibration plate.

The speaker vibration plate manufacturing device may further include an adhesive material supply unit which attaches an adhesive material between the sheet configuring the first layer and the sheet configuring the second layer.

In the speaker vibration plate manufacturing device, the accumulation unit may accumulate the mixture configuring the first layer and the mixture configuring the second layer on a molding die, and the molding unit may press and heat the molding die on which the mixture is accumulated by the accumulation unit, to form the speaker vibration plate.

According to still another aspect of the present disclosure, there is provided a manufacturing method of a speaker vibration plate, the method including: mixing fibers of a defibrated material defibrated with a binding material for binding the fibers to form a first layer with a first density; mixing the fibers and the binding material to form a second layer with a density higher than a density of the first layer; and bonding the first layer and the second layer to each other, in a state where the first layer and the second layer are laminated.

In the speaker vibration plate, the bonding of the first layer and the second layer may be a process of dissolving the binding material by a molding process including heating and pressing.

### BRIEF DESCRIPTION OF THE DRAWINGS

FIG. 1 is a perspective view of a vibration plate manufactured by a manufacturing method of a vibration plate of a first embodiment.

FIG. 2 is a flowchart showing the manufacturing method of a vibration plate of the first embodiment.

FIG. 3 is a configuration view of a vibration plate manufacturing device of the first embodiment.

FIG. 4 is an explanatory view showing states of crosslinking by an additive material.

FIG. 5 is an explanatory view showing states of crosslinking, in a case of using a thermally expandable material.

FIG. 6 is an explanatory view showing a state of crosslinking, in a case of using core-sheath structured fibers.

FIG. 7 is a flowchart showing a manufacturing method of a vibration plate of a second embodiment.

FIG. 8 is a configuration view of a vibration plate manufacturing device of the second embodiment.

FIG. 9 is a flowchart showing a manufacturing method of a vibration plate of a third embodiment.

FIG. 10 is a configuration view of a vibration plate manufacturing device of the third embodiment.

FIG. 11 is a flowchart shoring a manufacturing method of a vibration plate of a fourth embodiment.

FIG. 12 is a configuration view of a vibration plate manufacturing device of the fourth embodiment.

FIG. 13 is an explanatory view showing a specific example of an auxiliary material adding step.

FIG. 14 is an explanatory view showing another specific example of the auxiliary material adding step.

FIG. 15 is an explanatory view showing still another specific example of the auxiliary material adding step.

FIG. 16 is an explanatory view showing still another specific example of the auxiliary material adding step.

FIG. 17 is an explanatory view showing still another specific example of the auxiliary material adding step.

FIG. 18 is an explanatory view showing still another specific example of the auxiliary material adding step.

FIG. 19 is an explanatory view showing still another specific example of the auxiliary material adding step.

FIG. 20 is a cross sectional view of a vibration plate of a fifth embodiment.

FIG. 21 is a flowchart showing a manufacturing method of a vibration plate of the fifth embodiment.

FIG. 22 is a configuration view of a vibration plate manufacturing device of the fifth embodiment.

FIG. 23 is a configuration view of a sheet manufacturing device of the fifth embodiment.

FIG. 24 is a perspective view of a punching die of the fifth embodiment.

FIG. 25 is a perspective view of another punching die of a sixth embodiment.

FIG. 26 is a configuration view of a vibration plate manufacturing device of the sixth embodiment.

FIG. 27 is a cross sectional view of a vibration plate of a seventh embodiment.

FIG. 28 is a configuration view of a vibration plate manufacturing device of the seventh embodiment.

FIG. 29 is a cross sectional view showing another configuration example of the vibration plate.

FIG. 30 is a flowchart showing a manufacturing method of a vibration plate of an eighth embodiment.

FIG. 31 is a configuration view of a vibration plate manufacturing device of the eighth embodiment.

FIG. 32 is a configuration view of a vibration plate manufacturing device of a ninth embodiment.

FIG. 33 is a flowchart showing a manufacturing method of a vibration plate of the ninth embodiment.

FIG. 34 is a configuration view of a vibration plate manufacturing device of a tenth embodiment.

FIG. 35 is a perspective view of a molding die.

FIG. 36 is a perspective view showing another configuration example of the molding die.

FIG. 37 is a flowchart showing a manufacturing method of a vibration plate of an eleventh embodiment.

FIG. 38 is a configuration view of a vibration plate manufacturing device of the eleventh embodiment.

FIG. 39 is a flowchart showing a manufacturing method of a vibration plate of a twelfth embodiment.

FIG. 40 is a configuration view of a vibration plate manufacturing device of the twelfth embodiment.

FIG. 41 is a configuration view of a sheet manufacturing device of the twelfth embodiment.

FIG. 42 is a configuration view of a vibration plate manufacturing device of a thirteenth embodiment.

### DESCRIPTION OF EXEMPLARY EMBODIMENTS

Hereinafter, preferred embodiments of the present disclosure will be described in detail with reference to the drawings. The embodiments described below do not limit the contents of the present disclosure disclosed in the aspects. In addition, all of the configurations described below is not necessarily compulsory constituent elements of the present disclosure.

### 1. First Embodiment

### 1-1. Manufacturing Method of Speaker Vibration Plate

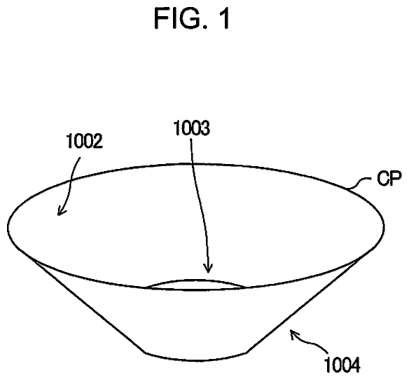

FIG. 1 is a perspective view showing a configuration of a vibration plate CP manufactured by a manufacturing method of the embodiment.

The vibration plate CP is a speaker vibration plate used in a speaker which outputs sound and has a truncated cone shape. The vibration plate CP is subjected to a process of attaching an edge, a center cap, a lead wire, or a voice coil to configure a speaker. In the description hereinafter, the vibration plate CP will be described to have a simple truncated cone shape, but a concentric ribs may be provided on the vibration plate CP. In addition, on an outer peripheral portion of the vibration plate CP, a shape for attaching an edge may be provided or a shape for attaching a lead wire or a center cap may be provided.

The vibration plate CP is formed by pressing and heating a material including fibers, as will be described later. The vibration plate CP has a recessed surface on a side for outputting sound. In the vibration plate CP, a front surface on a side for outputting sound is set as 1002, and a bottom surface portion of the recess of the front surface 1002 is set as a bottom portion 1003. In addition, the surface on a rear side of the front surface 1002 is set as a rear surface 1004. The front surface 1002 is a surface on a side for outputting vibration of the vibration plate CP1 as sound, and accordingly, the surface can be also referred to as a vibration surface.

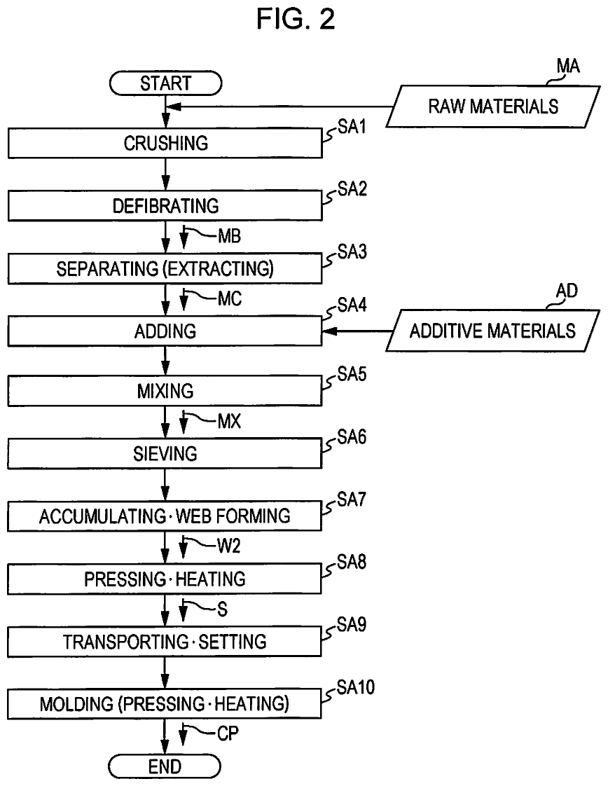

FIG. 2 is a flowchart showing a manufacturing method of the vibration plate of the first embodiment, and shows a step of manufacturing the speaker vibration plate CP by using a raw material including fibers. The vibration plate CP is known as so-called cone paper or speaker cone.

In the manufacturing step shown in FIG. 2, a raw material MA including fibers is used. The raw material MA may be any material, as long as it includes fibers. For example, a wood-based pulp material, Kraft pulp, waste paper, or synthetic pulp can be used. Examples of the wood-based pulp include mechanical pulp manufactured by a machine process such as ground pulp, chemical pulp manufactured by a chemical process, and semi-chemical pulp or chemiground pulp manufactured by using both of these processes in combination. In addition, any of bleached pulp or unbleached pulp may be used. For example, virgin pulp such as softwood bleached kraft pulp (N-BKP) or broad-leaved tree bleached kraft pulp (L-BKP), or Bleached ChemiThermoMechanical Pulp (BCTMP) is used. Nano-cellulose fibers (NCF) may be used. The waste paper is used paper such as plain paper copy (PPC) after the printing, magazines or newspaper. As the synthesis pulp, SWP manufactured by Mitsui Chemicals, Inc. is used, for example. SWP is a registered trademark.

The raw material MA, and a defibrated material MB and a material MC which will be described later can be referred to as the material including fibers.

The raw material MA may include carbon fibers, metal fibers, and thixotropic fibers, in addition to or instead of the wood-based pulp material, the waste paper, or the synthesis pulp. Accordingly, the raw material MA may be a mixture obtained by mixing a plurality of materials from the wood-based pulp material, the waste paper, the synthesis pulp, the carbon fibers, the metal fibers, and the thixotropic fibers.

Step SA1 is a crushing process of crushing the raw material MA. The crushing process is a step of cutting the raw material MA to have a size equal to or smaller than a predetermined size. The predetermined size is, for example, 1 cm to 5 cm square. The cut raw material MA is a crushed piece. When the raw material MA is configured of fibers or a fiber piece having a size equal to or smaller than the predetermined size, the crushing step in Step SA1 may be omitted.

Step SA2 is a defibration step. The defibration step is a step of defibrating the raw material MA or the crushed piece crushed in Step SA1 in an atmosphere, to disentangle the fibers included in the raw material MA to one or a several number of fibers. The raw material MA and the crushed piece can also be referred to as a material to be defibrated. In addition, a material defibrated in the defibration step is a defibrated material MB. By defibrating the raw material MA in the defibration step, an effect of separating a substance such as resin particles, an ink, a toner, or a bleeding inhibitor attached to the raw material MA from the fibers can be expected. The defibrated material MB may include resin particles, a colorant such as an ink or a toner, or an additive such as a bleeding inhibitor or a paper strengthening agent, which is separated from the fibers, when disentangling the fibers, in addition to the disentangled defibrated material fibers.

In the defibration step, the defibration is performed by a dry method. The dry method indicates a process of defibrating or the like performed in the atmosphere or the controlled gas, not in a liquid.

In addition, in the process described below, the process performed in the atmosphere is not limited to a process performed in the air. For example, the process can also be performed in gas other than the air. That is, the expression “in the atmosphere” described below can be replaced with “in the air”.

The defibrated material MB may include fibers having different lengths. A length of the fiber included in the defibrated material MB, that is, a fiber length is preferably 1 μm (1.0×10⁻⁶ m) to 500 mm and more preferably 5 μm to 200 mm. A thickness of the fiber, that is, a fiber diameter is preferably 0.1 μm to 1,000 μm and more preferably 1 μm to 500 μm.

Step SA3 is a step of extracting a material mainly including the fibers from the defibrated material MB, and is referred to as a separation step. The separation step is a step of separating particles such as a resin or an additive from the defibrated material MB including fibers or a resin, and extracting the material mainly including the fibers. Accordingly, particles of a resin or an additive affecting the manufacturing of the vibration plate CP can be removed from the components included in the raw material MA. The material separated in the separation step is set as a material MC.

When the raw material MA supplied in Step SA1 does not include the particles or the like affecting the manufacturing of the vibration plate CP, or when it is not necessary to remove the particles or the like from the component included in the raw material MA, the separation step in Step SA3 can be omitted. In this case, the defibrated material MB is used as the material MC as it is.

Step SA4 is an addition step. The addition step is a step of adding an additive material AD to the material MC separated in Step SA3.

The additive material AD includes particles of a resin functioning as a binding material for binding the fibers to each other, and specifically, includes particles of a thermoplastic resin and/or particles of a thermosetting resin particles.

As the thermoplastic resin, for example, a resin having a melting temperature of 60° C. to 200° C. and a deformation temperature of 50° C. to 180° C. can be used, for example. Here, the deformation temperature can also be referred to as a glass transition temperature. As the thermoplastic resin, a petroleum-derived resin, a biomass plastic, or a biodegradable plastic can be used. Here, examples of the petroleum-derived resin include a polyolefin resin, a polyester resin, a polyamide resin, polyacetal, polycarbonate, modified polyphenylene ether, cyclic polyolefin, an ABS resin, polystyrene, polyvinyl chloride, polyvinyl acetate, polyurethane, a Teflon resin, an acrylic resin, polyphenylene sulfide, polytetrafluoroethylene, polysulfone, polyether sulfone, amorphous polyaryate, liquid crystal polymer, polyetheretherketone, thermoplastic polyimide, and polyamideimide. Examples of the biomass plastic or the biodegradable plastic include polylactic acid, polycaprolactone, modified starch, polyhydroxybutyrate, polybutylene succinate, polybutylene succinate, and polybutylene succinate adipate. Teflon is a registered trademark. Examples of the thermosetting resin include a phenolic resin, an epoxy resin, a vinyl ester resin, and unsaturated polyester. The additive material AD includes one or a plurality of resins among the resins described above. The additive material AD is preferably particles, more preferably particles having a weight average particle diameter of 0.1 μm to 120 μm, and even more preferably particles having 1 μm to 50 μm. For example, the particles of the resin can include an aggregation inhibitor formed of silica (silicon oxide) or the like by kneading, or particles added by coating over the outer surface (attached to the outer surface) of the particles of the resin can be used.

The additive material AD may include a thermally expandable material which expands by heating, in addition to the resin described above. As the thermally expandable material, a so-called foaming material can be used. The thermally expandable material is preferably particles, and a thermally expandable material molded in a particulate state can be referred to as a foaming particles. A particle diameter of the foaming particles included in the additive material AD is preferably 0.5 μm to 1,000 μm and more preferably 1 μm to 300 μm, in terms of an average particle diameter before foaming. The average particle diameter after foaming is even more preferably 5 μm to 1,000 μm and most preferably 5 μm to 800 μm.

As the foaming particles, a capsule type thermally expandable capsule which expands by heating, or foaming material mixed particles mixed with the thermally expandable material can be used. Examples of the thermally expandable capsule include ADVANCELL manufactured by Sekisui Chemical Co., Ltd., KUREHA Microsphere manufactured by Kureha Corporation, Expancel manufactured by Akzo Nobel, and Matsumoto Microsphere manufactured by Matsumoto Yushi-Seiyaku Co., Ltd. ADVANCELL, KUREHA, Expancel, and Matsumoto Microsphere are respectively registered trademarks. The foaming material mixed particles are a particulate preparation prepared by mixing the thermally expandable material with the thermoplastic resin. Here, as the foaming material, azodicarbonamide, N,N′-dinitrosopentamethyl enetetramine, 4,4′-oxybis (benzenesulfonyl hydrazide), N,N′-Dinitrosopentamethyl enetetramine, azodicarbonamide, and sodium hydrogen carbonate can be used.

When surfaces of the foaming particles are coated with the resin, a coverage of the foaming particles with the resin is preferably 10% to 100%.

The additive material AD may include an inorganic filler, hard fibers, and thixotropic fibers, as a reinforcing material for rigidifying of a crosslinked structure in which the fibers are bound, in addition to the resins described above. As the inorganic filler, calcium carbonate, mica, or the like can be used, for example. As the hard fibers, carbon fibers, metal fibers, or the like can be used, for example. As the thixotropic fibers, cellulose nano-fibers are used.

In addition, the additive material AD may be formed as a composite resin material powder, by kneading and pulverizing the components such as the resins, the foaming particles, or the reinforcing materials.

Step SA5 is a mixing step. In the mixing step, the material MC and the additive material AD are mixed with each other to prepare a mixture MX.

Step SA6 is a sieving step. In the sieving step, the mixture MX is sieved, dispersed in the atmosphere, and is dropped.

Step SA7 is an accumulation step. In the accumulation step, the mixture MX dropping in the sieving step in Step SA6 is accumulated and a web is formed. The web formed in Step SA7 is referred to as a second web W2. The second web W2 is a state where the fibers and the additive material AD included in the mixture MX are accumulated, has a predetermined thickness, and has a low rigidity. The second web W2 corresponds to the accumulated material and the web.

Step SA8 is a pressing and heating step of pressing and heating the second web W2. In the pressing and heating step, the second web W2 is pressed and heated, and a sheet S is formed thereon. The order of the pressing and heating in the pressing and heating step is not limited, and the pressing is preferably performed first.

Step SA9 is a transportation step of transporting the sheet S formed in the pressing and heating step to a molding die. The transportation step may include a step of cutting the sheet S formed in the pressing and heating step to have a size of the molding die.

Step SA10 is a molding step of pressing and heating the sheet S by the molding die to form a vibration plate CP.

### 1-2. Configuration of Vibration Plate Manufacturing Device

FIG. 2 is a configuration view of a vibration plate manufacturing device 100.

The vibration plate manufacturing device 100 performs a manufacturing step of the vibration plate CP shown in FIG. 2 and manufactures the vibration plate CP from the raw material MA. The vibration plate manufacturing device 100 corresponds to the speaker vibration plate manufacturing device.

The vibration plate manufacturing device 100 includes a defibration unit 20, an additive material supply unit 52, a mixing unit 50, a second web formation unit 70, and a molding unit 200, as a compulsory configuration. The second web formation unit 70 corresponds to the accumulation unit. In addition, the vibration plate manufacturing device 100 includes a supply unit 10, a crushing unit 12, a selection unit 40, a first web formation unit 45, a rotator 49, the mixing unit 50, a dispersion unit 60, a web transportation unit 79, a pressing and heating unit 80, a cutting unit 90, and a transportation unit 95.

The crushing unit 12, the defibration unit 20, the selection unit 40, and the first web formation unit 45 configure a defibration processing unit 101 which manufactures the material MC by processing the raw material MA. The rotator 49, the mixing unit 50, the dispersion unit 60, the second web formation unit 70, the pressing and heating unit 80, and the cutting unit 90 configure a manufacturing unit 102 which manufactures the sheet S from the material MC.

The supply unit 10 is an automatic insertion device which accommodates the raw material MA and continuously inserts the raw material MA to the crushing unit 12.

The crushing unit 12 performs the crushing step (Step SA1). The crushing unit 12 includes a crushing blade 14 and cuts the raw material MA by the crushing blade 14 in the atmosphere to obtain a crushed piece having a size of several cm square. A shape or a size of the strip is random. As the crushing unit 12, a shredder can be used, for example. The raw material MA cut by the crushing unit 12 is collected by a hopper 9 and transported to the defibration unit 20 through a tube 2.

The defibration unit 20 is a device which defibrates the crushed piece cut by the crushing unit 12 by a dry method, and performs the defibration step (Step SA2). The defibration unit 20 can configure a defibration machine such as an impeller mill, for example. The defibration unit 20 of the embodiment is a mill which includes a cylindrical stator 22 and a rotor 24 rotating in the stator 22, and in which a defibration blade is formed on an inner peripheral surface of the stator 22 and an outer peripheral surface of the rotor 24. By the rotation of the rotor 24, the crushed piece is pinched between the stator 22 and the rotor 24 and defibrated. The defibrated material MB obtained by the defibration by the defibration unit 20 is sent to a tube 3 from an outlet of the defibration unit 20.

The crushed piece is transported from the crushing unit 12 to the defibration unit 20 by air flow. In addition, the defibrated material MB is transferred from the defibration unit 20 to the selection unit 40 through the tube 3 by air flow. These air flows may be generated by the defibration unit 20 or may be generated by providing a blower (not shown).

The selection unit 40 selects a component included in the defibrated material MB in accordance with sizes of the fibers. The size of the fiber indicates mainly a length of the fiber.

The selection unit 40 of the embodiment includes a drum unit 41, and a housing unit 43 accommodating the drum unit 41. The drum unit 41 is, for example, a so-called sieve such as a net including an opening, a filler, or a screen. Specifically, the drum unit 41 has a cylindrical shape rotatably driven by a motor and at least a part of a peripheral surface is formed of a net. The drum unit 41 may be configured of wire netting, expanded metal or punching metal obtained by extending a metal plate having a gap. The defibrated material MB introduced from an introduction port 42 into the drum unit 41 is divided into a passed material which passes the opening of the drum unit 41 and a residue which does not pass the opening, by the rotation of the drum unit 41. The passed material which passed the opening includes fibers or particles having a size smaller than the opening and this is referred to as a first selected material. The residue includes fibers, a non-defibrated piece, or a lump having a size greater than the opening, and this is referred to as a second selected material. The first selected material is dropped into the housing unit 43 towards the first web formation unit 45. The second selected material is transported from an outlet 44 connecting to the inner portion of the drum unit 41 to the defibration unit 20 through a tube 8.

The vibration plate manufacturing device 100 may include a classifier which separates the first selected material and the second selected material from each other, instead of the selection unit 40. The classifier is, for example, a cyclone classifier, Elbow-Jet classifier, or Eddy classifier.

The first web formation unit 45 includes a mesh belt 46, stretching rollers 47, and an suction unit 48. The mesh belt 46 is an endless metal belt and is suspended over a plurality of stretching rollers 47. The mesh belt 46 goes around an orbit made by the stretching rollers 47. A part of the orbit of the mesh belt 46 is planar on a lower side of the drum unit 41 and the mesh belt 46 configures a planar surface.

A plurality of openings are formed on the mesh belt 46, and components having a larger size than the opening of the mesh belt 46 among the first selected material dropped from the drum unit 41 are accumulated on the mesh belt 46. The components having a smaller size than the opening of the mesh belt 46 among the first selected material pass through the opening. The component passing through the opening of the mesh belt 46 are referred to as a third selected material, and includes, for example, fibers having a size shorter than the opening of the mesh belt 46, resin particles separated from the fibers by the defibration unit 20, and particles including an ink, a toner, or a bleeding inhibitor.

The suction unit 48 is coupled to a blower (not shown) and the air is sucked by the suction power of the blower from the lower side of the mesh belt 46. The air sucked from the suction unit 48 is discharged with the third selected material passed through the opening of the mesh belt 46.

The air flow made by the suction of the suction unit 48 draws the first selected material dropped from the drum unit 41 to the mesh belt 46, and accordingly, an effect of promoting the accumulation is exhibited.

The component accumulated on the mesh belt 46 has a web shape and configures a first web W1. That is, the first web formation unit 45 forms the first web W1 from the first selected material selected by the selection unit 40.

The first web W1 is a component mainly including fibers having a larger size than the opening of the mesh belt 46 among the components included in the first selected materials, and is formed in a state of being softly swollen with a large amount of the air. The first web W1 is transported to the rotator 49 along the movement of the mesh belt 46.

The rotator 49 includes a plurality of plate-shaped blades, and is driven and rotates by a driving unit (not shown) such as a motor or the like. The rotator 49 is disposed on an end portion of the orbit of the mesh belt 46 and contacts with a portion where the first web W1 transported by the mesh belt 46 is protruded from the mesh belt 46. The first web W1 is disentangled by the rotator 49 which collides with the first web W1, becomes a lump of small fibers, and is transported to the mixing unit 50 through a tube 7. A material obtained by dividing of the first web W1 by the rotator 49 is set as the material MC. The material MC is obtained by removing the third selected material from the first selected material described above and the main component is the fiber.

As described above, the selection unit 40 and the first web formation unit 45 have a function of separating the material MC mainly including the fiber from the defibrated material MB, and performs the separation step (Step SA3).

The additive material supply unit 52 is a device which adds the additive material AD to a tube 54 which transports the material MC and performs the addition step (Step SA4).

In the additive material supply unit 52, an additive material cartridge 52a for accumulating the additive material AD. The additive material cartridge 52a is a tank for accommodating the additive material AD and may be detachable from the additive material supply unit 52. The additive material supply unit 52 includes an additive material extraction unit 52b which extracts the additive material AD from the additive material cartridge 52a, and an additive material insertion unit 52c which discharges the additive material AD extracted by the additive material extraction unit 52b to a tube 54. The additive material extraction unit 52b includes a feeder which sends the additive material AD to the additive material insertion unit 52c. The additive material insertion unit 52c includes an openable shutter and sends the additive material AD to the tube 54 by opening the shutter.

The mixing unit 50 mixes the material MC and the additive material AD to each other by a mixing blower 56. The mixing unit 50 may include a tube 54 for transporting the material MC and the additive material AD to the mixing blower 56, in the mixing unit 50. The mixing unit 50 performs the mixing step (Step SA5).

The mixing blower 56 generates the air flow in the tube 54 linking the tube 7 and the dispersion unit 60, and mixes the material MC and the additive material AD with each other. The mixing blower 56, for example, includes a motor, blades which are driven and rotates by the motor, and a case accommodating the blades. In addition, in addition to the blades generating the air flow, the mixing blower 56 may include a mixer which mixes the material MC and the additive material AD with each other. The mixture mixed by the mixing unit 50 is referred to as a mixture MX, hereinafter. The mixture MX is transported to the dispersion unit 60 and introduced to the dispersion unit 60 by the air flow generated by the mixing blower 56.

The dispersion unit 60 disentangles the fibers of the mixture MX and drops the mixture to the second web formation unit 70, while performing the dispersion in the atmosphere. When the additive material AD has a fibrous shape, these fibers are also disentangled by the dispersion unit 60 and dropped to the second web formation unit 70. The dispersion unit 60 performs the sieving step (Step SA6).

The dispersion unit 60 includes a dispersion drum 61 and a housing 63 accommodating the dispersion drum 61. The dispersion drum 61 is, for example, a cylindrical structure configured in the same manner as the drum unit 41, and, rotates by a power of a motor (not shown) and functions as a sieve, in the same manner as the drum unit 41. The dispersion drum 61 includes an opening, and the mixture MX disentangled by the rotation of the dispersion drum 61 is dropped from the opening. Accordingly, in an internal space 62 formed in the housing 63, the mixture MX is dropped from the dispersion drum 61. The housing 63 corresponds to a case.

The second web formation unit 70 is disposed on a lower side of the dispersion drum 61. The second web formation unit 70 includes a mesh belt 72, stretching rollers 74, and a suction mechanism 76.

The mesh belt 72 is configured with an endless metal belt which is the same as the mesh belt 46 and is suspended over the plurality of stretching rollers 74. The mesh belt 72 moves in a transportation direction shown with a reference numeral F1, while going around an orbit configured by the stretching rollers 74. A part of the orbit of the mesh belt 72 is planar on a lower side of the dispersion drum 61 and the mesh belt 72 configures a planar surface.

A plurality of openings are formed on the mesh belt 72, and components having a larger size than the opening of the mesh belt 72 among the mixture MX dropped from the dispersion drum 61 are accumulated on the mesh belt 72. In addition, the components having a smaller size than the opening of the mesh belt 72 among the mixture MX pass through the opening.

The second web formation unit 70 corresponds to the accumulation unit, and the second web formation unit 70 performs the accumulation step (Step SA7).

The suction mechanism 76 sucks the air from a side opposite to the dispersion drum 61 with respect to the mesh belt 72, by a suction power of a blower (not shown). The components passed through the opening of the mesh belt 72 is sucked by the suction mechanism 76. The air flow made by the suction of the suction mechanism 76 draws the mixture MX dropped from the dispersion drum 61 to the mesh belt 72, and accordingly, the accumulation is promoted. The air flow of the suction mechanism 76 forms a down flow in a path where the mixture MX drops from the dispersion drum 61, and an effect of preventing the intertangling of the fibers during the dropping can be expected.

The end portion of the bottom portion 1003 side of the vibration plate CP is an adhesive portion with a voice coil bobbin of a speaker, and accordingly, it is important to ensure homogeneity and strength. Therefore, in the molding which will be described later, the thickness of the fiber may be set to be greater than those of other portions. In this case, the suction mechanism 76 can regionally have distribution in the suction power, and the suction power can be selectively increased in a region corresponding to the bottom portion 1003 of the second web W2, to adjust a basis weight (thickness of fiber). For example, the suction mechanism 76 may distribute an air speed or an air quantity of the air flow generated by the suction through the mesh belt 72 or the suction power due to these, so as to have differences therein in the plane of the mesh belt 72.

The component accumulated on the mesh belt 72 has a web shape and configures the second web W2. The second web W2 corresponds to the web and the accumulated material.

In the transportation path of the mesh belt 72, a humidity controlling unit 78 is provided downstream of the dispersion unit 60. The humidity controlling unit 78 is a mist type humidifier which supplies mist-like water towards the mesh belt 72, and includes, for example, a tank for storing water or an ultrasonic vibrator for generating mist from the water. By the mist applied by the humidity controlling unit 78, the amount of moisture contained in the second web W2 is adjusted and adsorption or the like of the fibers to the mesh belt 72 due to static electricity is prevented.

The second web W2 is peeled off from the mesh belt 72 and transported to the pressing and heating unit 80 by the web transportation unit 79. The web transportation unit 79 includes a mesh belt 79a, rollers 79b, and a suction mechanism 79c. The suction mechanism 79c includes a blower (not shown) and generates upward air flow by a suction power of the blower through the mesh belt 79a. The mesh belt 79a can be configured with an endless metal belt including an opening, in the same manner as the mesh belt 46 and the mesh belt 72. The mesh belt 79a moves by the rotation of the rollers 79b and moves on a revolution orbit. In the web transportation unit 79, the second web W2 is separated from the mesh belt 72 and adsorbed to the mesh belt 79a by the suction power of the suction mechanism 79c. The second web W2 moves together with the mesh belt 79a and is transported to the pressing and heating unit 80.

The pressing and heating unit 80 includes a pressing unit 82 and a heating unit 84. The pressing unit 82 presses the second web W2 at a predetermined nip pressure and adjusts a thickness of the second web W2, to realize a high density of the second web W2. The heating unit 84 applies heat to the second web W2 to bind the material MC-free fibers included in the second web W2 by the resin included in the additive material AD. The pressing unit 82 is configured with a pair of calender rollers 85 and 85. The pressing unit 82 includes a press mechanism of applying the nip pressure to the calender rollers 85 and 85 by oil pressure, or a motor which rotates the calender rollers 85 and 85. The heating unit 84 includes a pair of heating rollers 86 and 86. The heating unit 84 includes a heater (not shown) which heats peripheral surfaces of the heating rollers 86 to a predetermined temperature, and a motor (not shown) which rotates the heating rollers 86 and 86 towards the cutting unit 90. The second web W2 is heated to a higher temperature than a glass transition temperature of the resin included in the mixture MX in the heating unit 84 and is set as the sheet S. The pressing and heating unit 80 corresponds to a sheet forming unit.

The cutting unit 90 cuts the sheet S formed by the heating and pressing unit 80. The cutting unit 90 may be a cutter which cuts the sheet S to have a shape of molding dies 201 and 202 of the molding unit 200 which will be described later. For example, the cutting unit 90 may include a first cutting unit which cuts the sheet S in a direction intersecting a transportation direction of the sheet S shown with a reference numeral F2 in the drawing. In addition, the cutting unit 90 may include a second cutting unit which cuts the sheet S in a direction parallel to the transportation direction F2, in addition to the first cutting unit.

The sheet S cut by the cutting unit 90 is transported to the molding unit 200 by the transportation unit 95.

The molding unit 200 includes a pair of molding dies 201 and 202. The molding die 201 and the molding die 202 respectively have shapes fit to each other and are molded in a shape of the vibration plate CP. The molding unit 200 pinches the sheet S between the molding die 201 and the molding die 202, and presses and heats the sheet S, to form the vibration plate CP.

The transportation unit 95 transports the sheet S cut by the cutting unit 90 between the molding die 201 and the molding die 202. The transportation unit 95 performs the transportation step (Step SA9). In addition, the transportation step (Step SA9) may include an operation of the cutting unit 90. The molding unit 200 performs the molding step (Step SA10).

The molding die 201 and the molding die 202 have a shape fit to each other as a male die and a female die, and is a press type of pressing the pinched sheet S with a predetermined pressure. The molding unit 200, for example, forms the vibration plate CP having a truncated cone shape.

As a configuration of the molding unit 200 for heating the sheet S, a configuration of embedding a heater in at least one of the molding die 201 and the molding die 202 and heating the sheet S by each or at least one of the molding die 201 and the molding die 202 is used. In this case, the molding unit 200 may perform the heating and pressing of the sheet S at the same time or at different timings.

In addition, after pressing or during pressing the sheet S pinched between the molding die 201 and the molding die 202, the molding unit 200 may heat the molding die 201 and the molding die 202 from outside. Specifically, the molding dies 201 and 202 may be accommodated in a housing including a heater and the sheet S may be heated together with the molding dies 201 and 202. The heater may be an electric heater or a microwave heating device. In addition, superheated steam may be supplied between the molding dies 201 and 202 to heat the sheet S.

A temperature of the molding unit 200 for heating the sheet S is desirably a temperature for changing properties of the resin included in the additive material AD.

When the additive material AD includes a thermoplastic resin, the molding unit 200 performs the heating, for example, at 170° C. for 10 minutes. Specifically, the temperature of the molding unit 200 for heating the sheet S is preferably a temperature equal to or higher than a glass transition temperature, a melting point, or a softening point of the thermoplastic resin included in the additive material AD. For example, the heating temperature of the molding unit 200 can be set as a temperature equal to or higher than the glass transition temperature of the additive material AD and equal to or lower than the melting point thereof. In addition, the heating temperature may be a temperature higher than the melting point. A period of time of the heating by the molding unit 200 is set as a period of time in which the thermoplastic resin pinched between the molding die 201 and the molding die 202 is sufficiently dissolved or softened, and is, for example, 10 minutes or longer.

When the additive material AD includes a thermally expandable material, a temperature of the molding unit 200 for performing the heating is preferably a temperature equal to or higher than the temperature at which expansion or foaming of the thermally expandable material occurs. In this case, a period of time of the heating by the molding unit 200 is set as a period of time in which the thermally expandable material pinched between the molding die 201 and the molding die 202 can be sufficiently expanded, and is, for example, 10 minutes or longer.

In addition, when the additive material AD includes a thermosetting resin, a temperature of the molding unit 200 for performing the heating is preferably a temperature equal to or higher than the temperature at which phase transition or curing of the thermosetting resin occurs. A period of time of the heating by the molding unit 200 is set as a period of time in which the thermosetting resin pinched between the molding die 201 and the molding die 202 can be sufficiently cured, and is, for example, 10 minutes or longer.

The operation of the vibration plate manufacturing device 100 described above is controlled by a control device 110. The control device 110 controls at least the defibration unit 20, the additive material supply unit 52, the mixing blower 56, the dispersion unit 60, the second web formation unit 70, the pressing and heating unit 80, the cutting unit 90, the transportation unit 95, and the molding unit 200, to perform the manufacturing method of the vibration plate CP shown in FIG. 2. In addition, the control device 110 may control the operation of the supply unit 10, the selection unit 40, the first web formation unit 45, and the rotator 49.

The vibration plate manufacturing device 100 manufactures the vibration plate CP in a so-called dry type process of dispersing the mixture MX in the atmosphere and accumulating. As a method of molding the material including fibers, the papermaking of dispersing the fibers in a liquid, as described above, has been known, as a contrasting method with that of the vibration plate manufacturing device 100. Specifically, this is a so-called wet type papermaking of performing the papermaking and molding by dispersing fibers such as pulp. The wet type papermaking is a molding method using a hydrogen bond between fibers. In this method, the hydrogen bond between fibers strongly works due to the use of water, and it is difficult to ensure a long distance between fibers. Accordingly, a density of the fibers after the molding is high, and it is difficult to manufacture a molded product having a low density. In addition, since the wet papermaking uses a large amount of water, it is necessary to provide equipment for water supply and drainage.

The homogeneity is necessary for a speaker vibration plate, in order to obtain excellent sound quality. When the material other than the fiber, such as the additive material AD of the embodiment, is added, it is desirable that the material to be added is evenly present in the plane, without deviation in the structure of the vibration plate. In the wet papermaking, a plurality of materials are dispersed in water. Thus, deviation or aggregation may occur due to a difference in shape, a specific gravity, hydrophilicity and hydrophobicity, solubility, and dispersibility of the materials. Accordingly, unevenness of components or unevenness of a thickness may occur during the wet papermaking.

It is known that it is necessary to realize a low density, a high rigidity, and a high internal loss, as the properties of the speaker vibration plate, in order to obtain excellent sound quality.

In the vibration plate manufacturing device 100 and the manufacturing method of the vibration plate CP performed by the vibration plate manufacturing device 100 of the embodiment, a method of dispersing and accumulating the mixture MX including fibers defibrated by the dry method by the defibration unit 20, in the atmosphere is used. By this method, it is possible to manufacture the vibration plate CP having a low density, a high rigidity, and a high internal loss, as will be described later.

### 1-3. Configuration of Vibration Plate

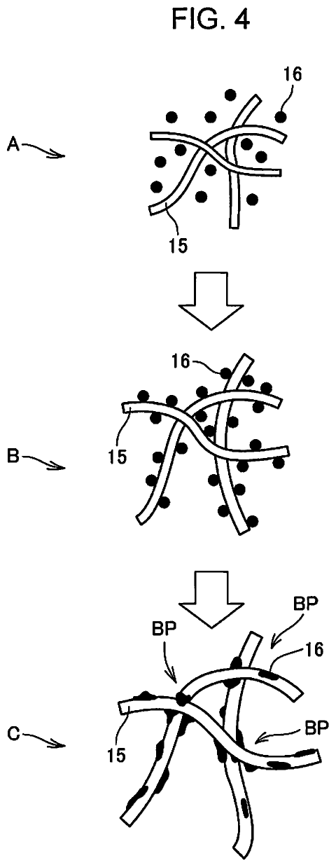

FIG. 4 is an explanatory view showing a configuration of the vibration plate CP, specifically, states of crosslinking by the additive material AD.

A reference numeral 15 of FIG. 4 is a fiber included in the mixture MX, and a reference numeral 16 is a particles of the resin included in the additive material AD. A state A is a state where the fibers 15 and the resins 16 are mixed with each other.

In the mixing step (Step SA5), the material MC and the additive material AD are mixed with each other by the mixing blower 56, and accordingly, the resins 16 are attached to the fibers 15, as shown in a state B shown in FIG. 4. The mixture MX are maintained in the state B in the sieving step (Step SA6) and the accumulation step (Step SA7). In the state B shown in FIG. 4, a plurality of the resins 16 are attached to the fibers 15.

After that, in the pressing and heating step (Step SA8) and the molding step (Step SA10), when the second web W2 or the sheet S is heated, the particles of the resins 16 are dissolved to crosslink and bind the fibers 15 and the fibers 15. This binding state is shown as a state C in FIG. 4. In the state C, the plurality of the fibers 15 are crosslinked and bound by the resins 16. The particles of the resins 16 are dissolved to crosslink and bind the fiber 15 and the fiber 15 at crosslinking points BP. Accordingly, on portions other than the crosslinking points BP, suitable spaces are ensured between the fiber 15 and the other fiber 15. At this time, the resins 16 are attached to the fibers 15 in a dotted manner or in an ruggedness shape, and accordingly, the crosslinking points are more easily formed, and the space between the fiber 15 and the other fiber 15 is easily provided.

The vibration plate manufacturing device 100 disperses the mixture MX including the fibers separated from the defibrated material MB and the additive material AD in the atmosphere in the sieving step (Step SA6) and accumulates the mixture in the accumulation step (Step SA7). Accordingly, the fibers 15 is accumulated and laminated on each other with random disposition and alignment. The laminated fibers 15 maintains the structure, while maintaining a suitable space and partially being in contact with other fiber in a dotted manner. Since the resins 16 are attached to the fibers 15, the plurality of fibers 15 in contact with each other in a dotted manner are crosslinked at the crosslinking points BP as in the state C, by the melting, softening, or curing caused by the heating of the resins 16.

As described above, the heated resins 16 form a crosslinked structure of fibers 15 in contact or adjacent to each other for the binding, and imparts a rigidity of a structure of the vibration plate CP, while maintaining the cavity of the structure of the vibration plate CP. The cavity of the vibration plate CP has an effect of decreasing the density of the vibration plate CP. In addition, since the fibers 15 are crosslinked at the plurality of crosslinking points BP, it is possible to apply a high rigidity to the vibration plate CP. Further, since the plurality of fibers 15 are crosslinked and bound in a dotted manner at the crosslinking points BP, it is possible to realize a high internal loss of the vibration plate CP. Therefore, the vibration plate CP has the high-level performances required for the speaker vibration plate which are a low density, a high rigidity, and a high internal loss.

The resins 16 which did not contribute to the crosslinked structure has an operation of coating the surfaces of the fibers 15, and accordingly, an effect of improving the rigidity of the fibers 15 can be expected. In addition, the resins 16 operate as a minute deformation region in the structure of the vibration plate CP, and absorbs impact or an energy applied to the vibration plate CP and releases and alleviates it as a heat energy. Accordingly, the resins 16 which did not contribute to the binding exhibit a function of impact absorption or a function of noise absorption as the internal loss, and therefore, the improvement of the effect of increasing the internal loss of the vibration plate CP can be expected.

As described above, according to the vibration plate manufacturing device 100, the vibration plate CP having a low density and a light weight is obtained. In addition, in the manufacturing method of the vibration plate CP of the embodiment, as the additive material AD, the resins 16 for binding the fibers to each other are added as particles, and the fibers 15 are bound with each other by these particles. Accordingly, the fibers 15 have free mobility on a portion other than the crosslinking points BP. Thus, even when impact or an energy is applied, the applied energy can be rapidly attenuated, without approaching a structural disorder or resonance. In addition, in the manufacturing method of the vibration plate CP of the embodiment, by controlling a rotation rate of the defibration unit 20, a supply speed of the raw material MA to the defibration unit 20, and the like, it is possible to easily control the fiber shape or the size and density of the fibers. It is possible to control the additive amount of the additive material AD at a high degree of freedom, by the additive material supply unit 52. It is also possible to control the temperature or the pressure of the heating unit 84 and the molding unit 200. Therefore, it is possible to manufacture the vibration plate CP with high quality, as the speaker vibration plate.

The vibration plate manufacturing device 100 performs the molding process including pressing and heating the second web W2 by the pressing and heating unit 80 to form the sheet S, and setting and heating the sheet S in the molding unit 200. Since the sheet S has a higher strength than that of the second web W2, the sheet S is hardly damaged in a step of transporting the sheet S to the molding unit 200 by the transportation unit 95. Therefore, it is possible to efficiently and rapidly manufacture the vibration plate CP. In addition, by cutting the sheet S by the cutting unit 90 before setting the sheet on the molding unit 200, it is possible to increase a processing efficiency of the molding unit 200.

The preferable properties of the vibration plate CP formed in the molding step (Step SA10) are disclosed.

A ratio of the fibers 15 and the resins 16, that is, a fiber:resin ratio is preferably fiber:resin ratio=5:95 to 95:5. Particularly, it is more preferably fiber:resin ratio=40:60 to 95:5. More specifically, a fiber density per 1 cm³ of the vibration plate CP is 0.0003 g/cm³ to 1.5 g/cm³, and a resin density is preferably 0.001 g/cm³ to 1.5 g/cm³. More preferably, the fiber density per 1 cm³ of the vibration plate CP is 0.095 g/cm³ to 0.9 g/cm³, and the resin density is preferably 0.005 g/cm³ to 0.9 g/cm³.

In addition, a thickness of the vibration plate CP is preferably equal to or smaller than 7.5 mm.

A basis weight of the vibration plate CP is preferably equal to or greater than 10 g/m² and smaller than 700 g/m². The basis weight is a so-called basis weight.

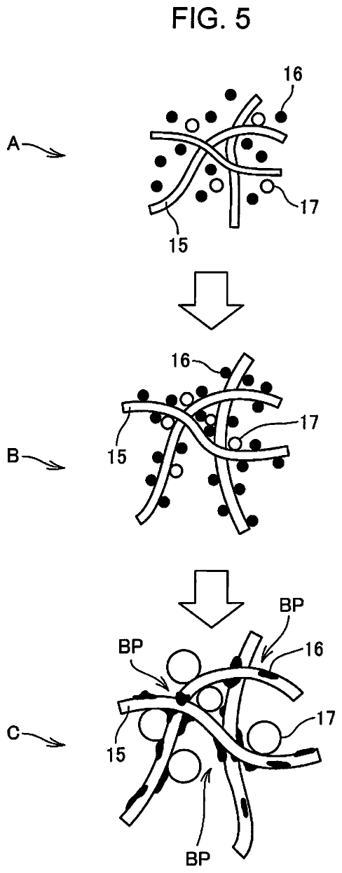

FIG. 5 is an explanatory view showing a configuration of the vibration plate CP and shows states of crosslinking, in a case of using the thermally expandable material.

An example shown in FIG. 5 is an example in which the additive material AD including the resin and the thermally expandable material is added to the material MC, in the addition step (Step SA4). A reference numeral 17 of FIG. 5 is a particle of a foaming particle included in the additive material AD. The foaming particle 17 corresponds to the thermally expandable material. A state A shows a state where the fiber 15 and the additive material AD are mixed with each other.

In the mixing step (Step SA5), when the material MC and the additive material AD are mixed with each other by the mixing blower 56, the resins 16 and the foaming particles 17 area attached to the fibers 15, as shown in a state B. The mixture MX is maintained in the state B in the sieving step (Step SA6) and the accumulation step (Step SA7).

In the pressing and heating step (Step SA8) and the molding step (Step SA10), when the second web W2 or the sheet S is heated, the foaming particles 17 are expanded, and the space between the fiber 15 and the fiber 15 is enlarged or maintained. In this state, the particles of the resins 16 are dissolved to crosslink and bind the fiber 15 and the fiber 15. The crosslinked state is shown as a state C in FIG. 5. In the state C, a plurality of the fibers 15 are crosslinked by the resins 16. By dissolving the particles of the resins 16, the fiber 15 and the fiber 15 are crosslinked and bound at the crosslinking points BP. On portions other than the crosslinking points BP, the space between the fiber 15 and the other fiber 15 is ensured by the expanded foaming particles 17.

As described above, in the vibration plate manufacturing device 100, the mixture MX is dispersed and accumulated in the atmosphere, and accordingly, the space between the fiber 15 and the fiber 15 can be ensured. In addition, when the foaming particles 17 are included in the additive material AD, the foaming particles 17 attached to the fibers 15 are expanded by the heating, and accordingly, the contact between the fiber 15 and the fiber 15 can be reliably set as a contact in a dotted manner. Therefore, in the state C, the state where the fiber 15 and the other fiber 15 are crosslinked at the crosslinking points BP in a dotted manner can be more reliably realized.

In the same manner as in the example described with reference to FIG. 4, even in a case of using the additive material AD including the foaming particles 17, it is possible to obtain the vibration plate CP having a low density, a light weight, a high rigidity, and a high internal loss. In addition, in the adding step (Step SA4), by adding the foaming particles 17, the vibration plate CP can be realized with a lower density, a higher rigidity, and a higher internal loss.

The preferable properties of the vibration plate CP formed in the molding step (Step SA10), in a case where the additive material AD includes the thermally expandable material are disclosed.

The fiber density per 1 cm³ of the vibration plate CP is preferably 0.0003 g/cm³ to 1.5 g/cm³, the resin density is preferably 0.001 g/cm³ to 1.5 g/cm³, and the density of the foaming particles is preferably 0.00001 g/cm³ to 1.5 g/cm³. More preferably, the fiber density per 1 cm³ of the vibration plate CP is 0.095 g/cm³ to 0.9 g/cm³, the resin density is preferably 0.005 g/cm³ to 0.9 g/cm³, and the density of the foaming particles is preferably 0.00001 g/cm³ to 0.9 g/cm³. In addition, the foaming particles 17 are preferably coated with the resins, and the coverage of the foaming particles with the resins is preferably 10% to 100%.

The thickness of the vibration plate CP is preferably equal to or smaller than 7.5 mm.

The basis weight of the vibration plate CP is preferably equal to or greater than 10 g/m² and smaller than 700 g/m².

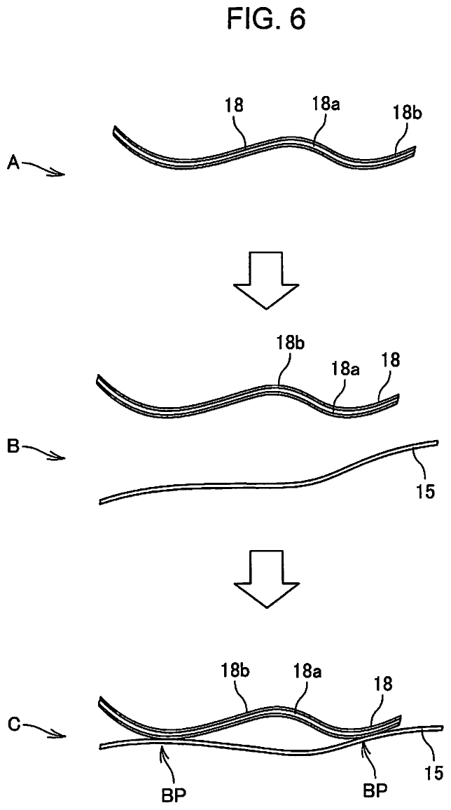

FIG. 6 is an explanatory view showing the configuration of the vibration plate CP and shows state of crosslinking in a case of using core-sheath structured fibers 18.

An example shown in FIG. 6 is an example in which the additive material AD including the core-sheath structured fibers 18 is added to the material MC, in the addition step (Step SA4). A state A of FIG. 6 shows the core-sheath structured fibers 18 of the additive material AD.

The core-sheath structured fiber 18 is a fibrous synthesis resin in which a resin layer 18b is formed on a surface of a resin fiber 18a. Both of the resin fiber 18a and the resin layer 18b are configured with a thermoplastic resin. The resin fiber 18a is a synthesis fiber having a strength as that of the fiber, and preferably has a rigidity and/or a tensile strength which are substantially the same as those of the fiber 15. In addition, a size of the core-sheath structured fiber 18, that is, a fiber length and a fiber diameter are preferably substantially the same as that of the fiber 15. That is, the size thereof is preferably substantially the same as that of the fiber included in the defibrated material MB.

A glass transition temperature of the resin fiber 18a is a higher temperature than the glass transition temperature of the resin layer 18b. In addition, a softening temperature of the resin fiber 18a may be a higher temperature than that of the resin layer 18b. Accordingly, when the core-sheath structured fiber 18 is heated, the resin layer 18b is softened or dissolved at a lower temperature than that of the resin fiber 18a.

When the additive material AD including the core-sheath structured fiber 18 is added to the material MC, a state where the fibers 15 and the core-sheath structured fibers 18 are mixed with each other is realized, as shown as a state B.

The fiber 15 and the core-sheath structured fiber 18 may be in contact with each other, but a state where the fiber and the core-sheath structured fiber is not completely stuck to each other is maintained due to the rigidity thereof.

When the pressing and the heating are performed in the pressing and heating unit 80 or the molding unit 200, the core-sheath structured fiber 18 is in contact with the fiber 15. Here, when the resin layer 18b is dissolved or softened by the heating, the core-sheath structured fiber 18 and the fiber 15 are crosslinked at the crosslinking points BP by the resin layer 18b. Since the core-sheath structured fiber 18 and the fiber 15 are in contact due to the rigidity thereof in a dotted manner, a space between the core-sheath structured fiber 18 and the fiber 15 is generated on portions other than the crosslinking points BP. Although not shown, the core-sheath structured fiber 18 are crosslinked and bound with a plurality of the fibers 15, the vibration plate CP having a three-dimensional crosslinked structure is obtained, in the same manner as in the examples shown in FIGS. 4 and 5.

As described above, the vibration plate manufacturing device 100 disperses and accumulates the mixture MX in the atmosphere, and accordingly, it is possible to ensure the space between the fiber 15 and the fiber 15. In addition, when the core-sheath structured fiber 18 is included in the additive material AD, it is possible reliably to set the contact between the fiber 15 and the core-sheath structured fiber 18, and the fiber 15 and the fiber 15, as the contact in a dotted manner, by the rigidity of the core-sheath structured fiber 18. Accordingly, in a state C, it is possible to more reliably realize a state where the fiber 15 and the core-sheath structured fiber 18 and the other fiber 15 are crosslinked at the crosslinking points BP in a dotted manner.

In the same manner as the example described with reference to FIG. 4, even in a case of using the additive material AD including the core-sheath structured fiber 18, it is possible to obtain the vibration plate CP having a low density, a light weight, a high rigidity, and a high internal loss.

As described above, the vibration plate CP manufactured by the vibration plate manufacturing device 100 of the first embodiment includes the defibrated material MB obtained by the defibration of the raw material MA which is the material including fibers, and the additive material AD including the binding material for binding the fibers. The vibration plate CP is a speaker vibration plate formed by the molding process including the pressing and heating.

Since the additive material (particles of the resins) AD is added to the defibrated material MB obtained by the defibration of the material, the vibration plate CP has a configuration in which the deviation or aggregation of the fibers 15 and the resins 16 is prevented and the fibers 15 and the resins 16 are homogenously distributed. In the vibration plate CP, the fibers 15 are homogenously distributed and crosslinked by the resins 16, and the defibrated fibers 15 are used, and accordingly, the fiber 15 and the other fiber 15 are crosslinked in a dotted manner. Accordingly, the vibration plate CP has a low density, a light weight, a great internal loss, and a high rigidity due to the crosslinking. Therefore, the vibration plate CP has the preferred properties for the speaker vibration plate. It is preferable that the defibrated material MB is defibrated in the atmosphere, because the deviation or aggregation of the fibers 15 and the resins 16 is effectively prevented.

In the vibration plate CP, the binding material (particles of the resins) include at least any of the thermoplastic resin and the thermosetting resin. Accordingly, it is possible to easily realize the configuration in which the fibers 15 are crosslinked by the resins 16, by the process including the heating, and it is possible to provide the vibration plate CP having properties of a low density, a high rigidity, and a high internal loss which are preferable for the speaker vibration plate.

When the additive material AD includes the foaming particles 17 as the thermally expandable material, the vibration plate CP includes a thermally expandable material. In this case, it is possible to ensure the space between the fiber 15 and the other fiber 15 included in the vibration plate CP by the foaming particles 17, and to realize the configuration in which the fiber 15 and the other fiber 15 are in contact and crosslinked in a dotted manner. The vibration plate CP have desirable properties for the speaker vibration plate such as a lower density, a greater internal loss, and a higher density by the crosslinking.

The vibration plate manufacturing device 100 includes the defibration unit 20 which defibrates the raw material MA as the material including the fibers 15, and the mixing unit 50 which mixes the additive material AD including the resins 16 as the binding material for crosslinking of the fibers 15, with the defibrated material MB defibrated by the defibration unit 20. The vibration plate manufacturing device 100 includes the second web formation unit 70 as the accumulation unit which accumulates the mixture MX mixed by the mixing unit 50. The vibration plate manufacturing device 100 includes the molding unit 200 which forms the second web W2 accumulated by the second web formation unit 70 on the vibration plate CP, by the molding process including the pressing and heating.

The vibration plate manufacturing device 100, to which the speaker vibration plate manufacturing device and the manufacturing method of the speaker vibration plate of the present disclosure are applied, adds and mixes the additive material AD to the defibrated material MB obtained by the defibration of the raw material MA. Accordingly, the fibers 15 included in the raw material MA and the additive material AD can be mixed with each other by preventing the deviation or aggregation. Thus, the vibration plate CP manufactured by the vibration plate manufacturing device 100 can have a configuration in which the fibers 15 and the additive material AD are homogenously distributed. Therefore, by performing the molding process by the molding unit 200, the fibers 15 can be homogenously distributed and crosslinked by the resins 16. Specifically, since the fibers 15 are homogenously mixed with the resins 16, the fiber 15 is crosslinked with the other fiber 15 in a dotted manner, by the molding process of the molding unit 200. Accordingly, the vibration plate CP has a low density, a light weight, a great internal loss, and a high rigidity by the crosslinking. Therefore, the vibration plate CP has the preferred properties for the speaker vibration plate.

The mixing unit 50 disperses the mixture, and the second web formation unit 70 as the accumulation unit accumulates the mixture MX. Accordingly, the fibers 15 included in the material MC and the resins 16 of the additive material AD can be mixed with each other by preventing the deviation or aggregation.

The mixing unit 50 may mix the resins 16 and the foaming particles 17 expanded by the heating, with the defibrated material MB. That is, the additive material AD including the resins 16 and the foaming particles 17 may be mixed with the material MC derived from the defibrated material MB. In this case, it is possible to ensure the space between the fiber 15 and the other fiber 15 included in the vibration plate CP by the foaming particles 17, and to realize the configuration in which the fiber 15 and the other fiber 15 are in contact and crosslinked by the resins 16. Therefore, it is possible to provide the vibration plate CP having desirable properties for the speaker vibration plate such as a lower density, a greater internal loss, and a higher rigidity by the crosslinking.

The mixing unit 50 mixes the defibrated material, and the binding material including at least any of the thermoplastic resin and the thermosetting resin. Therefore, it is possible to easily realize the configuration in which the fibers 15 are crosslinked by the resins 16 by performing the molding process including the heating by the molding unit 200, and it is possible to provide the vibration plate CP having the preferred properties for the speaker vibration plate.

The second web formation unit 70 accumulates the mixture MX and forms the second web W2. The vibration plate manufacturing device 100 includes the pressing and heating unit 80 which presses and heats the second web W2 to form the sheet S. The molding unit 200 presses and heats the sheet S set on the molding die in the molding process. According to this configuration, since the material of the vibration plate CP is the sheet S in a sheet shape, it is possible to easily perform a step of setting the material on the molding unit 200. In addition, in a stage before performing the molding process by the molding unit 200, it is also easy to temporarily store the sheet S. Accordingly, it is possible to increase a manufacturing efficiency of the vibration plate CP.

### 2. Second Embodiment

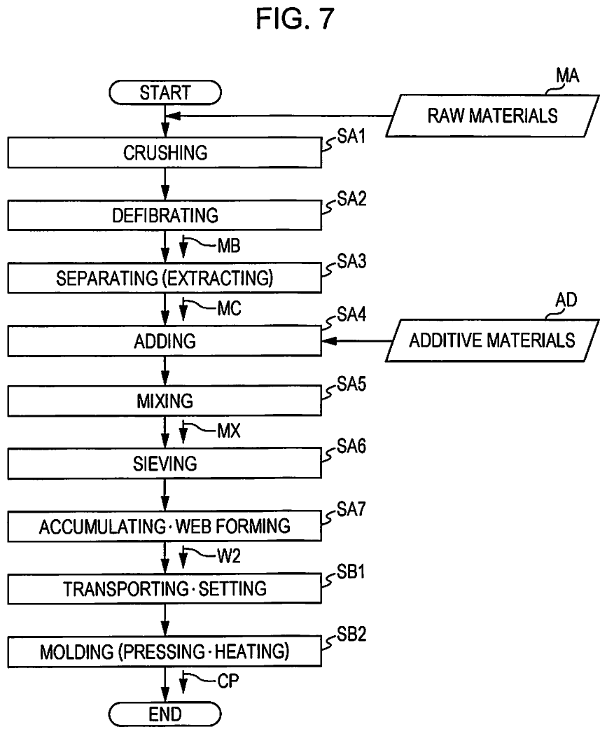

FIG. 7 is a flowchart showing a manufacturing method of the vibration plate CP of a second embodiment.

In a manufacturing step of the vibration plate CP of the second embodiment, the pressing and heating step (Step SA8) shown in FIG. 2 is not performed, after forming the second web W2 in Step SA7. In the manufacturing step of the vibration plate CP of the second embodiment, Steps SA1 to SA7 are the same as those in the manufacturing method described in the first embodiment, and therefore, the description is omitted.

The manufacturing step of the vibration plate CP of the second embodiment includes a transportation step (Step SB1) of transporting the second web W2 formed in Step SA7 to the molding unit 200. In the transportation step (Step SB1), the second web W2 is transported to the molding unit 200, without performing the pressing or heating. In addition, the second web W2 may be cut in the transportation step (Step SB1).

After that, a molding step in Step SB2 is performed. The molding step (Step SB2) is a step of pressing and heating the second web W2 by molding dies and forming the vibration plate CP.

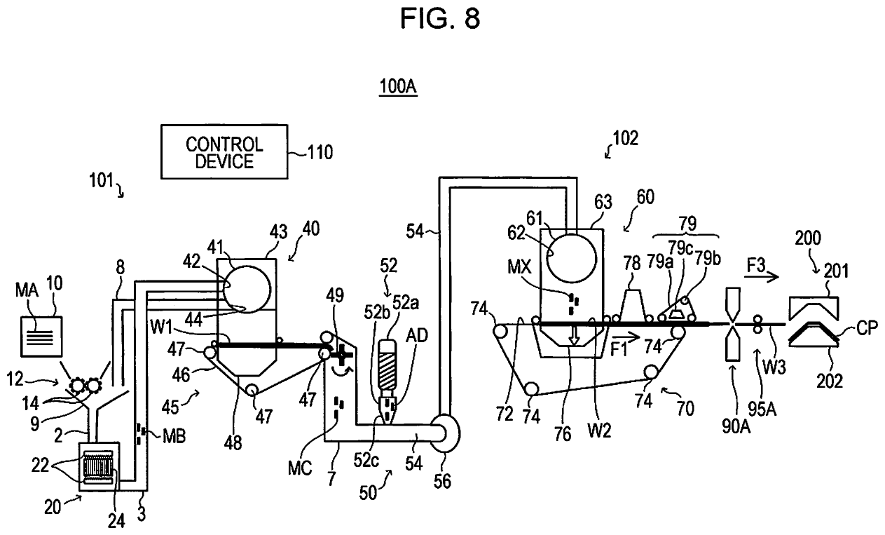

FIG. 8 is a configuration view of a vibration plate manufacturing device 100A of the second embodiment.

The vibration plate manufacturing device 100A has a configuration in which a cutting unit 90A is provided instead of the cutting unit 90 of the vibration plate manufacturing device 100 shown in FIG. 2, a transportation unit 95A is provided instead of the transportation unit 95, and the pressing and heating unit 80 is omitted. In the vibration plate manufacturing device 100A, the same reference numerals are used for the common configuration units with the vibration plate manufacturing device 100, and therefore, the description thereof is omitted. The vibration plate manufacturing device 100A corresponds to a speaker vibration plate manufacturing device.

The vibration plate manufacturing device 100A lifts up and transports the second web W2 formed by the second web formation unit 70 from the mesh belt 72 by the web transportation unit 79. The cutting unit 90A cuts the second web W2. The cutting unit 90A may be a cutter which cuts the second web W2 to have a shape of the molding dies 201 and 202. For example, the cutting unit 90A may include a first cutting unit which cuts the second web W2 in a direction intersecting with a transportation direction F3 of the second web W2. In addition, the cutting unit 90A may include a second cutting unit which cuts the second web W2 in a direction parallel to the transportation direction F3, in addition to the first cutting unit.

The second web W2 cut by the cutting unit 90A is transported to the molding unit 200 by the transportation unit 95A. The transportation unit 95A is different from the transportation unit 95 which transports the sheet S, and may have a configuration suitable for transporting the second web W2 having a lower rigidity and a lower strength than those of the sheet S. For example, the transportation unit 95A may be a conveyer which includes rollers having a greater diameter than those of the rollers included in the transportation unit 95, and transports the second web W2.

The molding unit 200 presses and heats the second web W2 pinched between a pair of molding dies 201 and 202 and forms the vibration plate CP.

The transportation unit 95A performs the transportation step (Step SB1). In addition, the transportation step (Step SB1) may include the operation of the cutting unit 90A. Further, the operation of the molding unit 200 corresponds to the molding step (Step SB2).

The shape, the pressing conditions, or the heating conditions of the molding die 201 and the molding die 202 are the same as those in the first embodiment. In addition, the configuration of heating the second web W2 by the molding unit 200 can be common with the configuration of heating the sheet S by the molding unit 200 in the first embodiment.

According to the vibration plate manufacturing device 100A and the manufacturing method of the vibration plate CP performed by the vibration plate manufacturing device 100A, it is possible to obtain the same effect as that of the vibration plate manufacturing device 100 described in the first embodiment. In addition, in the vibration plate manufacturing device 100A, it is also possible to add the foaming particles 17 or the core-sheath structured fibers 18 to the additive material AD.

In the vibration plate manufacturing device 100A, the second web W2 formed by the second web formation unit 70 is set on the molding unit 200, and the molding unit 200 presses and heats the second web W2 set on the molding dies 201 and 202. According to this configuration, the step of processing the second web W2 to the sheet S can be omitted, and accordingly, it is possible to increase the manufacturing efficiency of the vibration plate CP and improve the manufacturing lead time. In addition, by controlling the conditions of the pressing and heating of the molding unit 200, it is possible to more specifically control the state change of the mixture MX due to the pressing and heating. That is, by considering the effect of the first pressing and heating to the state of the fibers and the additive material AD included in the mixture MX, it is advantageous to more easily adjust the structure or the properties of the vibration plate CP.

### 3. Third Embodiment

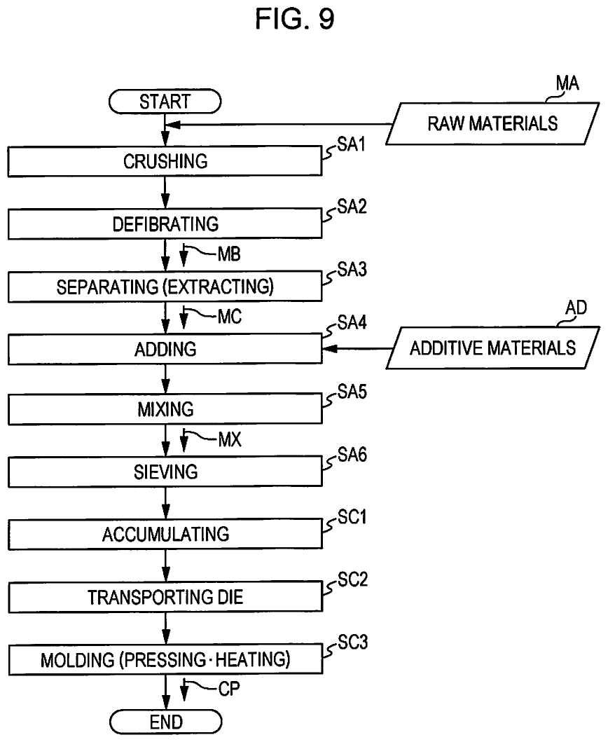

FIG. 9 is a flowchart showing a manufacturing method of the vibration plate CP of a third embodiment.

In a manufacturing step of the vibration plate CP of the third embodiment, the mixture MX is dispersed in the sieving step of Step SA6, and an accumulation step (Step SC1) of accumulating the mixture MX on the molding die 202 is performed. In the manufacturing step of the vibration plate CP of the third embodiment, Steps SA1 to SA6 are the same as those in the manufacturing method described in the first embodiment, and therefore, the description is omitted.

The manufacturing step of the vibration plate CP of the third embodiment includes the accumulation step (Step SC1) of accumulating the mixture MX dispersed in Step SA6 on the molding die 202. In the accumulation step (Step SC1), the molding die 202 is disposed on a position where mixture MX is to be dropped, and the mixture MX is accumulated on the molding die 202.

Then, a transportation step (Step SC2) of transporting the molding die 202 is performed. In the transportation step (Step SC2), the molding die 202 is transported to a position fit to the molding die 201. Then, a molding step (Step SC3) is performed. In the molding step (Step SC3), the pressing and heating are performed, and the vibration plate CP is formed, under the same conditions as in the molding step (Step SB2).

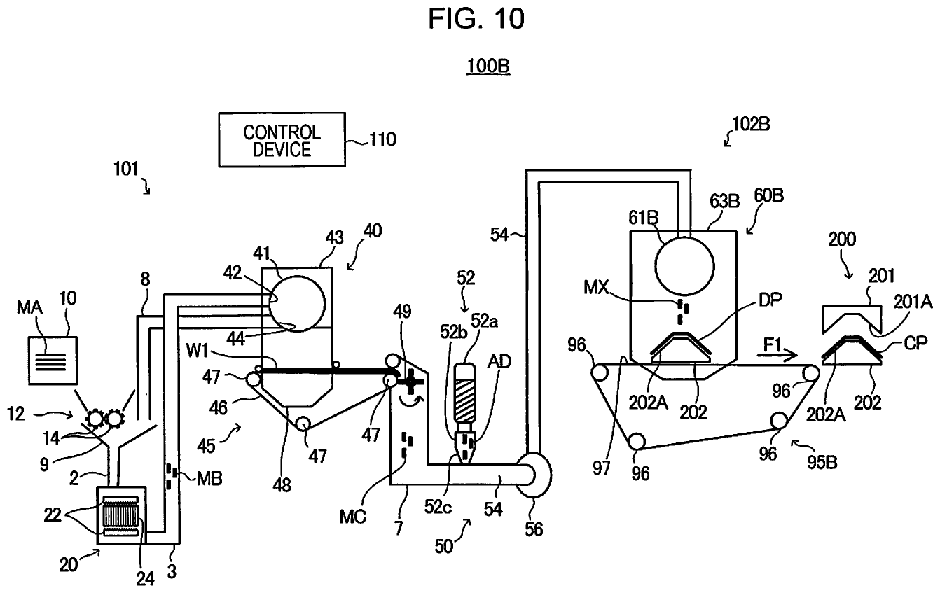

FIG. 10 is a configuration view of a vibration plate manufacturing device 100B of the third embodiment.

The vibration plate manufacturing device 100B has a configuration in which a dispersion unit 60B and an accumulation unit 95B are provided instead of the dispersion unit 60 and the second web formation unit 70 of the vibration plate manufacturing device 100 shown in FIG. 2, and the pressing and heating unit 80, the cutting unit 90, and the transportation unit 95 are not included. In the vibration plate manufacturing device 100B, the same reference numerals are used for the common configuration units with the vibration plate manufacturing device 100, and therefore, the description thereof is omitted. The vibration plate manufacturing device 100B corresponds to a speaker vibration plate manufacturing device. The accumulation unit 95B corresponds to the accumulation unit.

The dispersion unit 60B includes a housing 63B larger than the housing 63 included in the dispersion unit 60. The housing 63B has a size capable of accommodating the molding die 202. In the housing 63B, a dispersion drum 61B configured in the same manner as the dispersion drum 61 is disposed in the housing 63B. In the same manner as in the dispersion drum 61, the dispersion drum 61B disperses and drops the mixture MX in the atmosphere in the housing 63B by the rotation. The operation of the dispersion unit 60B corresponds to the sieving step (Step SA6)

In the housing 63B, the molding die 202 is positioned on a lower side of the dispersion drum 61B.

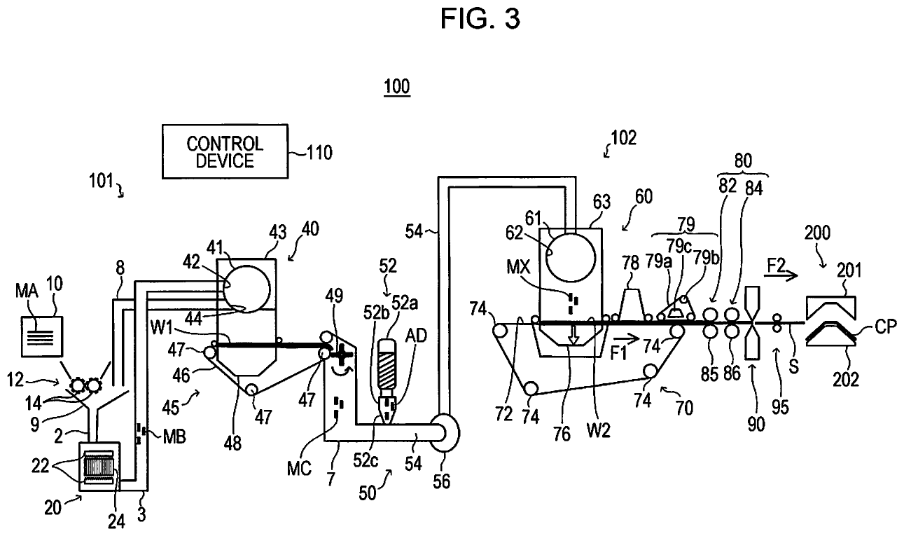

As shown in FIG. 3 and FIG. 8, the molding die 202 is configured in a truncated cone shape, in order to form the vibration plate CP having a conical shape. The molding die 202 is protruded upwards and positioned on a lower side of the dispersion drum 61B.

The molding unit 200 is configured with a combination of the molding die 202 having a truncated cone shape protruded upwards, and the molding die 201 which is positioned on an upper side of the molding die 202 and includes a fitting unit 201A a recessed upwards. The upper surface of the molding die 202 is a mounting surface 202A on which the material is mounted.

The mixture MX is accumulated on the mounting surface 202A and an accumulated material DP is configured. The side of the accumulated material DP in contact with the mounting surface 202A is the front surface 1002 of the vibration plate CP.

In order to set the shape of the vibration plate CP as a conical shape, the molding unit 200 may also have a upside-down configuration. That is, the molding die 202 having a mortar-shaped recess having a depth in the center, and the molding die 201 which is protruded downwards towards the molding die 202 may be combined with each other.

However, in the vibration plate manufacturing device 100B of the third embodiment, the molding die 202 including the mounting surface 202A protruded upwards having a truncated cone shape is suitable.

In the dispersion unit 60B, the accumulation step (Step SC1) of accumulating the mixture MX on the mounting surface 202A, the mounting surface 202A is protruded upwards, and accordingly, it is advantageous that the accumulated state of the mixture MX on a tilted surface of the mounting surface 202A is easily homogenized. When the mounting surface 202A has a bowl shape, a large amount of the mixture MX is accumulated so as to be dropped from the tilted surface of the mounting surface 202A, and accordingly, the amount of the mixture MX exceeding the assumption may be accumulated in the mounting surface 202A. That is, when the shape of the mounting surface 202A is protruded downwards, the operation of collecting a large amount of the mixture MX is worked, and an unevenness in thickness of the accumulated material DP is easily generated. Accordingly, it is necessary to perform detailed adjustment or control for homogenization of the thickness of the accumulated material DP.

With respect to this, when the molding die 202 positioned on a lower side of the dispersion drum 61B is disposed so that the mounting surface 202A is protruded upwards, a large amount of mixture MX is not collected on the tilted surface of the mounting surface 202A. Accordingly, it is possible to prevent the unevenness in thickness of the accumulated material DP. Therefore, in the accumulation step (Step SC1), it is preferable to dispose the molding die 202 including the mounting surface 202A having a truncated cone shape, on a lower side of the dispersion drum 61B, so that the mounting surface 202A is protruded upwards.

The accumulation unit 95B has a function of positioning the molding die 202 on a lower side of the dispersion drum 61B and transporting the molding die 202 to the position of the molding unit 200. The accumulation unit 95B includes an endless belt 97 suspended over stretching rollers 96, and can mount and move the molding die 202 by a circulation movement of the belt 97. The belt 97 approaches to the position of the molding die 201 of the molding unit 200, and the molding die 202 is transported from the lower side of the dispersion drum 61B to the lower side of the molding die 201, by the accumulation unit 95B.

The operation of the accumulation unit 95B corresponds to the transportation step (Step SC2). The operation of the molding unit 200 corresponds to the molding step (Step SC3).

The shape, the pressing conditions, or the heating conditions of the molding die 201 and the molding die 202 are the same as those in the second embodiment. In addition, the configuration of heating the accumulated material DP by the molding unit 200 can be common with the configuration of heating the sheet S by the molding unit 200 in the first embodiment.

According to the vibration plate manufacturing device 100B and the manufacturing method of the vibration plate CP performed by the vibration plate manufacturing device 100B, it is possible to obtain the same effect as those of the vibration plate manufacturing devices 100 and 100A described in the first embodiment and the second embodiment. In addition, in the vibration plate manufacturing device 100B, it is also possible to add the foaming particles 17 or the core-sheath structured fibers 18 to the additive material AD.

In vibration plate manufacturing device 100B, the mixture MX is accumulated on the molding die 202 to form the accumulated material DP, on which the mixture MX is laminated, and the accumulated material DP is heated by the molding unit 200. Accordingly, the step of forming and transporting the second web W2 or the step of processing the second web W2 into the sheet S can be omitted. Thus, it is possible to increase the manufacturing efficiency of the vibration plate CP. In addition, by controlling the conditions of the pressing and heating of the molding unit 200, it is possible to more specifically control the state change of the accumulated material DP due to the pressing and heating. That is, by considering the effect of the first pressing and heating to the state of the fibers and the additive material AD included in the accumulated material DP, it is advantageous to more easily adjust the structure or the properties of the vibration plate CP.

### 4. Fourth Embodiment

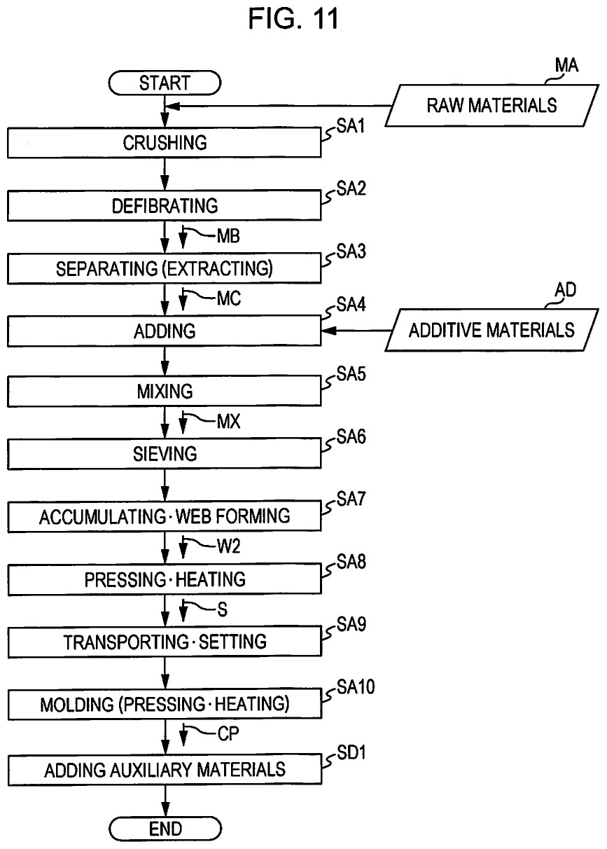

FIG. 11 is a flowchart shoring a manufacturing method of the vibration plate CP of a fourth embodiment.

In a manufacturing step of the vibration plate CP of the fourth embodiment, the vibration plate CP is formed in the step SA10, an auxiliary material adding step (Step SD1) is performed. In the manufacturing step of the vibration plate CP of the fourth embodiment, Steps SA1 to SA10 are the same as those in the manufacturing method described in the first embodiment, and therefore, the description is omitted.

The auxiliary material adding step (Step SD1) is a step of attaching an auxiliary material to the front surface 1002 or the rear surface 1004 of the vibration plate CP. In the auxiliary material adding step, for example, an ejecting head 301 which ejects a liquid auxiliary material from nozzles can be used. The ejecting head 301 has a configuration of ejecting the auxiliary material by heating or by using a piezoelectric element, and can have the same configuration as that of a printing head of an ink jet printer, for example.

The auxiliary material adding step (Step SD1) may include a step of drying or fixing the auxiliary material attached to the vibration plate CP.

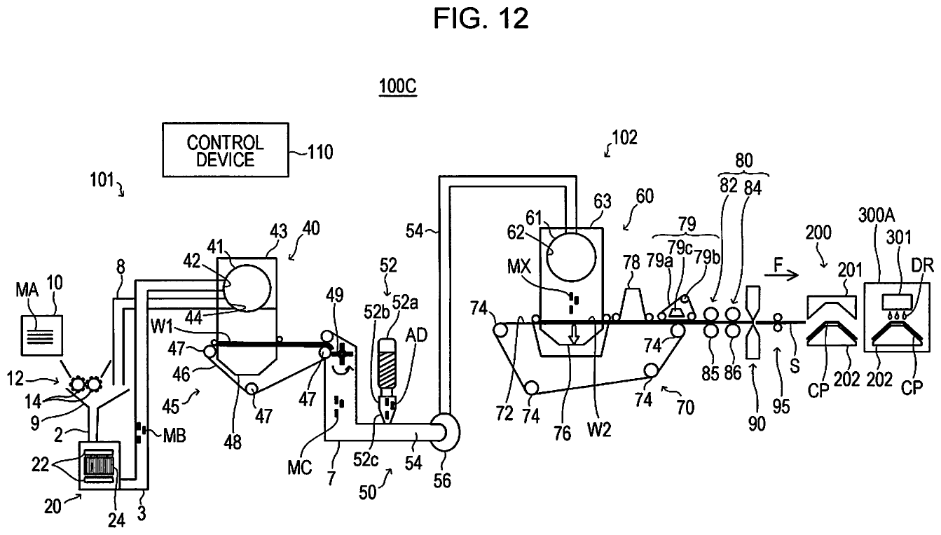

FIG. 12 is a configuration view of a vibration plate manufacturing device 100C of the fourth embodiment.

The vibration plate manufacturing device 100C has a configuration in which a material ejection unit 300A is provided in the vibration plate manufacturing device 100 shown in FIG. 2. In the vibration plate manufacturing device 100C, the same reference numerals are used for the common configuration units with those of the vibration plate manufacturing device 100, and therefore, the description thereof is omitted. The vibration plate manufacturing device 100C corresponds to a speaker vibration plate manufacturing device.

After forming the vibration plate CP by the molding unit 200, the molding die 202 is transported to the material ejection unit 300A while mounting the vibration plate CP.

The material ejection unit 300A includes the ejecting head 301. The ejecting head 301 is movably disposed on an upper side of the molding die 202, and a liquid auxiliary material DR is ejected from the ejecting head 301. Although not shown, the material ejection unit 300A may include a tank for storing the liquid auxiliary material DR and a supply tube for supplying the liquid auxiliary material DR from the tank to the ejecting head 301. The material ejection unit 300A corresponds to the attachment processing unit. The liquid auxiliary material DR corresponds to the auxiliary material.

By moving the ejecting head 301 while ejecting the liquid auxiliary material DR from the ejecting head 301, the liquid auxiliary material DR can be attached to the vibration plate CP on the molding die 202.

The material ejection unit 300A attaches the liquid auxiliary material DR to the vibration plate CP. THE material ejection unit 300A may attach the liquid auxiliary material DR to the front surface 1002 of the vibration plate CP or to the rear surface 1004 thereof. When the liquid auxiliary material DR is attached to the rear surface 1004, the vibration plate manufacturing device 100C may include a mechanical transportation unit which extracts the vibration plate CP from the molding die 202 and performing vertical inversion.

The liquid auxiliary material DR may be any of an aqueous solution and an organic solution, and for example, a liquid including an acrylic dispersion liquid as a solvent and glycerin as a moisture retaining material can be used. The liquid auxiliary material DR may be not a solution and may be liquid of the auxiliary material. The liquid auxiliary material DR may include a resin cured after attaching and dried onto the vibration plate CP. The liquid auxiliary material DR may include a resin cured after the heating.

The material ejection unit 300A may have a configuration in which an auto-stage or a transportation belt which moves the molding die 202 is provided on a lower side of the ejecting head 301, without moving the ejecting head 301.

When the liquid auxiliary material DR is attached by the material ejection unit 300A, a fiber:resin ratio is preferably 5:95 to 95:5 and more preferably 5:95 to 70:30, as the configuration of the vibration plate CP.

In addition, the material ejection unit 300A may have a configuration of ejecting a plural kinds of the liquid auxiliary materials DR from the ejecting head 301 to attach the liquid auxiliary materials DR to the vibration plate CP.

The material ejection unit 300A may attach the liquid auxiliary material DR to the entire portion of the front surface 1002 and/or the rear surface 1004 of the vibration plate CP or may be attached to a part thereof.

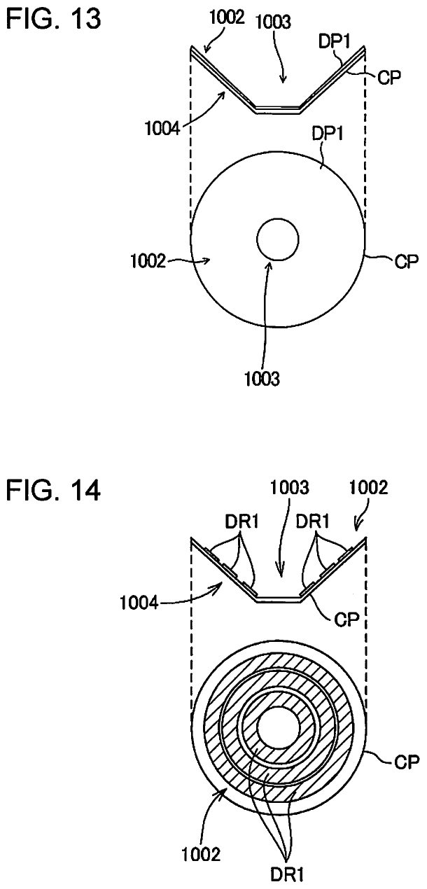

FIGS. 13 to 19 are explanatory views showing specific examples of the auxiliary material adding step.

Although not shown, the most typical example is an example in which the liquid auxiliary material DR is attached to the entire portion of the front surface 1002 of the vibration plate CP.

An example shown in FIG. 13 is an example in which the liquid auxiliary material DR is attached to the entire portion of the front surface 1002, and a thickness of an auxiliary material layer DR1 formed by the liquid auxiliary material DR is changed. The auxiliary material layer DR1 is formed on the entire portion of the front surface 1002, and the thickness of the auxiliary material layer DR1 is substantially thicker on the outer peripheral portion of the vibration plate CP. The control device 110 controls the amount of the liquid auxiliary material DR ejected from the ejecting head 301 and the movement of the ejecting head 301 or the movement of the molding die 202, and accordingly, it is possible to realize a configuration in which the thickness of the auxiliary material layer DR1 is intermittently or continuously changed towards the outer peripheral from the inner peripheral.

An example shown in FIG. 14 is an example in which the liquid auxiliary material DR is attached to the vibration plate CP so as to draw a plurality of rings. The auxiliary material layers DR1 configured of the liquid auxiliary material DR are disposed so as to draw concentric circles on the front surface 1002. A plurality of the auxiliary material layers DR1 has a function of adjusting the transfer of vibration of the vibration plate CP so as rib used in some of cone paper.

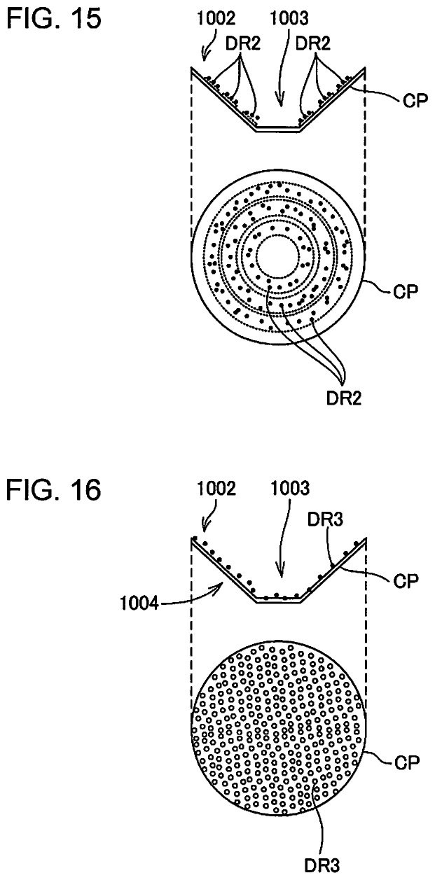

An example shown in FIG. 15 is an example in which the liquid auxiliary material DR is attached to the vibration plate CP so as to draw a plurality of rings, and the liquid auxiliary material DR is attached so as to draw dotted shapes. Accordingly, dotted-shaped auxiliary material layers DR2 are disposed on the front surface 1002 so as to draw rings.

An example shown in FIG. 16 is an example in which the liquid auxiliary material DR is attached to the entire portion of the front surface 1002 so as to draw dotted shapes. In this example, the dotted-shaped liquid auxiliary materials DR3 are homogeneously distributed on the front surface 1002.

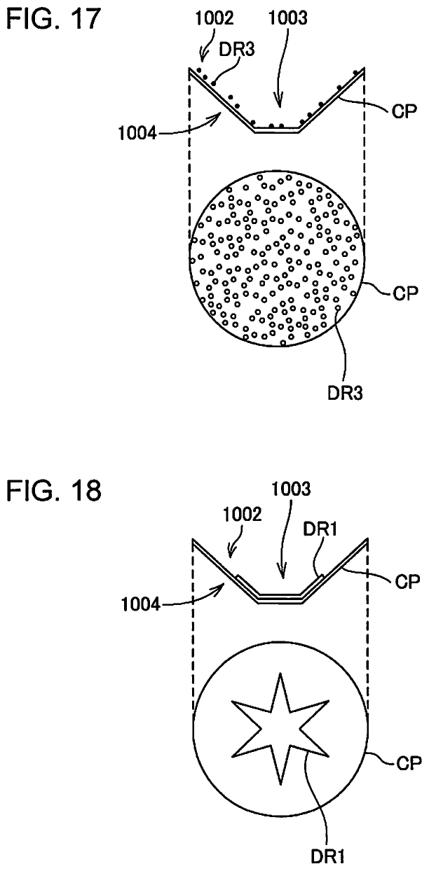

An example shown in FIG. 17 is an example in which the liquid auxiliary material DR is attached to the entire portion of the front surface 1002 so as to draw dotted shapes. In this example, the dotted-shaped liquid auxiliary materials DR3 are heterogeneously disposed on the front surface 1002.

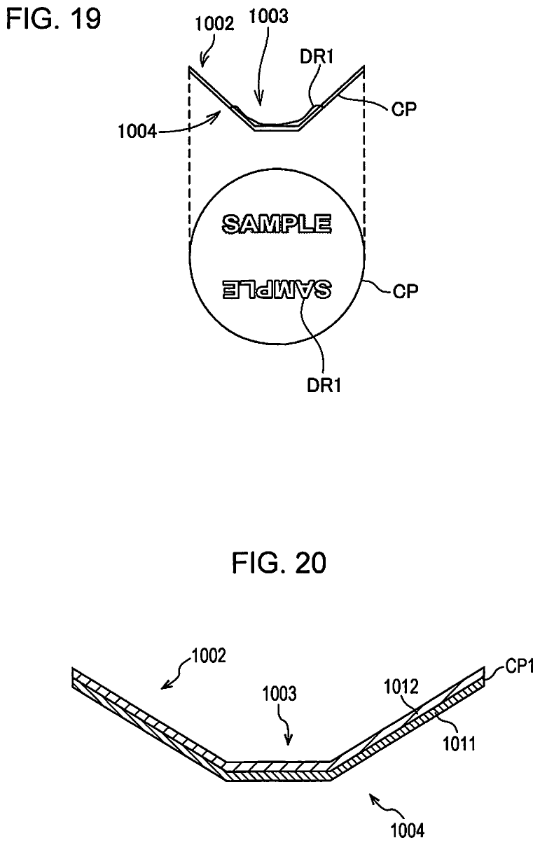

An example shown in FIG. 18 is an example in which the liquid auxiliary material DR is attached to the vibration plate CP so as to draw a star. The stellate auxiliary material layer DR1 is disposed on the front surface 1002 in a region including the bottom portion 1003. The shape of the auxiliary material layer DR1 is not limited to the star, and can be other figures. For example, by controlling the movement of the ejecting head 301 of the material ejection unit 300A or the movement of the molding die 202 by the control device 110 based on image data, the liquid auxiliary material DR can be attached in a shape shown in the image data. As shown in FIG. 19, characters can also be formed by the liquid auxiliary material DR. An example shown in FIG. 19 is an example in which the liquid auxiliary material DR is attached to the vibration plate CP so as to draw characters, and the auxiliary material layer DR1 in a shape representing the characters is disposed on the vibration plate CP. As described above, it is possible to the auxiliary material layer DR1 having various patterns on the vibration plate CP by the ejecting head 301.

As described above, in the vibration plate CP, the auxiliary material is attached to at least one surface of the front surface 1002 which is the vibration surface. The vibration plate manufacturing device 100C includes the material ejection unit 300A which attaches the liquid auxiliary material DR to the surface of the vibration plate CP formed by the molding unit 200.

By attaching the liquid auxiliary material DR to the front surface 1002 and/or the rear surface 1004 of the vibration plate CP, an effect of increasing the rigidity of the vibration plate CP can be expected. In addition, it is possible to apply or improve waterproof properties, moist, antibacterial properties, antifungal properties, flame resistance, or sustained release of the vibration plate CP. Further, it is also possible to apply new properties such as elasticity to the vibration plate CP.

### 5. Other Embodiments

Each embodiment described above is merely a specific aspect of the present disclosure in the aspects, and the present disclosure is not limited thereto and can be performed in various aspects, as shown below, for example, within a range not departing from a gist thereof.

For example, in each embodiment, the example of manufacturing the vibration plate CP having a conical shape by using the molding unit 200 including the molding die 202 having a truncated cone shape has been shown, but the vibration plate CP may include ribs or may have other three-dimensional shapes.

In the embodiments, the vibration plate manufacturing devices 100, 100A, 100B, and 100C have been described as devices which defibrates the raw material MA by the defibration unit 20 and manufactures the vibration plate CP, but the defibration processing unit 101 may not be included. For example, the additive material AD may be added and mixed with the material MC including the fibers defibrated in advance, and the vibration plate CP may be manufactured.

A color or properties of the vibration plate CP is random, and for example, by causing the additive material AD to include a colorant together with the resin, the material MC may be colored, and the vibration plate CP may be manufactured by using the mixture MX in any color.

Regarding other detailed configurations, modifications can be randomly performed.

Hereinafter, the preferred embodiment of the present disclosure will be described in detail with reference to the drawings. The embodiment described below does not limit the content of the present disclosure described in the aspects. In addition, all of the configurations described below is not limited to compulsory constituent elements of the present disclosure.

### 6. Fifth Embodiment

### 6-1. Configuration of Speaker Vibration Plate

A perspective view of a vibration plate CP1 of a fifth embodiment is the same as FIG. 1, the description regarding the same structure is the same, and therefore, the description is omitted.

FIG. 20 is a cross sectional view of the vibration plate CP1.

The vibration plate CP1 is configured of two layers, as shown in FIG. 20. Specifically, the vibration plate is configured of a first layer 1011 which is a layer on the side of the rear surface 1004 and a second layer 1012 which is a layer on the side of the front surface 1002.

The first layer 1011 and the second layer 1012 include a fiber material which will be described later, and the additive material AD for binding the fibers. The fiber material and the additive material AD included in the first layer 1011 and the second layer 1012 may be the same or different from each other.

The fibers included in the first layer 1011 and the second layer 1012 are fibers derived from the raw material MA used in a manufacturing method of the vibration plate CP1.

The raw material MA may be any material, as long as it includes fibers. For example, a wood-based pulp material, Kraft pulp, waste paper, or synthetic pulp can be used. Examples of the wood-based pulp include mechanical pulp manufactured by a machine process such as ground pulp, chemical pulp manufactured by a chemical process, and semi-chemical pulp or chemiground pulp manufactured by using both of these processes in combination. In addition, any of bleached pulp or unbleached pulp may be used. For example, virgin pulp such as softwood bleached kraft pulp (N-BKP) or broad-leaved tree bleached kraft pulp (L-BKP), or Bleached ChemiThermoMechanical Pulp (BCTMP) is used. Nano-cellulose fibers (NCF) may be used. The waste paper is used paper such as plain paper copy (PPC) after the printing, magazines or newspaper. As the synthesis pulp, SWP manufactured by Mitsui Chemicals, Inc. is used, for example. SWP is a registered trademark.

The raw material MA, and a defibrated material MB and a material MC which will be described later can be referred to as the material including fibers.

The raw material MA may include carbon fibers, metal fibers, and thixotropic fibers, in addition to or instead of the wood-based pulp material, the waste paper, or the synthesis pulp. Accordingly, the raw material MA may be a mixture obtained by mixing a plurality of materials from the wood-based pulp material, the waste paper, the synthesis pulp, the carbon fibers, the metal fibers, and the thixotropic fibers.

In the manufacturing method of the vibration plate CP1 which will be described later, the additive material AD is added to the fibers derived from the raw material MA. The additive material AD crosslinks a plurality of fibers and binds the fibers with each other, to configure the first layer 1011 and the second layer 1012.

The additive material AD includes resins functioning as a binding material for binding the fibers to each other, and specifically, includes a thermoplastic resin and/or a thermosetting resin.

As the thermoplastic resin, for example, a resin having a melting temperature of 60° C. to 200° C. and a deformation temperature of 50° C. to 180° C. can be used, for example. Here, the deformation temperature can also be referred to as a glass transition temperature. As the thermoplastic resin, a petroleum-derived resin, a biomass plastic, or a biodegradable plastic can be used. Here, examples of the petroleum-derived resin include a polyolefin resin, a polyester resin, a polyamide resin, polyacetal, polycarbonate, modified polyphenylene ether, cyclic polyolefin, an ABS resin, polystyrene, polyvinyl chloride, polyvinyl acetate, polyurethane, a Teflon resin, an acrylic resin, polyphenylene sulfide, polytetrafluoroethylene, polysulfone, polyether sulfone, amorphous polyaryate, liquid crystal polymer, polyetheretherketone, thermoplastic polyimide, and polyamideimide. Examples of the biomass plastic or the biodegradable plastic include polylactic acid, polycaprolactone, modified starch, polyhydroxybutyrate, polybutylene succinate, polybutylene succinate, and polybutylene succinate adipate. Teflon is a registered trademark. Examples of the thermosetting resin include a phenolic resin, an epoxy resin, a vinyl ester resin, and unsaturated polyester. The additive material AD includes one or a plurality of resins among the resins described above. The additive material AD is preferably particles, more preferably particles having a weight average particle diameter of 0.1 μm to 120 μm, and even more preferably particles having 1 μm to 50 μm.

The additive material AD may include a thermally expandable material which expands by heating, in addition to the resin described above. As the thermally expandable material, a so-called foaming material can be used. The thermally expandable material is preferably particles, and a thermally expandable material molded in a particulate state can be referred to as a foaming particles. A particle diameter of the foaming particles included in the additive material AD is preferably 0.5 μm to 1,000 μm and more preferably 1 μm to 300 μm, in terms of an average particle diameter before foaming. The average particle diameter after foaming is even more preferably 5 μm to 1,000 μm and most preferably 5 μm to 800 μm.

As the foaming particles, a capsule type thermally expandable capsule which expands by heating, or foaming material mixed particles mixed with the thermally expandable material can be used. Examples of the thermally expandable capsule include ADVANCELL manufactured by Sekisui Chemical Co., Ltd., KUREHA Microsphere manufactured by Kureha Corporation, Expancel manufactured by Akzo Nobel, and Matsumoto Microsphere manufactured by Matsumoto Yushi-Seiyaku Co., Ltd. ADVANCELL, KUREHA, Expancel, and Matsumoto Microsphere are respectively registered trademarks. The foaming material mixed particles are a particulate preparation prepared by mixing the thermally expandable material with the thermoplastic resin. Here, as the foaming material, azodicarbonamide, N,N′-dinitrosopentamethyl enetetramine, 4,4′-oxybis (benzenesulfonyl hydrazide), N,N′-Dinitrosopentamethyl enetetramine, azodicarbonamide, and sodium hydrogen carbonate can be used.

When surfaces of the foaming particles are coated with the resin, a coverage of the foaming particles with the resin is preferably 10% to 100%.

The additive material AD may include an inorganic filler, hard fibers, and thixotropic fibers, as an reinforcing material for rigidifying of a crosslinked structure in which the fibers are bound, in addition to the resins described above. As the inorganic filler, calcium carbonate, mica, or the like can be used, for example. As the hard fibers, carbon fibers, metal fibers, or the like can be used, for example. As the thixotropic fibers, cellulose nano-fibers are used.

In addition, the additive material AD may be formed as a composite resin material powder, by kneading and pulverizing the components such as the resins, the foaming particles, or the reinforcing materials.

The second layer 1012 has a higher density than that of the first layer 1011. For example, when the density of the first layer 1011 is smaller than 0.7 g/cm³, the density of the second layer 1012 is 0.7 g/cm³ to 1.2 g/cm³.

In addition, the second layer 1012 may have a higher density of the binding material and/or a higher density of the fibers, than those of the first layer 1011.

Further, the second layer 1012 may be a layer having a higher rigidity than that of the first layer 1011.

An adhesive material may be disposed between the first layer 1011 and the second layer 1012. The adhesive material may be selected, for example, from the thermoplastic resins, and a polyester resin or a styrene acryl resin is use, for example. By using the adhesive material, it is possible to more reliably bond the first layer 1011 and the second layer 1012 in the manufacturing step of the vibration plate CP1.

### 6-2. Manufacturing Step of Speaker Vibration Plate

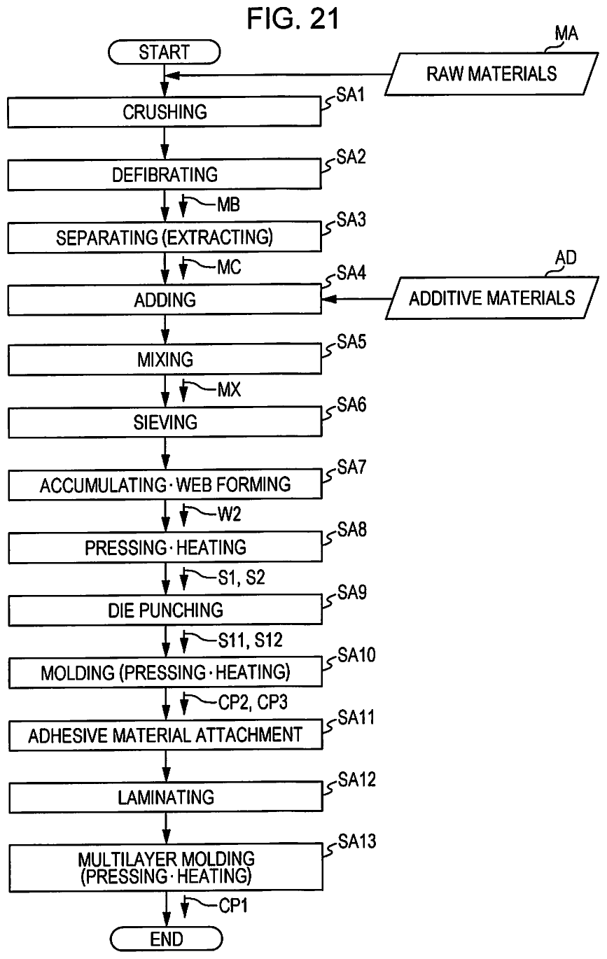

FIG. 21 is a flowchart showing the manufacturing method of the vibration plate CP1 of the fifth embodiment, and shows a step of manufacturing the speaker vibration plate CP by using the raw material including fivers. The vibration plate CP is known as so-called cone paper or speaker cone.

Step SA1 is a crushing process of crushing the raw material MA. The crushing process is a step of cutting the raw material MA to have a size equal to or smaller than a predetermined size. The predetermined size is, for example, 1 cm to 5 cm square. The cut raw material MA is a crushed piece. When the raw material MA is configured of fibers or a fiber piece having a size equal to or smaller than the predetermined size, the crushing step in Step SA1 may be omitted.

Step SA2 is a defibration step. The defibration step is a step of defibrating the raw material MA or the crushed piece crushed in Step SA1 in an atmosphere, to disentangle the fibers included in the raw material MA to one or a several number of fibers. The raw material MA and the crushed piece can also be referred to as a material to be defibrated. In addition, a material defibrated in the defibration step is a defibrated material MB. By defibrating the raw material MA in the defibration step, an effect of separating a substance such as resin particles, an ink, a toner, or a bleeding inhibitor attached to the raw material MA from the fibers can be expected. The defibrated material MB may include resin particles, a colorant such as an ink or a toner, or an additive such as a bleeding inhibitor or a paper strengthening agent, which is separated from the fibers, when disentangling the fibers, in addition to the disentangled defibrated material fibers.

In the defibration step, the defibration is performed by a dry method. The dry method indicates a process of defibrating or the like performed in the atmosphere or the controlled gas, not in a liquid.

In addition, in the process described below, the process performed in the atmosphere is not limited to a process performed in the air. For example, the process can also be performed in gas other than the air. That is, the expression “in the atmosphere” described below can be replaced with “in the air”.

The defibrated material MB may include fibers having different lengths. A length of the fiber included in the defibrated material MB, that is, a fiber length is preferably 1 μm to 500 mm and more preferably 5 μm to 200 mm. A thickness of the fiber, that is, a fiber diameter is preferably 0.1 μm to 1,000 μm and more preferably 1 μm to 500 μm.

Step SA3 is a step of extracting a material mainly including the fibers from the defibrated material MB, and is referred to as a separation step. The separation step is a step of separating particles such as a resin or an additive from the defibrated material MB including fibers or a resin, and extracting the material mainly including the fibers. Accordingly, particles of a resin or an additive affecting the manufacturing of the vibration plate CP can be removed from the components included in the raw material MA. The material separated in the separation step is set as a material MC.

When the raw material MA supplied in Step SA1 does not include the particles or the like affecting the manufacturing of the vibration plate CP, or when it is not necessary to remove the particles or the like from the component included in the raw material MA, the separation step in Step SA3 can be omitted. In this case, the defibrated material MB is used as the material MC as it is.

Step SA4 is an addition step. The addition step is a step of adding an additive material AD to the material MC separated in Step SA3.

Step SA5 is a mixing step. In the mixing step, the material MC and the additive material AD are mixed with each other to prepare a mixture MX.

Step SA6 is a sieving step. In the sieving step, the mixture MX is sieved, dispersed in the atmosphere, and is dropped.

Step SA7 is an accumulation step. In the accumulation step, the mixture MX dropping in the sieving step in Step SA6 is accumulated and a web is formed. The web formed in Step SA7 is referred to as a second web W2. The second web W2 is a state where the fibers and the additive material AD included in the mixture MX are accumulated, has a predetermined thickness, and has a low rigidity. The second web W2 corresponds to the web.

Step SA8 is a pressing and heating step of pressing and heating the second web W2. In the pressing and heating step, the second web W2 is pressed and heated, and sheets S1 and S2 are formed thereon. The order of the pressing and heating in the pressing and heating step is not limited, and the pressing is preferably performed first. The sheet S1 configures the first layer 1011 of the vibration plate CP1 by the processing. The sheet S2 configures the second layer 1012 by the processing. As described above, since the density and/or rigidity of the first layer 1011 and the second layer 1012 are different from each other, the sheet S1 and the sheet S2 are respectively independently manufactured.

Step SA9 is a step of cutting the sheets S1 and S2 formed in Step SA8 to have a shape and a size of the vibration plate CP1. In the embodiment, the punching of the sheets S1 and S2 is performed by using a punching die, and accordingly, Step SA9 is set as a die punching step.

Step SA10 is a molding step of pressing and heating the sheets S1 and S2 cut in Step SA9 by the molding die, respectively, to form a vibration plate CP2 configuring the first layer 1011 and a vibration plate CP3 configuring the second layer 1012.

Step SA11 is an adhesive material attachment step. In the adhesive material attachment step, an adhesive material BO is coated or ejected on at least one of the vibration plate CP2 and the vibration plate CP3 formed in Step SA10. The adhesive material BO has an operation of bonding the vibration plate CP2 and the vibration plate CP3 as described above.

Step SA12 is a lamination step. In the lamination step, the vibration plate CP2 and the vibration plate CP3 are overlapped on each other. In Step SA12, the operation of overlapping the vibration plate CP2 and the vibration plate CP3 on each other and the operation of disposing the vibration plate CP2 and the vibration plate CP3 on molding dies 201 and 202 which will be described later, may be performed in parallel.

Step SA13 is a multilayer molding step. In the multilayer molding step, the vibration plate CP2 and the vibration plate CP3 laminated in Step SA12 are pressed and heated to become one plate, and the vibration plate CP1 is formed.

### 6-3. Configuration of Vibration Plate Manufacturing Device

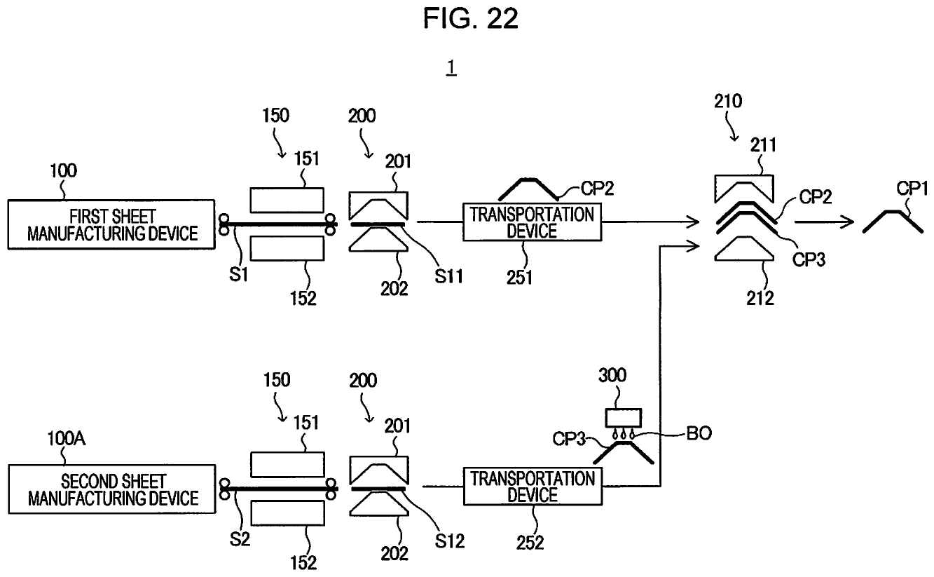

FIG. 22 is a configuration view of a vibration plate manufacturing device 1.

The vibration plate manufacturing device 1 includes a first sheet manufacturing device 100 which manufactures the sheet S1 by performing Steps SA1 to SA8 shown in FIG. 21 and a second sheet manufacturing device 100A which manufactures the sheet S2 by performing Steps SA1 to SA8.

The vibration plate manufacturing device 1 includes a die punching device 150. The die punching device 150 is a device which includes a punching die 151 and a receiving die 152, and pinches the sheet S1 between the punching die 151 and the receiving die 152, to punch the sheet S1 in a shape of the vibration plate CP1. The vibration plate manufacturing device 1 includes two die punching devices 150 for performing the die punching of the sheets S1 and S2. One die punching device 150 is linked to the first sheet manufacturing device 100, and performs the die punching of the sheet S1 discharged from the first sheet manufacturing device 100. In addition, the other die punching device 150 is linked to the second sheet manufacturing device 100A, and performs the die punching of the sheet S2 discharged from the second sheet manufacturing device 100A. The operation of the die punching device 150 corresponds to the die punching step of Step SA9. A punched piece obtained by the punching from the sheet S1 by the die punching device 150 is set as a sheet S11. In addition, a punched piece obtained by the punching from the sheet S2 by the die punching device 150 is set as a sheet S12. The sheets S11 and S12 are respectively punched from the planar sheets S1 and S2 to have a shape of the vibration plate CP1 and has a disk shape.

The molding unit 200 is disposed downstream of the die punching device 150. The molding unit 200 is a press device including the molding die 201 and the molding die 202 pinching the sheet S11 punched by the die punching device 150. The molding unit 200 is configured with a combination of the molding die 202 having a truncated cone shape protruded upwards, and the molding die 201 which is positioned on an upper side of the molding die 202. In the molding unit 200, the molding die 201 and the molding die 202 have a shape fit to each other as a male die and a female die, and is a press type of pinching the sheet S11 between the molding die 201 and the molding die 202. The molding unit 200 press and heats the sheet S11 to form the vibration plate CP2. The vibration plate CP2 formed by the molding unit 200 is transported to a multilayer molding unit 210 by a transportation device 251. The transportation device 251 is, for example, a conveyer which transports the vibration plate CP2 by a belt.

As a configuration of the molding unit 200 for heating the sheet S11, a configuration of embedding a heater in at least one of the molding die 201 and the molding die 202 and heating the sheet S11 by each or at least one of the molding die 201 and the molding die 202 is used. In this case, the molding unit 200 may perform the heating and pressing of the sheet S11 at the same time or at different timings.

In addition, after pressing or during pressing the sheet Sl1 pinched between the molding die 201 and the molding die 202, the molding unit 200 may heat the molding die 201 and the molding die 202 from outside. Specifically, the molding dies 201 and 202 may be accommodated in a housing including a heater and the sheet S11 may be heated together with the molding dies 201 and 202. The heater may be an electric heater or a microwave heating device. In addition, superheated steam may be supplied between the molding dies 201 and 202 to heat the sheet S11.

A temperature of the molding unit 200 for heating the sheet S11 is desirably a temperature for changing properties of the resin included in the additive material AD. When the additive material AD includes a thermoplastic resin, the molding unit 200 performs the heating, for example, at 170° C. for 10 minutes. Specifically, the temperature of the molding unit 200 for heating the sheet S is preferably a temperature equal to or higher than a glass transition temperature, a melting point, or a softening point of the thermoplastic resin included in the additive material AD. For example, the heating temperature of the molding unit 200 can be set as a temperature equal to or higher than the glass transition temperature of the additive material AD and equal to or lower than the melting point thereof. In addition, the heating temperature may be a temperature higher than the melting point. A period of time of the heating by the molding unit 200 is set as a period of time in which the thermoplastic resin pinched between the molding die 201 and the molding die 202 is sufficiently dissolved or softened, and is, for example, 10 minutes or longer.

When the additive material AD includes a thermally expandable material, a temperature of the molding unit 200 for performing the heating is preferably a temperature equal to or higher than the temperature at which expansion or foaming of the thermally expandable material occurs. In this case, a period of time of the heating by the molding unit 200 is set as a period of time in which the thermally expandable material pinched between the molding die 201 and the molding die 202 can be sufficiently expanded, and is, for example, 10 minutes or longer.

In addition, when the additive material AD includes a thermosetting resin, a temperature of the molding unit 200 for performing the heating is preferably a temperature equal to or higher than the temperature at which phase transition or curing of the thermosetting resin occurs. A period of time of the heating by the molding unit 200 is set as a period of time in which the thermosetting resin pinched between the molding die 201 and the molding die 202 can be sufficiently cured, and is, for example, 10 minutes or longer.

The molding unit 200 is disposed downstream of the die punching device 150. The molding unit 200 includes the molding die 201 and the molding die 202 pinching the sheet S12 punched by the die punching device 150. The molding unit 200 pinches the sheet S12 between the molding die 201 and the molding die 202, presses and heats the sheet S12, and forms the vibration plate CP3.

The configuration of the molding unit 200 which presses and heats the sheet S12 is as described above.

The condition of the pressing and heating of the molding unit 200, that is, the processing condition can be different conditions between the sheet S11 and the sheet S12.

The second layer 1012 positioned on the side of the front surface 1002 in the vibration plate CP1 has a higher rigidity and a higher density than those of the first layer 1011. The molding unit 200 which forms the vibration plate CP3 form the sheet S12 forms the vibration plate CP3 having a density of 0.7 g/cm³ to 1.2 g/cm³, under the conditions of a press surface pressure applied between the molding die 201 and the molding die 202 of 10 to 35 MPa, and a heating temperature equal to or lower than 200° C. Meanwhile, the molding unit 200 which forms the vibration plate CP2 form the sheet S11 forms the vibration plate CP2 having a density smaller than 0.7 g/cm³, under the conditions of a press surface pressure smaller than 10 MPa and a heating temperature equal to or lower than 180° C.

The molding unit 200 performs the molding step (step SA10). The molding unit 200 which forms the vibration plate CP2 from the sheet S11 corresponds to the first layer molding unit, and the molding unit 200 which forms the vibration plate CP3 from the sheet S12 corresponds to the second layer molding unit. In the molding unit 200, by heating the sheet S11, the binding material included in the sheet S11 is dissolved to bind the fibers of the sheet S11.

The vibration plate CP3 formed by the molding unit 200 is transported to an adhesive material attachment unit 300 by a transportation device 252. The transportation device 252 is, for example, a conveyer which transports the vibration plate CP3 by a belt.

The adhesive material attachment unit 300 performs the adhesive material attachment step (Step SA11). The adhesive material attachment unit 300 attaches the adhesive material BO to the vibration plate CP3. As the adhesive material attachment unit 300, for example, an ejecting head which ejects a liquid adhesive material from nozzles can be used. The ejecting head has a configuration of ejecting the adhesive material by heating or by using a piezoelectric element, and can have the same configuration as that of a printing head of an ink jet printer, for example. The adhesive material attachment unit 300 may be a coating device which applies the adhesive material BO to the vibration plate CP3 with a brush.

The adhesive material attachment unit 300 attaches the adhesive material BO to the entire surface or a part of the vibration plate CP3. The vibration plate CP3, to which the adhesive material BO is attached, is transported to the multilayer molding unit 210 and overlapped on the vibration plate CP2. Here, a process of overlapping and disposing the vibration plate CP2 and the vibration plate CP3 by the multilayer molding unit 210 corresponds to the lamination step (Step SA12).

The multilayer molding unit 210 is a press device including a molding die 211 and a molding die 212 pinching the laminated vibration plates CP2 and CP3. The molding die 211 and the molding die 212 is a press type having a shape fit to each other as a male die and a female die.

The multilayer molding unit 210 performs the multilayer molding step (Step SA13). The multilayer molding unit 210 pinches, presses, and heats the laminated vibration plate CP2 and the vibration plate CP3 between the molding die 211 and the molding die 212, to form the vibration plate CP1. In the multilayer molding unit 210, by heating the vibration plate CP2 and the vibration plate CP3, the binding materials included in the vibration plate CP2 and the vibration plate CP3 are dissolved to bond the vibration plate CP2 and the vibration plate CP3 to each other. The multilayer molding unit 210 corresponds to the molding unit.

As a configuration of the multilayer molding unit 210 for heating the vibration plates CP2 and CP3, a configuration of embedding a heater in at least one of the molding die 211 and the molding die 212 and heating the vibration plate CP2 by each or at least one of the molding die 211 and the molding die 212 is used. In this case, the multilayer molding unit 210 may perform the heating and pressing of the vibration plate CP2 at the same time or at different timings. In addition, after pressing or during pressing the vibration plate CP2 pinched between the molding die 211 and the molding die 212, the multilayer molding unit 210 may heat the molding die 211 and the molding die 212 from outside. Specifically, the molding dies 211 and 212 may be accommodated in a housing including a heater and the vibration plates CP2 and CP3 may be heated together with the molding dies 211 and 212. The heater may be an electric heater or a microwave heating device. In addition, superheated steam may be supplied between the molding dies 211 and 212 to heat the vibration plates CP2 and CP3.

The pressing and heating conditions of the multilayer molding unit 210 are more alleviated conditions than the conditions of the molding unit 200. That is, a heating temperature of the multilayer molding unit 210 is the same or equal to or lower than the lower heating temperature from the heating temperatures of the molding unit 200 for processing the sheet S11 and the molding unit 200 for processing the sheet S12. In addition, a pressure of the multilayer molding unit 210 is the same or equal to or lower than the lower pressure from the pressures of the molding unit 200 for processing the sheet S11 and the molding unit 200 for processing the sheet S12. Therefore, the density of the vibration plate CP2 is expected to be a low density which is the same as in the processing performed by the molding unit 200.

### 6-4. Configuration of Sheet Manufacturing Device

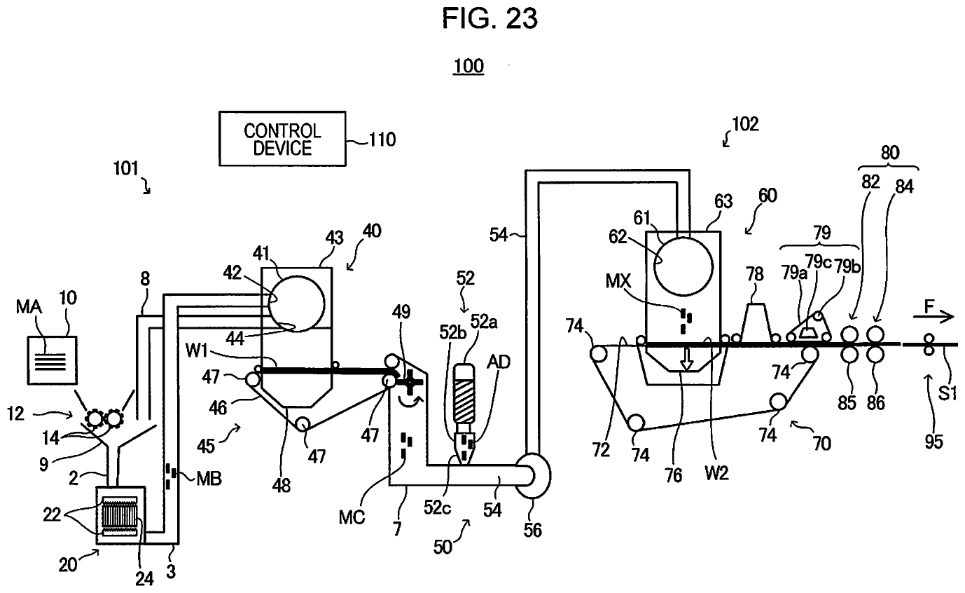

FIG. 23 is a configuration view of a first sheet manufacturing device 100.

The first sheet manufacturing device 100 includes a defibration unit 20, an additive material supply unit 52, a mixing unit 50, a second web formation unit 70, and a molding unit 200, as a compulsory configuration. The second web formation unit 70 corresponds to the accumulation unit. In addition, the first sheet manufacturing device 100 includes a supply unit 10, a crushing unit 12, a selection unit 40, a first web formation unit 45, a rotator 49, the mixing unit 50, a dispersion unit 60, a web transportation unit 79, a pressing and heating unit 80, and a transportation unit 95.

The crushing unit 12, the defibration unit 20, the selection unit 40, and the first web formation unit 45 configure a defibration processing unit 101 which manufactures the material MC by processing the raw material MA. The rotator 49, the mixing unit 50, the dispersion unit 60, the second web formation unit 70, the pressing and heating unit 80, and the transportation unit 95 configure a manufacturing unit 102 which manufactures the sheet S1 from the material MC.

The supply unit 10 is an automatic insertion device which accommodates the raw material MA and continuously inserts the raw material MA to the crushing unit 12.

The crushing unit 12 performs the crushing step (Step SA1). The crushing unit 12 includes a crushing blade 14 and cuts the raw material MA by the crushing blade 14 in the atmosphere to obtain a crushed piece having a size of several cm square. A shape or a size of the strip is random. As the crushing unit 12, a shredder can be used, for example. The raw material MA cut by the crushing unit 12 is collected by a hopper 9 and transported to the defibration unit 20 through a tube 2.

The defibration unit 20 performs the defibration step (Step SA2), and defibrates the crushed piece cut by the crushing unit 12 by a dry method. The defibration unit 20 can configure a defibration machine such as an impeller mill, for example. The defibration unit 20 of the embodiment is a mill which includes a cylindrical stator 22 and a rotor 24 rotating in the stator 22, and in which a defibration blade is formed on an inner peripheral surface of the stator 22 and an outer peripheral surface of the rotor 24. By the rotation of the rotor 24, the crushed piece is pinched between the stator 22 and the rotor 24 and defibrated. The defibrated material MB obtained by the defibration by the defibration unit 20 is sent to a tube 3 from an outlet of the defibration unit 20.

The crushed piece is transported from the crushing unit 12 to the defibration unit 20 by air flow. In addition, the defibrated material MB is transferred from the defibration unit 20 to the selection unit 40 through the tube 3 by air flow. These air flows may be generated by the defibration unit 20 or may be generated by providing a blower (not shown).

The selection unit 40 selects a component included in the defibrated material MB in accordance with sizes of the fibers. The size of the fiber indicates mainly a length of the fiber.

The selection unit 40 of the embodiment includes a drum unit 41, and a housing unit 43 accommodating the drum unit 41. The drum unit 41 is, for example, a so-called sieve such as a net including an opening, a filler, or a screen. Specifically, the drum unit 41 has a cylindrical shape rotatably driven by a motor and at least a part of a peripheral surface is formed of a net. The drum unit 41 may be configured of wire netting, expanded metal or punching metal obtained by extending a metal plate having a gap. The defibrated material MB introduced from an introduction port 42 into the drum unit 41 is divided into a passed material which passes the opening of the drum unit 41 and a residue which does not pass the opening, by the rotation of the drum unit 41. The passed material which passed the opening includes fibers or particles having a size smaller than the opening and this is referred to as a first selected material. The residue includes fibers, a non-defibrated piece, or a lump having a size greater than the opening, and this is referred to as a second selected material. The first selected material is dropped into the housing unit 43 towards the first web formation unit 45. The second selected material is transported from an outlet 44 connecting to the inner portion of the drum unit 41 to the defibration unit 20 through a tube 8.

The first sheet manufacturing device 100 may include a classifier which separates the first selected material and the second selected material from each other, instead of the selection unit 40. The classifier is, for example, a cyclone classifier, Elbow-Jet classifier, or Eddy classifier.

The first web formation unit 45 includes a mesh belt 46, stretching rollers 47, and an suction unit 48. The mesh belt 46 is an endless metal belt and is suspended over a plurality of stretching rollers 47. The mesh belt 46 goes around an orbit made by the stretching rollers 47. A part of the orbit of the mesh belt 46 is planar on a lower side of the drum unit 41 and the mesh belt 46 configures a planar surface.

A plurality of openings are formed on the mesh belt 46, and components having a larger size than the opening of the mesh belt 46 among the first selected material dropped from the drum unit 41 are accumulated on the mesh belt 46. The components having a smaller size than the opening of the mesh belt 46 among the first selected material pass through the opening. The component passing through the opening of the mesh belt 46 are referred to as a third selected material, and includes, for example, fibers having a size shorter than the opening of the mesh belt 46, resin particles separated from the fibers by the defibration unit 20, and particles including an ink, a toner, or a bleeding inhibitor.

The suction unit 48 is coupled to a blower (not shown) and the air is sucked by the suction power of the blower from the lower side of the mesh belt 46. The air sucked from the suction unit 48 is discharged with the third selected material passed through the opening of the mesh belt 46.

The air flow made by the suction of the suction unit 48 draws the first selected material dropped from the drum unit 41 to the mesh belt 46, and accordingly, an effect of promoting the accumulation is exhibited.

The component accumulated on the mesh belt 46 has a web shape and configures a first web W1. That is, the first web formation unit 45 forms the first web W1 from the first selected material selected by the selection unit 40.

The first web W1 is a component mainly including fibers having a larger size than the opening of the mesh belt 46 among the components included in the first selected materials, and is formed in a state of being softly swollen with a large amount of the air. The first web W1 is transported to the rotator 49 along the movement of the mesh belt 46.

The rotator 49 includes a plurality of plate-shaped blades, and is driven and rotates by a driving unit (not shown) such as a motor or the like. The rotator 49 is disposed on an end portion of the orbit of the mesh belt 46 and contacts with a portion where the first web W1 transported by the mesh belt 46 is protruded from the mesh belt 46. The first web W1 is disentangled by the rotator 49 which collides with the first web W1, becomes a lump of small fibers, and is transported to the mixing unit 50 through a tube 7. A material obtained by dividing of the first web W1 by the rotator 49 is set as the material MC. The material MC is obtained by removing the third selected material from the first selected material described above and the main component is the fiber.

As described above, the selection unit 40 and the first web formation unit 45 performs the separation step (Step SA3), and separates the material MC mainly including the fiber from the defibrated material MB.

The additive material supply unit 52 performs the addition step (Step SA4) and adds the additive material AD to a tube 54 which transports the material MC.

In the additive material supply unit 52, an additive material cartridge 52a for accumulating the additive material AD. The additive material cartridge 52a is a tank for accommodating the additive material AD and may be detachable from the additive material supply unit 52. The additive material supply unit 52 includes an additive material extraction unit 52b which extracts the additive material AD from the additive material cartridge 52a, and an additive material insertion unit 52c which discharges the additive material AD extracted by the additive material extraction unit 52b to a tube 54. The additive material extraction unit 52b includes a feeder which sends the additive material AD to the additive material insertion unit 52c. The additive material insertion unit 52c includes an openable shutter and sends the additive material AD to the tube 54 by opening the shutter.

The mixing unit 50 mixes the material MC and the additive material AD to each other by a mixing blower 56. The mixing unit 50 may include a tube 54 for transporting the material MC and the additive material AD to the mixing blower 56, in the mixing unit 50. The operation of the mixing unit 50 corresponds to the mixing step (Step SA5).

The mixing blower 56 generates the air flow in the tube 54 linking the tube 7 and the dispersion unit 60, and mixes the material MC and the additive material AD with each other. The mixing blower 56, for example, includes a motor, blades which are driven and rotates by the motor, and a case accommodating the blades. In addition, in addition to the blades generating the air flow, the mixing blower 56 may include a mixer which mixes the material MC and the additive material AD with each other. The mixture mixed by the mixing unit 50 is referred to as a mixture MX, hereinafter. The mixture MX corresponds to the material including fibers. The mixture MX is transported to the dispersion unit 60 and introduced to the dispersion unit 60 by the air flow generated by the mixing blower 56.

The dispersion unit 60 performs the sieving step (Step SA6). The dispersion unit 60 disentangles the fibers of the mixture MX and drops the mixture to the second web formation unit 70, while performing the dispersion in the atmosphere. When the additive material AD has a fibrous shape, these fibers are also disentangled by the dispersion unit 60 and dropped to the second web formation unit 70.

The dispersion unit 60 includes a dispersion drum 61 and a housing 63 accommodating the dispersion drum 61. The dispersion drum 61 is, for example, a cylindrical structure configured in the same manner as the drum unit 41, and rotates by a power of a motor (not shown) and functions as a sieve, in the same manner as the drum unit 41. The dispersion drum 61 includes an opening, and the mixture MX disentangled by the rotation of the dispersion drum 61 is dropped from the opening. Accordingly, in an internal space 62 formed in the housing 63, the mixture MX is dropped from the dispersion drum 61. The housing 63 corresponds to a case.

The second web formation unit 70 is disposed on a lower side of the dispersion drum 61. The second web formation unit 70 includes a mesh belt 72, stretching rollers 74, and a suction mechanism 76.

The mesh belt 72 is configured with an endless metal belt which is the same as the mesh belt 46 and is suspended over the plurality of stretching rollers 74. The mesh belt 72 moves in a transportation direction shown with a reference numeral F1, while going around an orbit configured by the stretching rollers 74. A part of the orbit of the mesh belt 72 is planar on a lower side of the dispersion drum 61 and the mesh belt 72 configures a planar surface.

The second web formation unit 70 performs the accumulation step (Step SA7). A plurality of openings are formed on the mesh belt 72, and components having a larger size than the opening of the mesh belt 72 among the mixture MX dropped from the dispersion drum 61 are accumulated on the mesh belt 72. In addition, the components having a smaller size than the opening of the mesh belt 72 among the mixture MX pass through the opening.

The second web formation unit 70 corresponds to the accumulation unit.

The suction mechanism 76 sucks the air from a side opposite to the dispersion drum 61 with respect to the mesh belt 72, by a suction power of a blower (not shown). The components passed through the opening of the mesh belt 72 is sucked by the suction mechanism 76. The air flow made by the suction of the suction mechanism 76 draws the mixture MX dropped from the dispersion drum 61 to the mesh belt 72, and accordingly, the accumulation is promoted. The air flow of the suction mechanism 76 forms a down flow in a path where the mixture MX drops from the dispersion drum 61, and an effect of preventing the intertangling of the fibers during the dropping can be expected. The component accumulated on the mesh belt 72 has a web shape and configures the second web W2. The second web W2 corresponds to the web and the accumulated material.

In the transportation path of the mesh belt 72, a humidity controlling unit 78 is provided downstream of the dispersion unit 60. The humidity controlling unit 78 is a mist type humidifier which supplies mist-like water towards the mesh belt 72, and includes, for example, a tank for storing water or an ultrasonic vibrator for generating mist from the water. By the mist applied by the humidity controlling unit 78, the amount of moisture contained in the second web W2 is adjusted and adsorption or the like of the fibers to the mesh belt 72 due to static electricity is prevented.

The second web W2 is peeled off from the mesh belt 72 and transported to the pressing and heating unit 80 by the web transportation unit 79. The web transportation unit 79 includes a mesh belt 79a, rollers 79b, and a suction mechanism 79c. The suction mechanism 79c includes a blower (not shown) and generates upward air flow by a suction power of the blower through the mesh belt 79a. The mesh belt 79a can be configured with an endless metal belt including an opening, in the same manner as the mesh belt 46 and the mesh belt 72. The mesh belt 79a moves by the rotation of the rollers 79b and moves on a revolution orbit. In the web transportation unit 79, the second web W2 is separated from the mesh belt 72 and adsorbed to the mesh belt 79a by the suction power of the suction mechanism 79c. The second web W2 moves together with the mesh belt 79a and is transported to the pressing and heating unit 80.

The pressing and heating unit 80 includes a pressing unit 82 and a heating unit 84. The pressing unit 82 presses the second web W2 at a predetermined nip pressure and adjusts a thickness of the second web W2, to realize a high density of the second web W2. The heating unit 84 applies heat to the second web W2 to bind the material MC-derived fibers included in the second web W2 by the resin included in the additive material AD. The pressing unit 82 is configured with a pair of calender rollers 85 and 85. The pressing unit 82 includes a press mechanism of applying the nip pressure to the calender rollers 85 and 85 by oil pressure, or a motor which rotates the calender rollers 85 and 85. The heating unit 84 includes a pair of heating rollers 86 and 86. The heating unit 84 includes a heater (not shown) which heats peripheral surfaces of the heating rollers 86 to a predetermined temperature, and a motor (not shown) which rotates the heating rollers 86 and 86. The second web W2 is heated to a higher temperature than a glass transition temperature of the resin included in the mixture MX in the heating unit 84 and is set as the sheet S1. The pressing and heating unit 80 corresponds to a sheet forming unit.

The sheet S1 is transported to the die punching device 150 shown in FIG. 22 by the transportation unit 95.

The operation of the first sheet manufacturing device 100 described above is controlled by a control device 110. The control device 110 controls at least the defibration unit 20, the additive material supply unit 52, the mixing blower 56, the dispersion unit 60, the second web formation unit 70, the pressing and heating unit 80, and the transportation unit 95, to perform the manufacturing method of the vibration plate CP1. In addition, the control device 110 may control the operation of the supply unit 10, the selection unit 40, the first web formation unit 45, and the rotator 49.

The second sheet manufacturing device 100A has the common configuration with the first sheet manufacturing device 100 shown in FIG. 23, and accordingly, the drawings and description of the specific configuration of the second sheet manufacturing device 100A are omitted.

The first sheet manufacturing device 100 and the second sheet manufacturing device 100A have the common device configuration, but the sheet S1 manufactured by the first sheet manufacturing device 100 and the sheet S2 manufactured by the second sheet manufacturing device 100A are different from each other, as described above. Accordingly, the raw materials MA, the additive materials AD and/or the processing conditions are different between the first sheet manufacturing device 100 and the second sheet manufacturing device 100A.

For example, the raw material MA and the additive material AD used in the first sheet manufacturing device 100 and the raw material MA and the additive material AD used in the second sheet manufacturing device 100A may be different components.

A fiber length of the defibrated material MB defibrated by the defibration unit 20 of the first sheet manufacturing device 100, and a fiber length of the defibrated material MB defibrated by the defibration unit 20 of the second sheet manufacturing device 100A may be controlled to be different lengths. In addition, the additive amount of the additive material AD added by the additive material supply unit 52 of the first sheet manufacturing device 100, and the additive amount of the additive material AD added by the additive material supply unit 52 of the second sheet manufacturing device 100A may be different amounts. These controls can be performed by the control device 110.

The vibration plate manufacturing device 1 manufactures the vibration plate CP in a so-called dry type process of dispersing the mixture MX in the atmosphere and accumulating. As a method of molding the material including fibers, the papermaking of dispersing the fibers in a liquid, as described above, has been known, as a contrasting method with that of the vibration plate manufacturing device 1. Specifically, this is a so-called wet type papermaking of performing the papermaking and molding by dispersing fibers such as pulp. The wet type papermaking is a molding method using a hydrogen bond between fibers. In this method, the hydrogen bond between fibers strongly works due to the use of water, and it is difficult to ensure a long distance between fibers. Accordingly, a density of the fibers after the molding is high, and it is difficult to manufacture a molded product having a low density. In addition, since the wet papermaking uses a large amount of water, it is necessary to provide equipment for water supply and drainage.

The homogeneity is necessary for a speaker vibration plate, in order to obtain excellent sound quality. When the material other than the fiber, such as the additive material AD is added, it is desirable that the material to be added is evenly present in the plane, without deviation in the structure of the vibration plate. In the wet papermaking, a plurality of materials are dispersed in water. Thus, deviation or aggregation may occur due to a difference in shape, a specific gravity, hydrophilicity and hydrophobicity, solubility, and dispersibility of the materials. Accordingly, unevenness of components or unevenness of a thickness may occur during the wet papermaking.

It is known that it is necessary to realize a low density, a high rigidity, and a high internal loss, as the properties of the speaker vibration plate, in order to obtain excellent sound quality.

In the vibration plate manufacturing device 1 and the manufacturing method of the vibration plate CP performed by the vibration plate manufacturing device 1 of the embodiment, a method of dispersing and accumulating the mixture MX including fibers defibrated by the dry method by the defibration unit 20, in the atmosphere. By this method, it is possible to manufacture the vibration plate CP having a low density, a high rigidity, and a high internal loss.

In addition, the vibration plate manufacturing device 1 can manufacture the vibration plate CP1 on which the first layer 1011 and the second layer 1012 are laminated. By including the first layer 1011 having relatively low density and low rigidity, it is possible to realize the weight reduction and the improvement of the internal loss of the vibration plate CP1 and to increase the rigidity of the vibration plate CP1 by the second layer 1012 having a high density and a high rigidity. Therefore, it is possible to manufacture the vibration plate CP1 having excellent properties for the speaker vibration plate.

The properties of the first layer 1011 and the second layer 1012 can be easily adjusted, by controlling the kind of the raw material MA, the kind of the additive material AD, the pressing and heating conditions of the molding unit 200, and the pressing and heating conditions of the multilayer molding unit 210. Accordingly, the vibration plate manufacturing device 1 has an advantage that the vibration plate CP1 having excellent properties can be easily manufactured.

As described above, the vibration plate CP1 manufactured by the vibration plate manufacturing device 1 of the fifth embodiment has suitable properties for the speaker vibration plate. The vibration plate CP1 includes the first layer 1011 including the defibrated material MB obtained by the defibrating the material including fibers, and the additive material AD as a binding material for binding the fibers of the defibrated material MB. The vibration plate CP1 includes the second layer 1012 having a higher density than that of the first layer 1011 including the defibrated material MB and the additive material AD. The vibration plate CP1 is a vibration plate formed by dissolving the additive material AD.

The vibration plate CP1 is configured of the first layer 1011 and the second layer 1012 in which the additive material AD is added to the defibrated material MB obtained by defibrating the material. In both of the first layer 1011 and the second layer 1012, the resin included in the additive material AD and the fibers of the defibrated material MB are mixed homogeneously by a method capable of controlling deviation or aggregation, and pressing and heating are performed. In addition, the vibration plate CP1 is configured of the first layer 1011 and the second layer 1012 having a higher density than that of the first layer 1011. Accordingly, by including the first layer 1011 having a relatively low density, it is possible to realize the weight reduction and the improvement of the internal loss of the vibration plate CP1 and to increase the strength of the vibration plate CP1 by the second layer 1012 having a high density. As described above, the vibration plate CP1 has excellent properties for the speaker vibration plate.

In the vibration plate CP1, the second layer 1012 is a layer having a higher rigidity than that of the first layer 1011. By including the first layer 1011 having relatively low density and a low rigidity, the vibration plate CP1 have a light weight and a high internal loss. In addition, by including the second layer 1012 having a high density and a high rigidity, the entire part of the vibration plate CP1 have a high rigidity. Therefore, the vibration plate CP1 has more excellent properties for the speaker vibration plate.

In the vibration plate CP1, since the density of at least any of the fibers and the binding material included in the second layer 1012 is higher than the first layer 1011, the rigidity of the second layer 1012 can be higher than that of the first layer 1011. Therefore, the entire parts of the vibration plate CP1 has a high rigidity and has more excellent properties for the speaker vibration plate.

The binding material configuring the first layer 1011 and the second layer 1012 includes at least any of a thermoplastic resin and a thermosetting resin. Accordingly, it is possible to easily realize the configuration in which the fibers of the defibrated material MB are crosslinked by the additive material AD, by the process including the heating. Therefore, it is possible to provide the vibration plate CP1 having preferred properties for the speaker vibration plate.

The vibration plate CP1 includes the adhesive material BO which bonds the first layer 1011 and the second layer 1012 to each other. That is, the vibration plate CP1 has a configuration in which the first layer 1011 and the second layer 1012 are bonded to each other by the adhesive material BO. Since the first layer 1011 and the second layer 1012 are strongly bonded to each other, it is possible to provide the vibration plate CP1 having a low density and a high internal loss which are properties of the first layer 1011 and a high rigidity which is properties of the second layer 1012.

In addition, the vibration plate manufacturing device 1 includes the defibration unit 20 which defibrates the material including the fibers, and the mixing unit 50 which mixes the additive material AD including the binding material for crosslinking the fibers, with the defibrated material MB defibrated by the defibration unit 20. The vibration plate manufacturing device 1 includes the second web formation unit 70 which accumulates the mixture MX mixed by the mixing unit 50 to form the first layer 1011 and the second layer 1012. The vibration plate manufacturing device 1 includes the multilayer molding unit 210 which forms the vibration plate CP1 on which the first layer 1011 and the second layer 1012 are laminated, by dissolving the binding material of the additive material AD. The second layer 1012 has a higher density than that of the first layer 1011.

The vibration plate manufacturing device 1, to which the speaker vibration plate manufacturing device and the manufacturing method of the speaker vibration plate of the present disclosure are applied, manufactures the vibration plate CP1 configured of the first layer 1011 and the second layer 1012 in which the additive material AD is added to the defibrated material MB obtained by defibration of the material. The vibration plate manufacturing device 1 homogeneously mixes the resin as the binding material included in the additive material AD and the fibers of the defibrated material MB by a method capable of preventing the deviation or aggregation, to form the first layer 1011 and the second layer 1012. Since the vibration plate CP1 manufactured by the vibration plate manufacturing device 1 includes the first layer 1011 having a relatively low density, the weight is reduced, the internal loss is increased, and the strength is increased than that of the second layer 1012 having a high density. Therefore, the vibration plate manufacturing device 1 can provide the vibration plate CP1 having excellent properties for the speaker vibration plate, by using the material including fibers.

The vibration plate manufacturing device 1 manufactures the vibration plate CP1 in which the second layer 1012 is a layer having a higher rigidity than that of the first layer 1011. This vibration plate CP1 includes the first layer 1011 having a relatively low density and low rigidity, and accordingly, a light weight and a high internal loss are realized. In addition, by including the second layer 1012 having a high density and a high rigidity, the entire part of the vibration plate CP1 has a high rigidity. Therefore, the vibration plate manufacturing device 1 can provide the vibration plate CP1 having more excellent properties for the speaker vibration plate.

The vibration plate manufacturing device 1 forms the vibration plate CP1 in which the density of at least any of the fiber and the binding material included in the second layer 1012 is higher than that of the first layer 1011. Since the rigidity of the second layer 1012 of the vibration plate CP1 is higher than that of the first layer 1011, the entire part of the vibration plate manufacturing device 1 has a high rigidity, and it is possible to provide the vibration plate CP1 having more excellent properties for the speaker vibration plate.

In the vibration plate manufacturing device 1, the additive material AD including at least any of a thermoplastic resin and a thermosetting resin as the binding material is used. Accordingly, by performing the processing including the heating in the molding process, it is possible to easily realize the configuration in which the fibers of the defibrated material MB are crosslinked by the additive material AD. Therefore, it is possible to provide the vibration plate CP1 having preferred properties for the speaker vibration plate.

The vibration plate manufacturing device 1 includes the adhesive material attachment unit 300 for bonding the adhesive material between a sheet configuring the first layer 1011, and a sheet configuring the second layer 1012. Therefore, it is possible to strongly bond the first layer 1011 and the second layer 1012 to each other, and to provide the vibration plate CP1 having a low density and a high internal loss which are properties of the first layer 1011 and a high rigidity which is properties of the second layer 1012.

The vibration plate manufacturing device 1 includes the pressing and heating unit 80 which forms the second web W2 by accumulating the mixture MX, and presses and heats the second web W2 to form the sheets S1 and S2. The multilayer molding unit 210 forms the vibration plate CP1 including the first layer 1011 formed by the molding unit 200 from the sheet S1 and the second layer 1012 formed by the molding unit 200 from the sheet S2. According to this configuration, since the material of the vibration plate CP1 is sheet-shaped sheets S1 and S2, it is possible to easily perform the step of manufacturing the first layer 1011 and the second layer 1012. The vibration plate CP2 and CP3 configuring the first layer 1011 and the second layer 1012 are formed in advance, and the molding process is also easily performed by the multilayer molding unit 210. Therefore, it is possible to increase the manufacturing efficiency of the vibration plate CP1.

The manufacturing method of the vibration plate CP1 performed by the vibration plate manufacturing device 1 includes a step of mixing fibers the defibrated material MB obtained by defibrating the raw material MA, and the additive material AD including the binding material for binding the fibers, to form the first layer 1011 at a first density. This step is a step of manufacturing the vibration plate CP2 by the first sheet manufacturing device 100. The manufacturing method of the vibration plate CP1 includes a step of mixing the fiber and the binding material to form a second layer at a higher density than that of the first layer. This step is a step of manufacturing the vibration plate CP3 by the second sheet manufacturing device 100A. In addition, the manufacturing method of the vibration plate CP1 includes a step of bonding the vibration plate CP2 which is the first layer and the vibration plate CP3 which is the second layer in a laminated state. This step corresponds to the process of the multilayer molding unit 210. The multilayer molding unit 210 may perform the molding process of dissolving the binding material by the molding process including the heating and pressing.

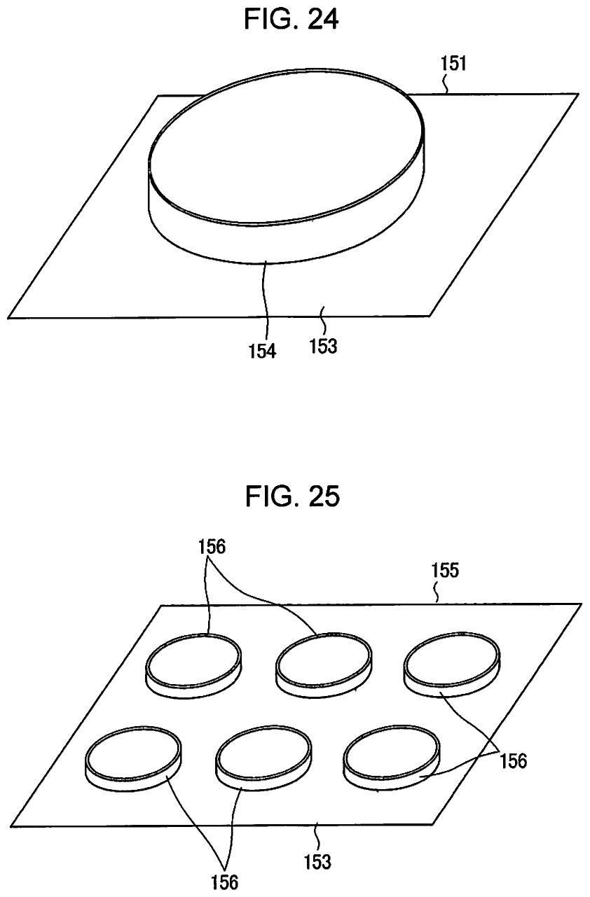

Here, FIG. 24 shows a configuration of the punching die 151 used for the die punching of the sheets S1 and S2 by the die punching device 150. FIG. 24 is a perspective view of the punching die 151.

The punching die 151 of FIG. 24 shows a state which is vertical inversed from the state shown in FIG. 22. The punching die 151 has a configuration in which one cylindrical blade 154 is provided on a planar base 153, and the punching die punches one disk-shaped sheet S11 from one sheet S1 and punches one disk-shaped sheet S12 from one sheet S2. The punching die 151 used in the vibration plate manufacturing device 1 can also be configured to perform the punching of a plurality of circles. This configuration will be described as a sixth embodiment.

### 7. Sixth Embodiment

FIG. 25 is a perspective view of a punching die 155 used in the manufacturing method of the vibration plate CP of a sixth embodiment. In the punching die 155, a plurality of cylindrical blades 156 are disposed on the base 153. When the punching die 155 is set on the die punching device 150 and used with the receiving die 152, the plurality of sheets S11 can be punched from one sheet S1 by one pressing operation of the die punching device 150. In the same manner, the plurality of sheets S12 can be punched by one press operation from one sheet S2. Accordingly, it is possible to realize the improvement of the manufacturing efficiency of the vibration plate CP.

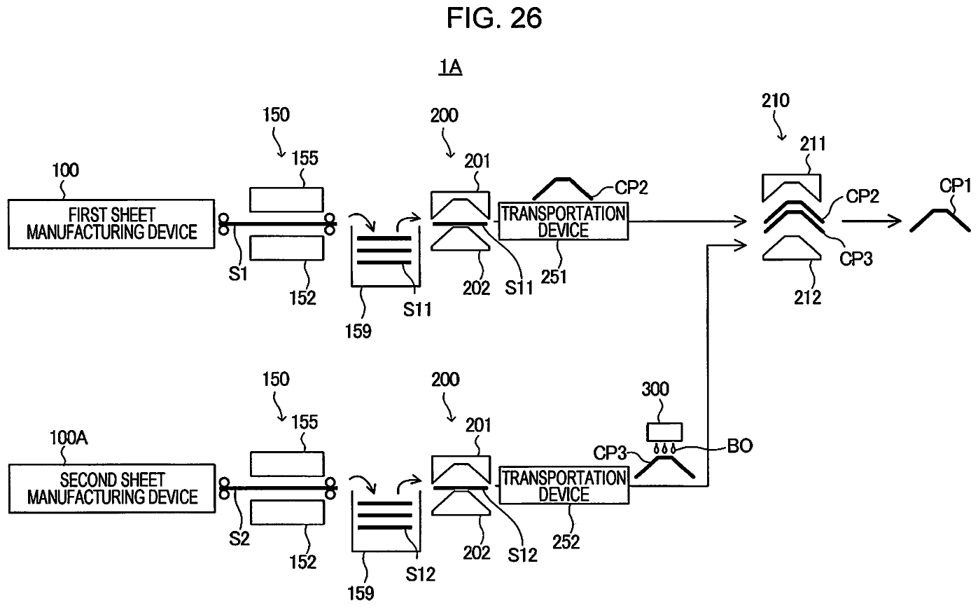

FIG. 26 is a configuration view of a vibration plate manufacturing device 1A.

The vibration plate manufacturing device 1A has a configuration in which a punching die 155 is provided instead of the punching die 151 and a stocker 159 is disposed, in the vibration plate manufacturing device 1 described in the fifth embodiment, and the other units are common with the vibration plate manufacturing device 1. In the vibration plate manufacturing device 1A, the same reference numerals are used for the common configuration units with the vibration plate manufacturing device 1, and therefore, the description thereof is omitted.

The stocker 159 is disposed downstream of the die punching device 150 linked to the first sheet manufacturing device 100. In the stocker 159, the sheet S11 punched by the die punching device 150 is accumulated and accommodated. The stocker 159 can accommodate at least the number of sheets S11 punched in one press operation by the die punching device 150. The sheets S11 accommodated in the stocker 159 are sent to the molding unit 200 one by one or by the number of sheets capable of being processed at one time by the molding unit 200, and are processed by the molding unit 200.

The stocker 159 is disposed downstream of the die punching device 150 linked to the second sheet manufacturing device 100A. In the stocker 159, the sheet S12 punched by the die punching device 150 is accumulated and accommodated. The stocker 159 can accommodate at least the number of sheets S12 punched in one press operation by the die punching device 150. The sheets S12 accommodated in the stocker 159 are sent to the molding unit 200 one by one or by the number of sheets capable of being processed at one time by the molding unit 200, and are processed by the molding unit 200.

The stockers 159 may include supply devices which respectively supply the same number of sheets S11 and sheets S12 to the molding units 200 at a suitable timing.

In the vibration plate manufacturing device 1A, the molding unit 200 may be configured to be able to process a plurality of the sheets S11 at one time. In this case, it is preferable that both of the molding unit 200 positioned downstream of the first sheet manufacturing device 100 and the molding unit 200 positioned downstream of the second sheet manufacturing device 100A can process the same number of sheets S11 and S12. According to this configuration, it is possible to manufacture a large number of vibration plates CP1 for a short period of time.

### 8. Seventh Embodiment

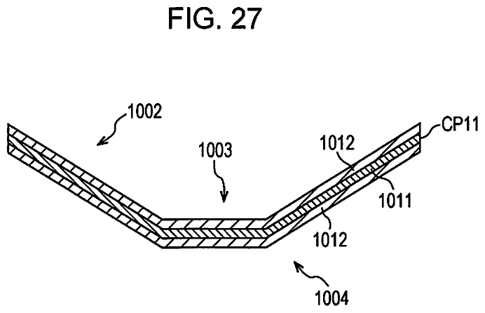

FIG. 27 is a cross sectional view of a vibration plate CP11 of a seventh embodiment.

The vibration plate CP11 is configured of the first layer 1011 and a plurality of layers including the second layer 1012 which are the same as those of the vibration plate CP1 described above. The usage of the vibration plate CP11 is typically a speaker vibration plate, in the same manner as the vibration plate CP1.

The vibration plate CP11 has a multilayer structure in which the first layer 1011 is pinched between two second layers 1012. The second layers 1012 are exposed to the side of the front surface 1002 and the side of the rear surface 1004, and the first layer 1011 is an inner layer pinched between the second layers 1012.

The vibration plate CP11 has a configuration in which the first layer 1011 having a relatively low rigidity and low density is pinched between the second layers 1012 having a high rigidity and high density. By disposing the first layer 1011, it is possible to decrease the density of the vibration plate CP11 and apply a high internal loss. In addition, since the second layers 1012 are exposed to the side of the front surface 1002 and the side of the rear surface 1004, it is possible to realize high rigidity over the entire vibration plate CP11. Therefore, the vibration plate CP11 has excellent properties for a speaker vibration plate.

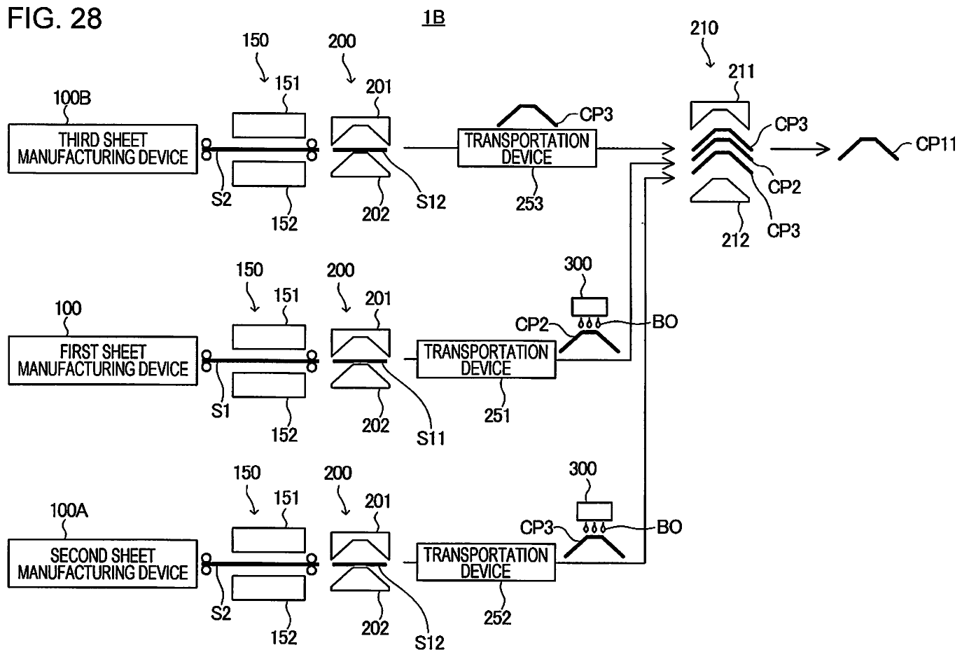

FIG. 28 is a configuration view of a vibration plate manufacturing device 1B of the seventh embodiment. The vibration plate manufacturing device 1B is an example of a device suitable for the manufacturing the vibration plate CP11.

The vibration plate manufacturing device 1B has a configuration in which a third sheet manufacturing device 100B is disposed on the vibration plate manufacturing device 1 described in the fifth embodiment. In the vibration plate manufacturing device 1B, the same reference numerals are used for the configuration units configured in the same manner as those in the vibration plate manufacturing device 1, and therefore, the description thereof is omitted.

The third sheet manufacturing device 100B is configured in the same manner as the second sheet manufacturing device 100A, and manufactures the sheet S2 by using the raw material MA and the additive material AD which are the same as those in the second sheet manufacturing device 100A. The sheet S2 manufactured by the third sheet manufacturing device 100B may be a sheet having different specification from the sheet S2 manufactured by the second sheet manufacturing device 100A.

In the vibration plate manufacturing device 1B, the die punching device 150 is disposed to correspond to the third sheet manufacturing device 100B, and the molding unit 200 is disposed downstream of the die punching device 150. The sheet S2 manufactured by the third sheet manufacturing device 100B is die-punched by the die punching device 150 and the sheet S12 is punched. After that, the molding unit 200 presses and heats the sheet S12. The molding unit 200 disposed to correspond to the third sheet manufacturing device 100B, for example, processes the sheet S12 under the same processing conditions as those in the molding unit 200 installed to correspond to the second sheet manufacturing device 100A, and forms the vibration plate CP3. The vibration plate CP3 formed by the molding unit 200 is transported to the multilayer molding unit 210 by the transportation device 253. The transportation device 253 is configured in the same manner as the transportation device 252, and is, for example, a conveyer transporting the vibration plate CP3 by a belt.

In the vibration plate manufacturing device 1B, the sheet S11 die-punched from the sheet S1 manufactured by the first sheet manufacturing device 100 is processed into the vibration plate CP2 by the molding unit 200, and transported to the adhesive material attachment unit 300 by the transportation device 251.

The adhesive material attachment unit 300 attaches the adhesive material BO to the vibration plate CP2. The adhesive material attachment unit 300 attaches the adhesive material BO to the entire surface or a part of the vibration plate CP2. The vibration plate CP2, to which the adhesive material BO is attached, is transported to the multilayer molding unit 210, and is laminated between the vibration plate CP3, and the vibration CP3, to which the adhesive material BO is attached. Here, a process of overlapping and disposing the two vibration plates CP3 and the vibration plate CP2 by the multilayer molding unit 210 corresponds to the lamination step (Step SA12). The adhesive material attachment unit 300 corresponds to the adhesive material supply unit.

The multilayer molding unit 210 presses and heats the two vibration plates CP3 and the one vibration plate CP2 in a laminated state, and forms the vibration plate CP11 having a three-layered structure. Accordingly, the vibration plate CP11 of FIG. 27 is manufactured.

The vibration plate CP11 has a configuration in which the first layer 1011 is pinched between the two second layers 1012 having the same configuration, but the component or configuration of the two second layers 1012 may be different from each other. For example, the manufacturing conditions of the sheets S2 of the second sheet manufacturing device 100A and the third sheet manufacturing device 100B may be different from each other. In addition, the processing conditions of the sheets S12 of the plurality of molding units 200 may be different from each other.

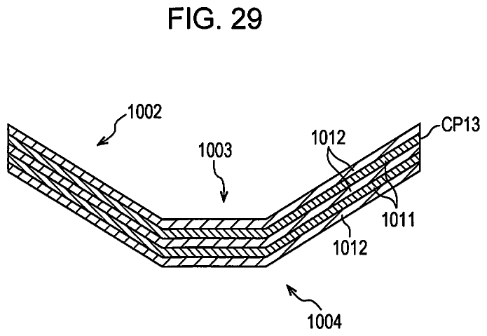

FIG. 29 is a cross sectional view showing another configuration example of the vibration plate and shows a vibration plate CP13 having a 5-layered structure.

The vibration plate CP13 has a configuration in which the first layers 1011 and the second layers 1012 are alternately laminated on each other. A manufacturing method of the vibration plate CP13 can be performed by using the vibration plate manufacturing device 1B. For example, in the vibration plate manufacturing device 1B, the vibration plate can be manufactured by laminating two vibration plates CP2, to which the adhesive material BO is attached, and two vibration plates CP3, to which the adhesive material BO is attached, on the vibration plate CP2, to which the adhesive material BO is not attached.

In the vibration plate CP13, the layers exposed to the side of the front surface 1002 and the side of the rear surface 1004 are configured of the second layer 1012 having a high rigidity. Accordingly, the vibration plate CP13 has a rigidity suitable for the speaker vibration plate. In addition, the two first layers 1011 are disposed in the vibration plate CP13. The first layer 1011 has a light weight and a lower density than those of the second layer 1012. Accordingly, it is possible to decrease the density of the vibration plate CP13 and apply a high internal loss.

As described above, by manufacturing the vibration plate CP13 having a larger number of layers, instead of the vibration plate CP1 or the vibration CP11, it is possible to provide a vibration plate suitable for the usage configuring a speaker. In addition, in the vibration plate CP13, a larger number of layers are bonded to each other by the adhesive material BO, compared to the vibration plate CP1 or the vibration CP11. Accordingly, it is advantageous that the rigidity is higher than that of the vibration plate CP1 or the vibration CP11.

### 9. Eighth Embodiment

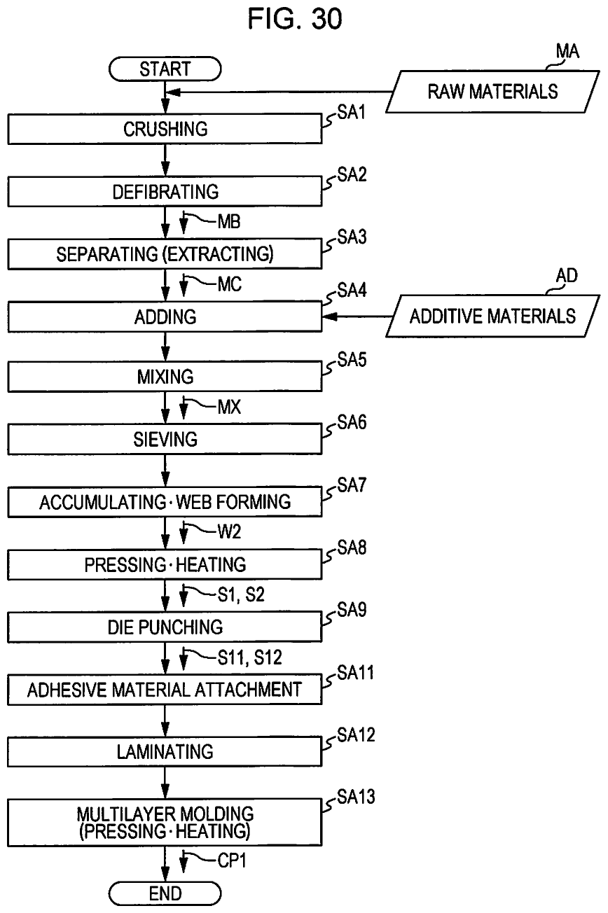

FIG. 30 is a flowchart showing a manufacturing method of the vibration plate CP1 of an eighth embodiment.

The manufacturing method of the vibration plate CP1 shown in FIG. 30 is a method in which the process proceeds to Step SA11, without performing the molding step in Step SA10, after the die punching step in Step SA9, in the manufacturing method of the vibration plate CP1 of the fifth embodiment shown in FIG. 21. That is, the molding step in Step SA10 is omitted. The other steps are the same as those in FIG. 21.

In the manufacturing method of the eighth embodiment, the sheets S11 and S12 are punched from the sheets S1 and S2 in the die punching step in Step SA9, and the adhesive material BO is bonded to the sheets S11 and S12 for the laminating. After that, the disk-shaped sheets S11 and S12 are pressed and heated to form the vibration plate CP1.

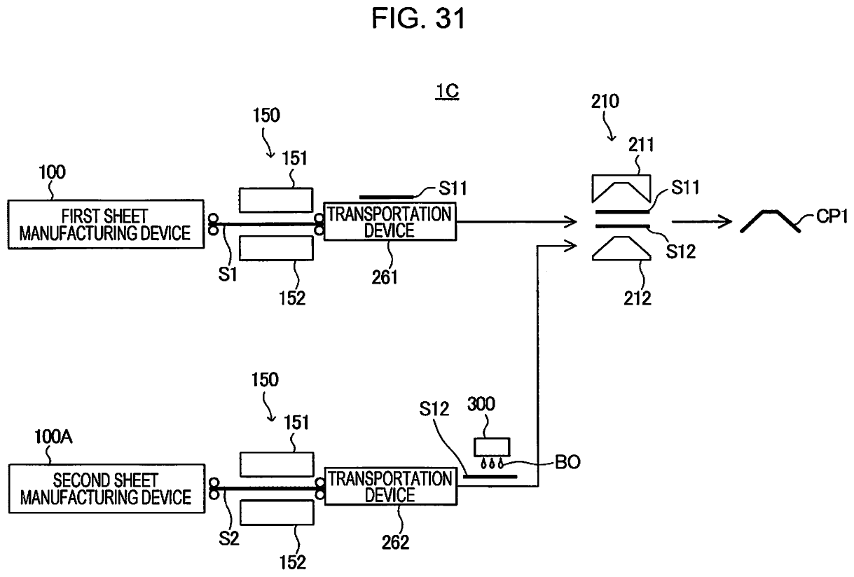

FIG. 31 is a configuration view of a vibration plate manufacturing device 1C of the eighth embodiment. The vibration plate manufacturing device 1C is an example of a device which performs the manufacturing method of FIG. 30.

The vibration plate manufacturing device 1C has a configuration in which the molding unit 200 is removed from the vibration plate manufacturing device 1 described in the fifth embodiment, and transportation devices 261 and 262 are provided, instead of the transportation devices 251 and 252. In the vibration plate manufacturing device 1C, the same reference numerals are used for the configuration units configured in the same manner as those in the vibration plate manufacturing device 1, and therefore, the description thereof is omitted.

In the vibration plate manufacturing device 1C, the punching step is performed on the sheet S1 manufactured by the first sheet manufacturing device 100 by the die punching device 150, and the sheet S11 is punched. This sheet S11 is transported to the multilayer molding unit 210 by the transportation device 261.

In the vibration plate manufacturing device 1C, the punching step is performed on the sheet S2 manufactured by the second sheet manufacturing device 100A by the die punching device 150, and the sheet S12 is punched. This sheet S12 is transported to the adhesive material attachment unit 300 by the transportation device 262. In the adhesive material attachment unit 300, the adhesive material BO is attached to the sheet S12, and the sheet S12, to which the adhesive material BO is attached, is transported to the multilayer molding unit 210. In the adhesive material attachment unit 300, the adhesive material BO may be attached to the entire surface of the sheet S12 or only a part thereof.

The transportation devices 261 and 262 are devices which transport the sheets S11 and S12, and are, for example, conveyers which transport the sheets S11 and S12 by a belt.

In the multilayer molding unit 210, the sheet S12, to which the adhesive material BO is attached, and the sheet S11 are laminated on each other. In the multilayer molding unit 210, the laminated sheets S11 and S12 are pinched between the molding die 211 and the molding die 212, and pressed and heated to form the vibration plate CP1.

The vibration plate manufacturing device 1C include the pressing and heating unit 80 which forms the second web W2 by accumulating the mixture MX, and presses and heats the second web W2 to form the sheets S1 and S2, in the same manner as in the vibration plate manufacturing device 1. The multilayer molding unit 210 forms the vibration plate CP1, by laminating the sheet S11 configuring the first layer 1011 and the sheet S12 configuring the second layer 1012 and pressing and heating the sheets by the molding dies 211 and 212.

That is, in the manufacturing of the vibration plate CP1 by the vibration plate manufacturing device 1C, the disk-shaped sheets S11 and S12 are laminated to form the vibration plate CP1, by omitting the step of molding the sheets S11 and S12 to have a shape of the vibration plate CP1. Accordingly, by omitting the step, it is possible to improve the manufacturing efficiency. Meanwhile, in the multilayer molding unit 210, it is necessary to greatly perform the deformation in a state where the sheets S11 and S12 are laminated on each other. Accordingly, when the rigidity of the sheets S11 and S12 is high, it is desired to finely adjust the processing conditions of the multilayer molding unit 210, so that a deviation or cracks between the sheet S11 and the sheet S12 does is not generated.

With respect to this, in the vibration plate manufacturing device 1 shown in FIG. 22, since the each one of the sheets S11 and S12 are molded in a shape of the vibration plate CP1 in advance, the deformation of the material in the multilayer molding unit 210 is small. Accordingly, it is advantageous that generation of a deviation or cracks of the material during the process of the multilayer molding unit 210 is not concerned. In addition, it is possible to individually control the conditions for processing the sheet S11 by the molding unit 200 and the conditions for processing the sheet S12 by the molding unit 200, and accordingly, it is possible to easily optimize the rigidity and the density of the first layer 1011 and the second layer 1012 configuring the vibration plate CP1.

### 10. Ninth Embodiment

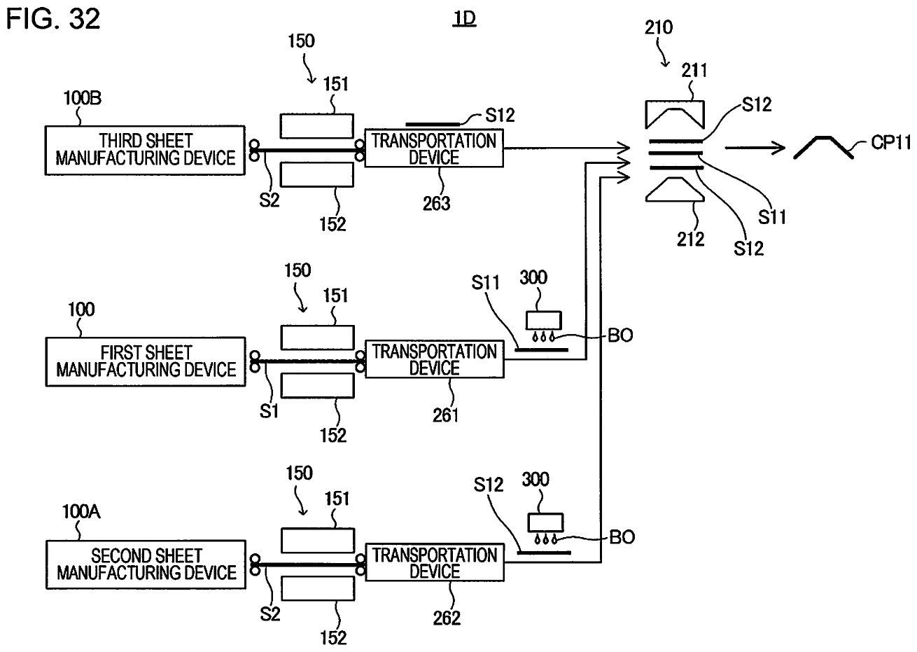

FIG. 32 is a configuration view of a vibration plate manufacturing device 1D of a ninth embodiment.

The vibration plate manufacturing device 1D has a configuration in which the third sheet manufacturing device 100B is provided in the vibration plate manufacturing device 1C of the seventh embodiment shown in FIG. 31. In addition, a transportation device 263 is provided to correspond to the third sheet manufacturing device 100B.

In the vibration plate manufacturing device 1D, the third sheet manufacturing device 100B, and the die punching device 150 corresponding to the third sheet manufacturing device 100B are disposed. The sheet S2 manufactured by the third sheet manufacturing device 100B is die-punched by the die punching device 150, and the sheet S12 is punched. This sheet S12 is transported to the multilayer molding unit 210 by the transportation device 263. The transportation device 263 has the same configuration as that of the transportation device 262, and is, for example, a conveyer which transports the vibration plate CP3 by a belt.

In the vibration plate manufacturing device 1D, the sheet S11 die-punched from the sheet S1 manufactured by the first sheet manufacturing device 100 is transported to the adhesive material attachment unit 300 by the transportation device 261.

The adhesive material attachment unit 300 attaches the adhesive material BO to the sheet S11. The adhesive material attachment unit 300 attaches the adhesive material BO to the entire surface or a part of the sheet S11. The sheet S11, to which the adhesive material BO is attached, is transported to the multilayer molding unit 210, and is laminated between the sheet S12, and the sheet S12, to which the adhesive material BO is attached. Here, a process of overlapping and disposing the two sheets S12 and the sheet S11 by the multilayer molding unit 210 corresponds to the lamination step (Step SA12).

The multilayer molding unit 210 presses and heats the two sheets S12 and one sheet S11 in a laminated state, and forms the vibration plate CP11 having a three-layered structure.

As described above, according to the vibration plate manufacturing device 1D, it is possible to manufacture the vibration plate CP11 having a three-layered structure by the manufacturing method shown in FIG. 30.

### 11. Tenth Embodiment

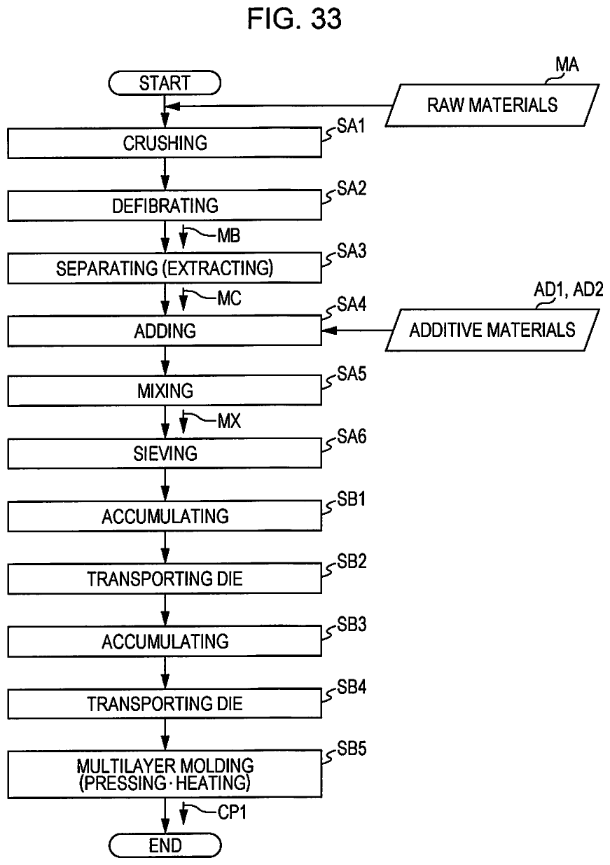

FIG. 33 is a flowchart showing a manufacturing method of the vibration plate CP1 of a tenth embodiment.

The manufacturing method of the vibration plate CP1 of the tenth embodiment includes the common steps as Steps SA1 to SA6 of the manufacturing method of the vibration plate CP1 of the fifth embodiment described with reference to FIG. 21.

The manufacturing method of the vibration plate CP1 of the tenth embodiment is a method of manufacturing the vibration plate CP1, without manufacturing the sheet S, by accumulating the mixture MX dispersed in the sieve step (Step SA6) on the molding die 202.

That is, when the mixture MX is dispersed in the sieve step (Step SA6), the molding die 202 is disposed at a position where the mixture MX is to be dispersed, and the mixture MX is accumulated on the molding die 202. This step is the accumulation step (Step SB1).

After the accumulation step, a transportation step (Step SB2) of transporting the molding die 202, on which the mixture MX is accumulated, is performed. After the transportation step (Step SB2), the second accumulation step is performed (Step SB3). In the accumulation step (Step SB3), the mixture MX is further accumulated on the molding die 202, on which the mixture MX is accumulated.

After the accumulation step, a transportation step (Step SB4) of transporting the molding die 202 is performed. In the transportation step (Step SB4), the molding die 202 is transported to the molding unit 200. The molding die 202 is combined with the molding die 201 in the molding unit 200, and performs the pressing and heating with respect to the mixture MX accumulated on the molding die 202. This process of pressing and heating is the multilayer molding step (step SB5). Two-layered vibration plate CP1 is formed by the multilayer molding step (step SB5).

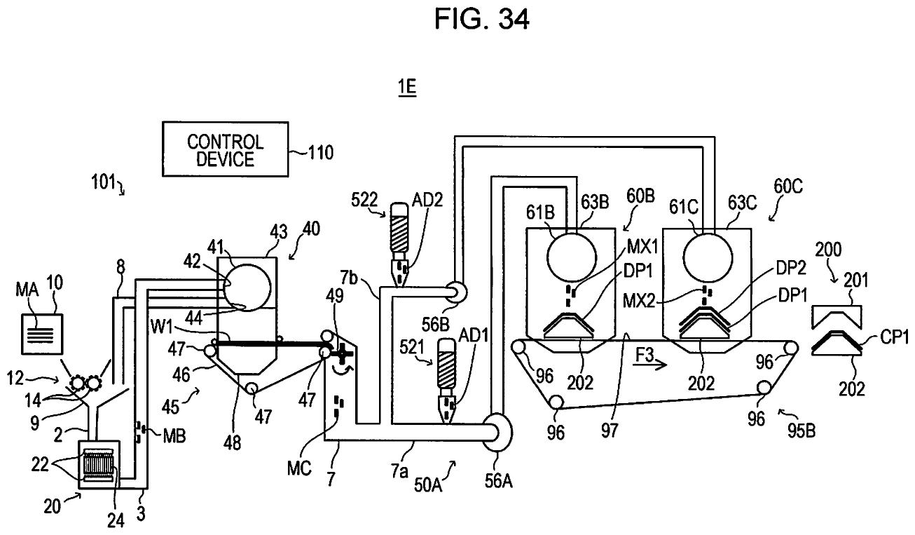

FIG. 34 is a configuration view of a vibration plate manufacturing device 1E of the tenth embodiment. The vibration plate manufacturing device 1E includes a supply unit 10, a crushing unit 12, a defibration unit 20, a selection unit 40, a first web formation unit 45, a rotator 49, and a control device 110, as the common configuration with the first sheet manufacturing device 100 described in the fifth embodiment. In the vibration plate manufacturing device 1E, the same reference numerals are used for the common configuration units with the vibration plate manufacturing device 1, and therefore, the description thereof is omitted.

The vibration plate manufacturing device 1E includes a plurality of additive material supply units 521 and 522 as the configuration of adding the additive material to the material MC. The additive material supply units 521 and 522 respectively have the same configuration as that of the additive material supply unit 52 of the first sheet manufacturing device 100 shown in FIG. 23. The additive material supply unit 521 adds an additive material AD1 to the material MC. The additive material supply unit 522 adds an additive material AD2 to the material MC.

The additive materials AD1 and AD2 are materials molded in particulate state including a thermoplastic resin or a thermosetting resin, in the same manner as the additive material AD.

In the vibration plate manufacturing device 1E, the tube 7, through which the material MC is sent, is branched into two tubes. The additive material supply unit 521 is provided on one branched tube 7a and the additive material supply unit 522 is provided on the other branched tube 7b. Accordingly, the material MC is divided into two and supplied to each of the branched tubes 7a and 7b, and the additive materials AD1 and AD2 are added. Thus, a mixture MX1 obtained by adding the additive material AD1 to the material MC and a mixture MX2 obtained by adding the additive material AD2 to the material MC are generated.

The material MC and the additive material AD1 flowing through the branched tube 7a is mixed by a mixing blower 56A. The material MC and the additive material AD2 flowing through the branched tube 7b is mixed by a mixing blower 56B. The mixing blowers 56A and 56B are blowers configured in the same manner as the mixing blower 56.

The additive material supply unit 521 includes a cartridge which accumulates the additive material AD1 and supplies the additive material AD1 from the cartridge to the branched tube 7a. In the same manner as described above, the additive material supply unit 522 includes a cartridge which accumulates the additive material AD2 and supplies the additive material AD2 from the cartridge to the branched tube 7b. The additive material AD1 and the additive material AD2 may be the same components or different components.

The additive material AD1 is a material which is processed by the molding unit 200 and configures the second layer 1012. In addition, the additive material AD2 is a material which is processed by the molding unit 200 and configures the first layer 1011. The second layer 1012 has a higher density and a higher rigidity than those of the first layer 1011. Accordingly, the additive material AD1 and the additive material AD2 are preferably set as components suitable for the second layer 1012 and the first layer 1011. In addition, the amount of the additive material AD1 supplied to the branched tube 7a by the additive material supply unit 521, and the amount of the additive material AD2 supplied to the branched tube 7b by the additive material supply unit 522 may be the amounts different from each other.

The amounts of the material MC branched to the branched tubes 7a and 7b from the tube 7 may not be homogeneous. For example, a larger amount of material MC can flow to the branched tube 7b, so that the second layer 1012 has a higher density as that of the first layer 1011.

The vibration plate manufacturing device 1E includes two dispersion units 60B and 60C, instead of the dispersion unit 60 included in the first sheet manufacturing device 100. In the dispersion unit 60B, a dispersion drum 61B is accommodated in a housing 63B, and the mixture MX1 is sieved, dispersed, and dropped in the housing 63B by the dispersion drum 61B. In the dispersion unit 60C, a dispersion drum 61C is accommodated in a housing 63C, and the mixture MX2 is sieved, dispersed, and dropped in the housing 63C by the dispersion drum 61C. The dispersion drums 61B and 61C are respectively configured in the same manner as the dispersion drum 61. In addition, the housings 63B and 63C are configured in the same manner as the housing 63, but sizes thereof may be greater than that of the housing 63.

A transportation unit 95B is disposed on a lower side of the dispersion units 60B and 60C. The transportation unit 95B includes an endless belt 97 suspended over rollers 96 and transports the molding die 202 by an operation performed by mounting the molding die 202 on the belt 97. The molding die 202 moves the inner portion of the housing 63B and moves to the molding unit 200 through the inner portion of the housing 63C, with the belt 97. That is, the dispersion unit 60B is positioned upstream and the dispersion unit 60C is disposed downstream in the transportation direction F3 of the molding die 202. The dispersion units 60B and 60C and the transportation unit 95B correspond to the accumulation unit.

In the molding unit 200, the molding die 201 is overlapped on the molding die 202 transported by the belt 97, and pressed and heated.

In the vibration plate manufacturing device 1E, the additive material AD1 is added to the material MC by the additive material supply unit 521 and mixed by the mixing blower 56A, to generate the mixture MX1. The mixture MX1 is supplied into the dispersion drum 61B and dispersed in the atmosphere by the dispersion drum 61B. This operation corresponds to the sieving step (Step SA6).

In the vibration plate manufacturing device 1E, the additive material AD2 is added to the material MC by the additive material supply unit 522 and mixed by the mixing blower 56B, to generate the mixture MX2. The mixture MX2 is supplied into the dispersion drum 61C and dispersed in the atmosphere by the dispersion drum 61C. This operation corresponds to the sieving step (Step SA6).

In the dispersion unit 60B, the mixture MX1 dropped from the dispersion drum 61B is accumulated on the molding die 202. The mixture MX1 accumulated on the molding die 202 is set as an accumulated material DP1. The process of performing the accumulated material DP1 corresponds to the accumulation step (Step SB1).

In the dispersion unit 60C, the mixture MX2 dropped from the dispersion drum 61C is accumulated on the molding die 202. Since the accumulated material DP1 is formed on the molding die 202 in advance, the mixture MX2 is overlapped and accumulated on the accumulated material DP1. The accumulated mixture MX2 is set as an accumulated material DP2. The process of performing the accumulated material DP2 corresponds to the accumulation step (Step SB3). In addition, the operation of transporting the molding die 202 to the dispersion unit 60C from the dispersion unit 60B corresponds to the transportation step (Step SB2), and the operation of transporting the molding die 202 to the molding unit 200 from the dispersion unit 60C corresponds to the transportation step (Step SB4).

The accumulated materials DP1 and DP2 are laminated on the molding die 202. The accumulated material DP1 is configured of a material forming the second layer 1012, and the accumulated material DP2 is configured of a material forming the first layer 1011. Accordingly, by overlapping the molding die 202, on which the accumulated materials DP1 and DP2 are laminated, on the molding die 201, and performing the pressing and heating, it is possible to manufacture the vibration plate CP1 on which the first layer 1011 and the second layer 1012 are laminated. The process of the pressing and heating of the molding unit 200 corresponds to the multilayer molding step (Step SB5).

FIG. 35 is a perspective view of the molding die 202.

The molding die 202 is a protruded die having a shape in that a cone 204 stands on a plate-shaped or box-shaped base 203. With respect to this, although not shown, the molding die 201 has a recessed shape including a recess corresponding to the cone 204.

As shown in FIG. 34, the molding die 202 is disposed on a lower side of the dispersion drum 61B of the housing 63B so that the apex of the cone 204 faces upwards.

In order to set the shape of the vibration plate CP as a conical shape, the molding unit 200 may be set upside down. That is, the molding die 201 may be positioned on a lower side, the molding die 202 is positioned on an upper side, and these may be combined with each other.

However, in the vibration plate manufacturing device 1E of the embodiment, the molding die 202 including the cone 204 protruded upwards is suitable to be disposed on a lower side of the dispersion drum 61B. The same applies to the lower side of the dispersion drum 61C.

In the dispersion unit 60B, the mixture MX1 is accumulated on the cone 204 protruded upwards, it is advantageous that the accumulated state of the mixture MX1 is easily homogenized. When the molding die 201 having a recess is disposed on the dispersion unit 60B, the mixture MX1 dropped from the dispersion drum 61B is dropped into the recess of the molding die 201. This operation causes a movement of dropping of the mixture MX1 temporarily attached to the molding die 201, to a deeper position of the recess. Accordingly, the amount of mixture MX1 exceeding the amount attached to the surface of the recess may be accumulated on the molding die 201. In addition, an unevenness of the accumulated amount of the mixture MX1 at a shallower position and a deeper position of the recess. This phenomenon can also occur in the dispersion unit 60C in the same manner.

With respect to this, when the molding die 202 is disposed on the dispersion unit 60B by setting the apex of the cone 204 to face upwards, the amount of the mixture MX1 accumulated on the cone 204 is homogenous on the surface of the cone 204. Accordingly, it is possible to obtain the accumulated material DP1 having less unevenness in thickness. In the same manner, in the dispersion unit 60C, by positioning the molding die 202 on a lower side of the dispersion drum 61C, the accumulated material DP2 having less unevenness in thickness can be formed on the accumulated material DP1.

Therefore, in the accumulation step (Steps SB1 and SB3), the molding die 202 including the cone 204 having a truncated cone shape is preferably disposed on the lower side of the dispersion drums 61B and 61C so that the cone 204 faces upwards.

As described above, in the vibration plate manufacturing device 1E, the mixture MX1 configuring the first layer 1011 is accumulated and the accumulated material DP1 is formed on the molding die 202. In addition, the mixture MX2 configuring the second layer 1012 is accumulated and the accumulated material DP2 is formed. The molding unit 200 presses and heats the molding die 202, on which the mixtures MX1 and MX2 are accumulated, to form the vibration plate CP1, on which the accumulated materials DP1 and DP2 are accumulated.

In the vibration plate manufacturing device 1E, the mixtures MX1 and MX2 which are materials configuring the vibration plate CP1 are directly accumulated on the molding die 202, and processed by the molding unit 200. The molding unit 200 of the vibration plate manufacturing device 1E corresponds to the molding unit of the present disclosure.

According to the embodiment, the step of forming and transporting the second web W2 or the step of processing the second web W2 into the sheets S1 and S2 in the first sheet manufacturing device 100 and the second sheet manufacturing device 100A can be omitted. In addition, the step of punching the sheets S11 and S12 by the die punching device 150 from the sheets S1 and S2 or the step of transporting the sheets S11 and S12 can be omitted. Thus, it is possible to increase the manufacturing efficiency of the vibration plate CP1.

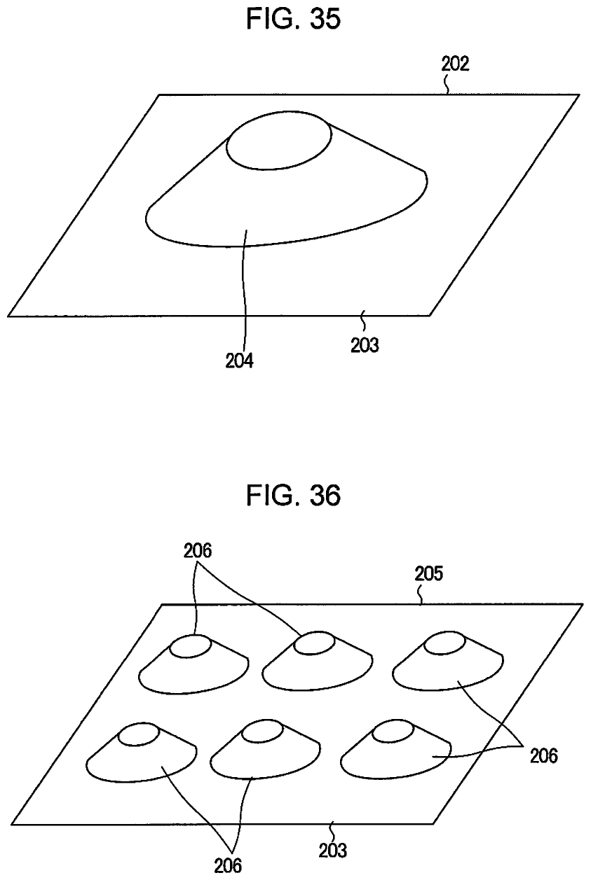

FIG. 36 is a perspective view of the molding die 205.

In the vibration plate manufacturing device 1E, a molding die 205 may be used instead of the molding die 202.

The molding die 205 is a protruded die in which a plurality of cones 206 stand on the plate-shaped or box-shaped base 203. The cones 206 can be combined with a recess including a plurality of recesses, and accordingly, the molding die 205 can be, for example, used instead of the molding die 202.

When the molding die 205 is transported by the belt 97, instead of the molding die 202 and disposed on the lower side of the dispersion drum 61B and the lower side of the dispersion drum 61C, it is possible to form the accumulated materials DP1 and DP2 corresponding to a plurality of vibration plates CP1, with one accumulation step (Step SB1 and SB3). Accordingly, it is possible to further increase the manufacturing efficiency of the vibration plate CP1.

### 12. Eleventh Embodiment

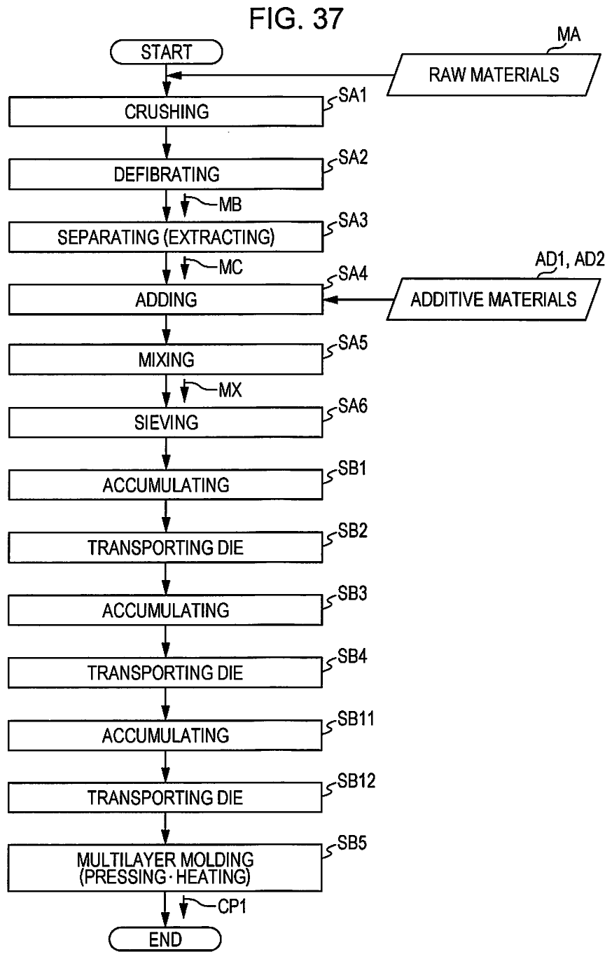

FIG. 37 is a flowchart showing a manufacturing method of the vibration plate CP11 of an eleventh embodiment.

The manufacturing method shown in FIG. 37 is a method of manufacturing the vibration plate CP11 having a three-layered structure by using the manufacturing method of the vibration plate CP1 of FIG. 33.

That is, a third accumulation step (Step SB11) is included, in addition to the accumulation steps in Steps SB1 and SB3.

Specifically, after performing the accumulating on the molding die 202 in the accumulation step (Step SB3), this molding die 202 is further transported (Step SB4) and the third accumulation step is performed (Step SB11). Then, a transportation process of transporting the molding die 202 is performed (Step SB12), and the multilayer molding step (step SB5) is performed.

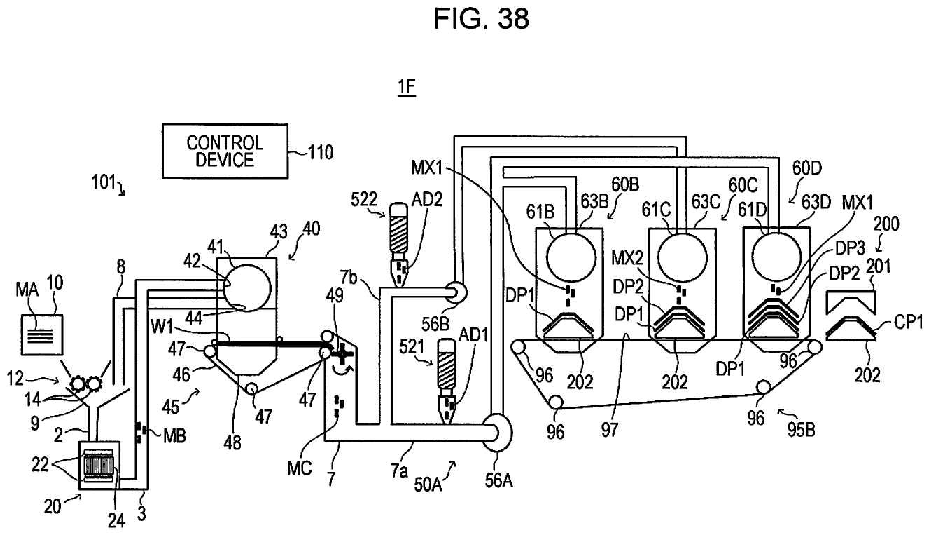

FIG. 38 is a configuration view of a vibration plate manufacturing device 1F of the eleventh embodiment.

The vibration plate manufacturing device 1F is an example of a device which performs the manufacturing method of the vibration plate CP11 of FIG. 37.

The vibration plate manufacturing device 1F has a common configuration with the vibration plate manufacturing device 1E shown in FIG. 34. The same reference numerals are used for the common configuration units with the vibration plate manufacturing device 1E, and therefore, the description thereof is omitted.

The vibration plate manufacturing device 1F has a configuration in which a dispersion 60D including a dispersion drum 61D and a housing 63D is provided in the configuration of the vibration plate manufacturing device 1E. The dispersion drum 61D and a housing 63D are configured in the same manner as the dispersion drum 61B and a housing 63B.

The mixture MX1 is supplied to the dispersion drum 61D, in the same manner as the dispersion drum 61B.

The molding die 202 is transported to the housing 63D by the belt 97 of the transportation unit 95B. When the molding die 202 approaches the housing 63D, a state where the accumulated material DP1 and the accumulated material DP2 is obtained. In the dispersion drum 61D, the mixture MX1 is further dropped and accumulated on the accumulated material DP2, to form an accumulated material DP3.

The accumulated material DP3 is a layer of the mixture MX1 configuring the second layer 1012, in the same manner as the accumulated material DP1. Accordingly, by pressing and heating the molding die 202, on which the accumulated materials DP1, DP2, and DP3 are accumulated, by the molding unit 200, the vibration plate CP11 configured with three layers is manufactured.

According to the configuration of the vibration plate manufacturing device 1F, the vibration plate CP11 having a three-layered structure including the first layer 1011 and the second layer 1012 having a higher rigidity and higher density than those of the first layer 1011 can be manufactured through the step of forming the second web W2 or the sheets S1 and S2. In addition, both of the dispersion unit 60B and 60D can disperses and drops the mixture MX1, and accordingly, the number or the kind of the additive material supply units 521 and 522 do not increase, compared to that in the vibration plate manufacturing device 1E. Therefore, it is advantageous that the vibration plate CP11 having a larger amount layers can be manufactured, without complicating the device configuration.

### 13. Twelfth Embodiment

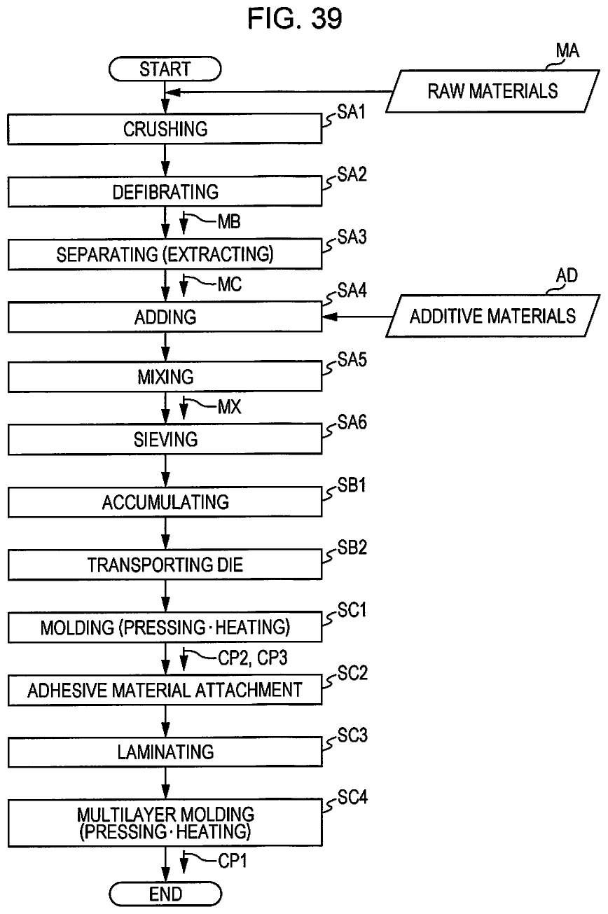

FIG. 39 is a flowchart showing a manufacturing method of the vibration plate CP1 of the twelfth embodiment.

The manufacturing method of the vibration plate CP1 shown in FIG. 39 corresponds to a modification example of the manufacturing method shown in FIG. 33, and Steps SA1 to SA6 and the steps SB1 and SB2 are common processes.

In the manufacturing method of FIG. 39, after the accumulation step (Step SB2) of performing the accumulating on the molding die 202, the molding step (Step SC1) of performing the pressing and heating is performed.

Accordingly, the fibers and the binding material accumulated on the molding die 202 are bound with each other to manufacture the vibration plates CP2 and CP3.

Next, an adhesive material attachment step in Step SC2 is performed. In the adhesive material attachment step, the adhesive material BO is applied and ejected to at least any of the vibration plate CP2 and the vibration plate CP3 formed in Step SC1.

Next, a lamination step in Step SC3 is performed. In the lamination step, the vibration plate CP2 and the vibration plate CP3 are overlapped on each other. In Step SC3, the operation of overlapping the vibration plate CP2 and the vibration plate CP3 and the operation of disposing the vibration plate CP2 and the vibration plate CP3 on the molding dies 201 and 202 may be performed in parallel.

Next, a multilayer molding step in Step SC4 is performed. In the multilayer molding step, the vibration plate CP2 and the vibration plate CP3 laminated in Step SC3 are pressed and heated to become one plate, and the vibration plate CP1 is formed.

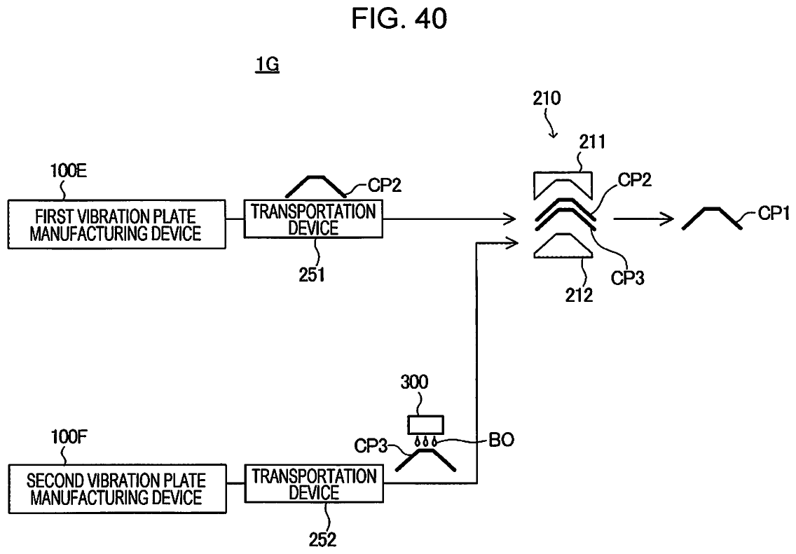

FIG. 40 is a configuration view of a vibration plate manufacturing device 1G of the twelfth embodiment. The vibration plate manufacturing device 1G is an example of a device which performs the manufacturing method shown in FIG. 39.

The vibration plate manufacturing device 1 includes a first vibration plate manufacturing device 100E and a second vibration plate manufacturing device 100F. The first vibration plate manufacturing device 100E performs Steps SA1 to SA6, SB1 and SB2, and SC1 shown in FIG. 39 to manufacture the vibration plate CP2. The second vibration plate manufacturing device 100F performs Steps SA1 to SA6, SB1 and SB2, and SC1 to manufacture the vibration plate CP3.

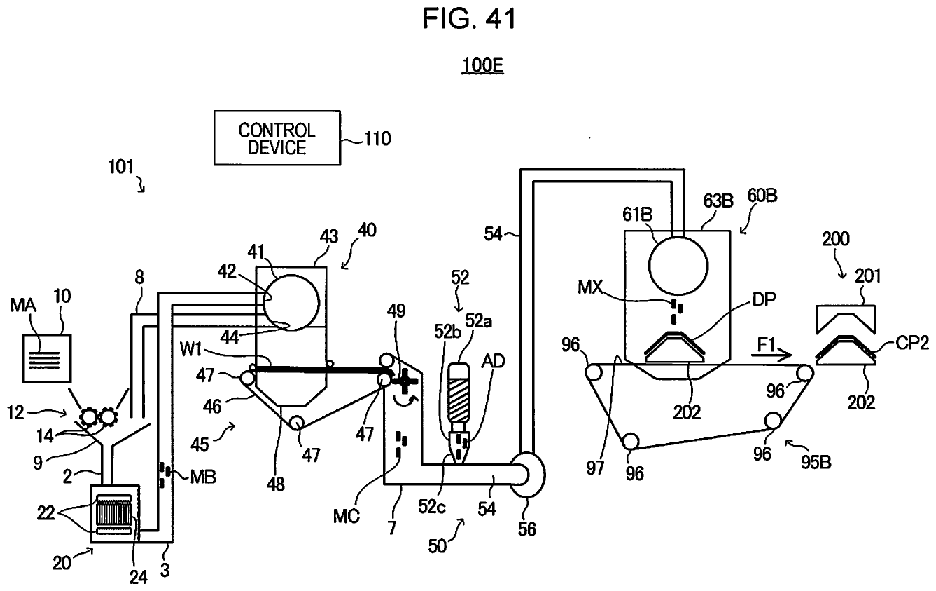

FIG. 41 is a configuration view of the first vibration plate manufacturing device 100E.

The configuration of the first vibration plate manufacturing device 100E corresponds to a configuration in which the additive material supply unit 52 is provided, instead of the additive material supply units 521 and 522 and the dispersion unit 60C is removed, in the vibration plate manufacturing device 1E shown in FIG. 34. The additive material supply unit 52 has the common configuration as that of the first sheet manufacturing device 100 shown in FIG. 23. In addition, in the first vibration plate manufacturing device 100E, the same reference numerals are used for the common configuration units with the vibration plate manufacturing device 1E, and therefore, the description thereof is omitted.

In the first vibration plate manufacturing device 100E, the mixture MX is dispersed and dropped in the atmosphere by the dispersion drum 61B in the dispersion unit 60B, and is accumulated on the molding die 202 transported by the transportation unit 95B. Accordingly, the accumulated material DP, on which the mixture MX is accumulated, is formed on the molding die 202. The molding die 202 is transported to the molding unit 200, fit to the molding die 201, and pressed and heated. By this process of the molding unit 200, the vibration plate CP2 is formed from the accumulated material DP.

The second vibration plate manufacturing device 100F is configured in the same manner as in the first vibration plate manufacturing device 100E, and therefore, the drawings and description of the specific configuration are omitted. The second vibration plate manufacturing device 100F performs the same process as that of the first vibration plate manufacturing device 100E and the vibration plate CP3 is formed.

In the first vibration plate manufacturing device 100E and the second vibration plate manufacturing device 100F, the process of forming the vibration plate CP2 or the vibration plate CP3 from the accumulated material DP corresponds to the molding step (Step SC1).

The vibration plate CP2 configures the first layer 1011, and the vibration plate CP3 configures the second layer 1012. Accordingly, in the first vibration plate manufacturing device 100E, the additive material AD having a blend suitable for the first layer 1011 is added to the material MC to generate the mixture MX. In the second vibration plate manufacturing device 100F, the additive material AD suitable for the second layer 1012 is added to the material MC to generate the mixture MX. The component or the additive amount of these additive materials AD can be the same as those in the other embodiments.

In FIG. 40, the vibration plate CP2 formed by the first vibration plate manufacturing device 100E is transported to the multilayer molding unit 210 by the transportation device 251. In addition, the vibration plate CP3 formed by the second vibration plate manufacturing device 100F is transported to the adhesive material attachment unit 300 by the transportation device 252. The adhesive material attachment unit 300 attaches the adhesive material BO to a part or the entire part of the vibration plate CP3. The vibration plate CP3, to which the adhesive material BO is attached, is transported to the multilayer molding unit 210. This process performed by the adhesive material attachment unit 300 corresponds to the adhesive material attachment step (Step SC2).

In the multilayer molding unit 210, the vibration plate CP2 and the vibration plate CP3, to which the adhesive material BO is attached, are laminated. The process of overlapping and disposing the vibration plate CP3 and the vibration plate CP2 by the multilayer molding unit 210 corresponds to the lamination step (Step SC3). In the multilayer molding unit 210, the laminated vibration plate CP2 and the vibration plate CP3 are pressed and heated, and the vibration plate CP1 is formed. This process performed by the multilayer molding unit 210 corresponds to the multilayer molding step (Step SC4).

According to the vibration plate manufacturing device 1G, the vibration plate CP2 and the vibration plate CP3 are individually manufactured, and accordingly, it is possible to finely adjust the manufacturing conditions and materials of the vibration plate CP2 and the vibration plate CP3. Thus, it is possible to easily manufacture the vibration plate CP1 having preferred properties for the speaker vibration plate. In addition, in the first vibration plate manufacturing device 100E and the second vibration plate manufacturing device 100F, the vibration plates CP2 and CP3 are manufactured by the method of accumulating, pressing, and heating the mixture MX on the molding die 202, without obtaining the second web W2 or the sheets S1 and S2. Therefore, it is possible to increase the manufacturing efficiency of the vibration plate CP1.

### 14. Thirteenth Embodiment

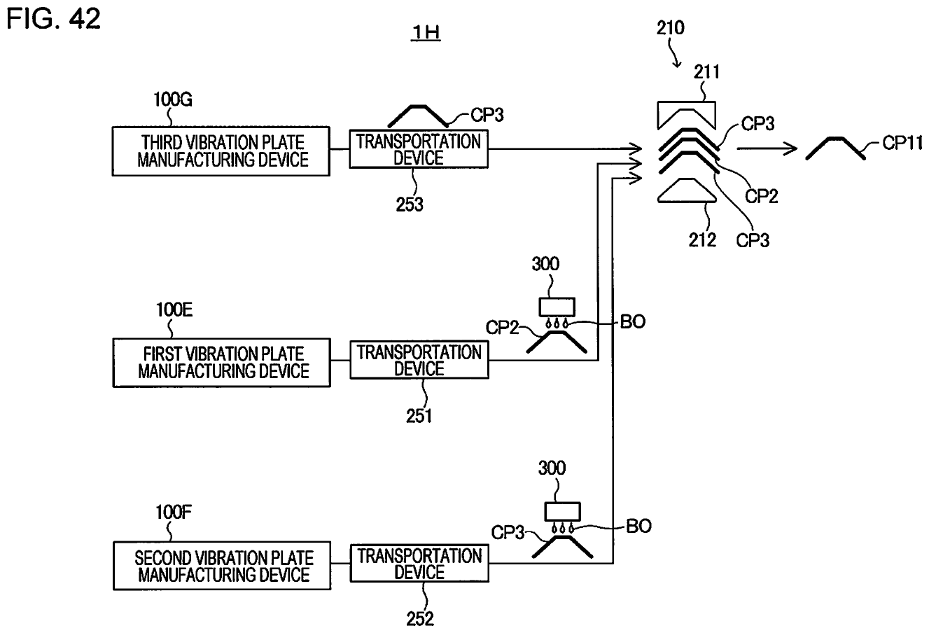

FIG. 42 is a configuration view of a vibration plate manufacturing device 1H of a thirteenth embodiment.

The vibration plate manufacturing device 1H is a device which manufactures the vibration plate CP11 having three layers by the manufacturing method shown in FIG. 39. The vibration plate manufacturing device 1H has a configuration in which a third vibration plate manufacturing device 100G is disposed in the vibration plate manufacturing device 1G shown in FIG. 40. In the vibration plate manufacturing device 1H, the same reference numerals are used for the common configuration units with the vibration plate manufacturing device 1G, and therefore, the description thereof is omitted.

The third vibration plate manufacturing device 100G is configured in the same manner as the second vibration plate manufacturing device 100F, and the vibration plate CP3 is manufactured by using the raw material MA and the additive material AD which are the same as those of the second vibration plate manufacturing device 100F.

In the vibration plate manufacturing device 1H, the transportation device 253 is provided to correspond to the third vibration plate manufacturing device 100G. The transportation device 253 transports the vibration plate CP3 manufactured by the third vibration plate manufacturing device 100G to the multilayer molding unit 210.

In the vibration plate manufacturing device 1H, the vibration plate CP2 manufactured by the first vibration plate manufacturing device 100E is transported to the adhesive material attachment unit 300 by the transportation device 251.

In the adhesive material attachment unit 300, the adhesive material BO is bonded to the vibration plate CP2. The adhesive material attachment unit 300 attaches the adhesive material BO to the entire surface or a part of the vibration plate CP2. The vibration plate CP2, to which the adhesive material BO is attached, is transported to the multilayer molding unit 210 and is laminated between the vibration plate CP3, and the vibration plate CP3, to which the adhesive material BO is attached. Here, a process of overlapping and disposing the two vibration plates CP3 and the vibration plate CP2 by the multilayer molding unit 210 corresponds to the lamination step (Step SC3).

The multilayer molding unit 210 presses and heats the two vibration plates CP3 and one vibration plate CP2 in a laminated state, and forms the vibration plate CP11 having a three-layered structure.

As described above, by using the manufacturing method shown in FIG. 39, it is possible to manufacture the vibration plate CP1 having a two-layered structure and the vibration plate CP11 having a three-layered structure, and it is also possible to manufacture a vibration plate having a larger number of layers.

### 15. Other Embodiments

Each embodiment is merely specific aspects for performing the present disclosure disclosed in the aspects, and the disclosure is not limited thereto. The present disclosure can be performed in various aspects as shown below, for example, within a range not departing from a gist thereof.

For example, the vibration plates CP1 and CP11 exemplified as the manufactured products of the embodiments may include ribs or may have other three-dimensional shapes.

In addition, the vibration plate manufacturing devices 1, 1A, 1B, 1C, 1D, 1F, 1G, and 1H are described as a device which manufactures the vibration plate CP by defibrating the raw material MA by the defibration unit 20, but the defibration processing unit 101 is not included. For example, a configuration in which the additive material AD is added and mixed with the material MC including fivers which are defibrated in advance, to manufacture the vibration plate CP, may be used.

A color or properties of the vibration plate CP is random, and for example, by causing the additive material AD to include a colorant together with the resin, the material MC may be colored, and the vibration plates CP1 and CP11 may be manufactured by using the mixture MX in any color.

For other specific configurations, the modification can be randomly performed.

What is claimed is:

1. A speaker vibration plate including:
a defibrated material obtained by defibrating a material including fibers; and
a binding material for binding the fibers to each other, wherein
the speaker vibration plate is formed by a molding process including pressing and heating.

2. The speaker vibration plate according to claim 1, wherein
the binding material includes at least any one of a thermoplastic resin and a thermosetting resin.

3. The speaker vibration plate according to claim 1, further comprising:
a thermally expandable material.

4. The speaker vibration plate according to claim 1, wherein
the speaker vibration plate includes a vibration surface, and
an auxiliary material is attached to at least one surface of the vibration surface.

5. A speaker vibration plate manufacturing device comprising:
a defibration unit which defibrates a material including fibers;
a mixing unit which mixes a binding material for binding the fibers to each other, to a defibrated material defibrated by the defibration unit;
an accumulation unit which accumulates a mixture mixed by the mixing unit; and
a molding unit which forms an accumulated material accumulated by the accumulation unit into a speaker vibration plate by a molding process including pressing and heating.

6. The speaker vibration plate manufacturing device according to claim 5, wherein
the mixing unit disperses the mixture, and
the accumulation unit accumulates the mixture.

7. The speaker vibration plate manufacturing device according to claim 5, wherein
the mixing unit mixes the defibrated material and the binding material with a thermally expandable material which expands by heating.

8. The speaker vibration plate manufacturing device according to claim 5, wherein
the mixing unit mixes the defibrated material with the binding material including at least any of a thermoplastic resin and a thermosetting resin.

9. The speaker vibration plate manufacturing device according to claim 5, wherein
the accumulation unit accumulates the mixture to form a web, and
the molding unit presses and heats the web set in a molding die in the molding process.

10. The speaker vibration plate manufacturing device according to according to claim 5, wherein
the accumulation unit accumulates the mixture to form a web,
the speaker vibration plate manufacturing device further comprises a sheet forming unit which forms a sheet by pressing and heating the web, and
the molding unit presses and heats the sheet set in the molding die in the molding process.

11. The speaker vibration plate manufacturing device according to claim 5, wherein
the accumulation unit accumulates the mixture in the molding die, and
the molding unit presses and heats the molding die, on which the mixture is accumulated, in the molding process.

12. The speaker vibration plate manufacturing device according to claim 5, further comprising:
an attachment processing unit which attaches an auxiliary material to a surface of the speaker vibration plate formed by the molding unit.

13. A manufacturing method of a speaker vibration plate, the method comprising:
defibrating a material including fibers;
mixing a binding material for binding the fibers to each other, with a defibrated material obtained by the defibrating;
accumulating the mixture; and
forming an accumulated material into a speaker vibration plate by a molding process including pressing and heating.

14. A speaker vibration plate comprising:
a first layer which includes a defibrated material obtained by defibrating a material including fibers, and a binding material for binding the fibers of the defibrated material; and
a second layer which includes the defibrated material and the binding material and has a higher density than a density of the first layer, in which the binding material is dissolved to form the speaker vibration plate.

15. The speaker vibration plate according to claim 14, wherein
the second layer is a layer having a higher rigidity than a rigidity of the first layer.

16. The speaker vibration plate according to claim 14, wherein
a density of at least any one of the fibers and the binding material included in the second layer is higher than that of the first layer.

17. The speaker vibration plate according to claim 14, wherein
the binding material includes at least any of a thermoplastic resin and a thermosetting resin.

18. The speaker vibration plate according to claim 14, further comprising:
an adhesive material which bonds the first layer and the second layer to each other.

19. A speaker vibration plate manufacturing device comprising:
a defibration unit which defibrates a material including fibers;
a mixing unit which mixes a binding material for crosslinking the fibers, with a defibrated material defibrated by the defibration unit;
an accumulation unit which accumulates a mixture mixed by the mixing unit to form a first layer and a second layer; and
a molding unit which dissolves the binding material to form a speaker vibration plate in which the first layer and the second layer are laminated, wherein
the second layer has a higher density than a density of the first layer.

20. The speaker vibration plate manufacturing device according to claim 19, wherein
the second layer has a higher rigidity than a rigidity of the first layer.

21. The speaker vibration plate manufacturing device according to claim 19, wherein
a density of at least any of the fibers and the binding material included in the second layer is higher than the density of the first layer.

22. The speaker vibration plate manufacturing device according to claim 19, wherein
the binding material includes at least any of a thermoplastic resin and a thermosetting resin.

23. The speaker vibration plate manufacturing device according to claim 19, wherein
the accumulation unit accumulates the mixture to form a web,
the speaker vibration plate manufacturing device further comprises a sheet forming unit which forms a sheet by pressing and heating the web, and
the molding unit forms the speaker vibration plate including the first layer formed from the sheet by a first layer molding unit and the second layer formed from the sheet by a second layer molding unit.

24. The speaker vibration plate manufacturing device according to claim 19, wherein
the accumulation unit accumulates the mixture to form a web,
the speaker vibration plate manufacturing device further comprises a sheet forming unit which forms a sheet by pressing and heating the web, and
the molding unit laminates the sheet configuring the first layer and the sheet configuring the second layer, and performs pressing and heating by a molding die, to form the speaker vibration plate.

25. The speaker vibration plate manufacturing device according to claim 23, further comprising:
an adhesive material supply unit which attaches an adhesive material between the sheet configuring the first layer and the sheet configuring the second layer.

26. The speaker vibration plate manufacturing device according to claim 19, wherein
the accumulation unit accumulates the mixture configuring the first layer and the mixture configuring the second layer on a molding die, and
the molding unit presses and heats the molding die on which the mixture is accumulated by the accumulation unit, to form the speaker vibration plate.

27. A manufacturing method of a speaker vibration plate, the method comprising:
mixing fibers of a defibrated material defibrated with a binding material for binding the fibers to form a first layer with a first density;
mixing the fibers and the binding material to form a second layer with a density higher than a density of the first layer; and
bonding the first layer and the second layer to each other, in a state where the first layer and the second layer are laminated.

28. The manufacturing method of a speaker vibration plate according to claim 27, wherein
the bonding of the first layer and the second layer is a process of dissolving the binding material by a molding process including heating and pressing.
